(19) United States
(12) Patent Application Publication
(10) Pub. No.: US 2007/0182812 A1
(43) Pub. Date: Aug. 9, 2007

(54) Panoramic image-based virtual reality/telepresence audio-visual system and method

(76) Inventor: Kurtis J. Ritchey, Leavenworth, KS (US)

Correspondence Address: CARDINAL LAW GROUP, Suite 2000, 1603 Orrington Avenue, Evanston, IL, 60201, US

(21) Appl. No.: 11/131,647

(22) Filed: May 18, 2005

Related U.S. Application Data
(60) Provisional application No. 60/572,408, filed on May 19, 2004.

(51) Int. Cl. H04N 7/00

(52) U.S. Cl. 348/36

(57) ABSTRACT

A panoramic system comprises means for obtaining a panoramic image, and means for displaying the panoramic image.

### CROSS-REFERENCE TO RELATED APPLICATIONS

The present application claims the benefit of U.S. Provisional Patent Application Ser. No. 60/572,408, filed May 19, 2004, which is incorporated herein by reference in its entirety.

### BACKGROUND AND SUMMARY OF THE INVENTION

In U.S. Pat. No. 5,130,794, claim 5, the present inventor disclosed a portable system incorporating a plurality of cameras for recording a spherical FOV scene. In that same patent, claim 4, the present inventor disclosed an optical assembly that can be constructed and placed on a conventional camcorder that enables the camcorder to record spherical field-of-view (FOV) panoramic images. Similarly, in U.S. Pat. No. ______, IPIX later claims a portable plural camera system for recording panoramic imagery. However, in many instances using a single camcorder is advantageous because most people cannot afford to buy several camcorders, one camcorder for recording panoramic spherical FOV imagery and one for recording conventional directional FOV imagery. Given this, it is the object of the present invention to overcome various limitations of conventional camcorders for recording panoramic imagery.

An advantage of using a single conventional camcorder to record panoramic images is that it is readily available, adaptable, and affordable to the average consumer. However, the disadvantage is that conventional camcorders are not tailored to recording panoramic images. For instance, a limitation of the claim 4 lens is that transmitting image segments representing all portions of a spherical FOV scene to a single frame results in a scene of low resolution image when a portion of that scene is enlarged. This limitation is compounded further when overlapping images are recorded adjacent to one another on a single frame in order facilitate stereographic recording. For example, the Canon XL1 camcorder with inter-changeable lens capability produces an EIA standard television signal of 525 lines, 60 fields, NTSC color signal. The JVC JY-HD10U HDTV Camcorder produces a 1280×720P image in a 16:9 format at 60 fields, color signal. And finally the professional Sony HDW-F900 produces a 1920×1080 image in a 16:9 format at various frame rates to include 25, 29.97, and 59.94 fields per second color signal. The images can be recorded in either a progressive or interlaced mode. Assuming two fisheye lenses are used to record a complete scene of spherical coverage, it is preferable that each hemispherical image be recorded at a resolution of 1000×1000 pixels. While HDTV camcorders represent an improvement they still fall short of this desired resolution. The optical systems put forth in the present invention facilitates recording images nearer to or greater than the 1000×1000 pixel resolution desired, depending on which of the above cameras is incorporated. It is therefore an objective of the present invention to provide several related methods for adapting and enhancing a single conventional camcorder to record a higher resolution spherical FOV images.

A limitation of the current panoramic optical assemblies that incorporate wide angle and fisheye lenses is that the recorded image is barrel distorted. Typically, the distortion is removed through image processing. The problem with this is that it takes time and computer resources. It also requires purchasing and tightly controlled proprietary software that is restricting use of imagery captured by panoramic optical assemblies currently on the market. It is therefore an object of the present invention to reduce or remove the barrel distortion caused by the fisheye lenses by optical means, specifically by specially constructed fiber optic image conduits.

A limitation current panoramic camcorders is that they rely on magnetic tape media. It is therefore an objective of the present invention to provide a method of adapting a conventional camcorder system into the panoramic camcorder system incorporating a diskette (i.e. CD ROM or DVD) recording system for easy storage and playback of the panoramic imagery.

Another limitation is that the microphone(s) on the above conventional camcorders is not designed for panoramic recording. The microphone(s) of a conventional camcorder are typically oriented to record sound in front of the conventional zoom lens. Also, typically, conventional camcorders incorporate a boom microphone(s) that extend outward over the top of the camcorder. This does not work well with a panoramic camera system using the optical assembly in claim 4 records a spherical FOV because the microphone gets in the way of visually recording the surrounding panoramic scene. It is therefore an object of the present invention to incorporate the microphones into the optical assembly in an outward orientation consistent with recording a panoramic scene.

Another limitation is that the tripod socket mount on the above conventional camcorders is not designed to facilitate panoramic recording. Conventional camcorder mounting sockets are typically on the bottom of the camera and do not facilitate orienting the camera lens upward toward the ceiling or sky. However, orienting the camera upward toward the ceiling or sky is the optimal orientation when the panoramic lens in claim 4 is to be mounted. A limitation of current cameras is that no tripod socket is on the rear of the camera, opposite the lens end of the camera. It is therefore an objective of the present invention to provide a tripod mount to the back end of the camera to facilitate the preferred orientation of the panoramic lens assembly of claim 4 and as improved upon in the present invention.

Another limitation of current camcorders is that they have not been designed to facilitate recording panoramic imagery and conventional directional zoom lens imagery without changing lenses. It is therefore an objective of the present invention to put forth several panoramic sensor assembly embodiments that can be mounted to a conventional camcorder which facilitate recording and playback of panoramic and/or zoom lens directional imagery.

Another limitation is that the control mechanism on the above conventional camcorders is not designed for panoramic recording. Typically, conventional camcorders are designed to be held and manually operated by the camera operator, where the operator is located out of sight behind the camera. This does not work well with the panoramic camera system using the optical assembly in claim 4 records a spherical FOV such that the camera operator cannot hide when manually operating the controls of the camera. It is therefore an object of the present invention to provide a wireless remote control device for remotely controlling the camcorder operation with a spherical FOV optical assembly, like that in claim 4 or as improved upon in the present invention.

Another limitation is that the viewfinder on the above conventional camcorders is not designed for panoramic recording. Typically, conventional camcorders are designed to be held and viewed by the camera operator, where the operator is located out of sight behind the camera. This does not work well with the panoramic camera system using the optical assembly in claim 4 records a spherical FOV such that the camera operator cannot hide when manually operating the controls of the camera. It is therefore an object of the present invention to provide a wireless remote viewfinder for remotely controlling the camcorder with a spherical FOV optical assembly, like that in claim 4 or as improved upon in the present invention.

Another limitation is that the remote control receiver(s) on the above conventional camcorders is not designed for camcorders adapted for panoramic recording. Typically, conventional camcorders incorporate remote control receiver(s) that face forward and backward of the camera. The problem with this is that a camcorder incorporating a lens like that in claim 4 or improved upon in the present invention work most effectively when the recording lens end of the camcorder is placed upward with the optical assembly mounted onto the recording lens end of the camera. When the camcorder is placed upward the remote control signal does not readily communicate with the remote control device because the receivers are facing upward to the sky and downward toward the ground. It is therefore an object of the present invention to incorporate a remote control receiver(s) onto a conventional camera that has been adapted for taking panoramic imagery such that the modified camcorder is able to receive control signals from an operator using a wireless remote control device located horizontal (or to the any side) of the panoramic camcorder.

A previous limitation of panoramic camcorder systems is that image segments comprising the panoramic scene required post production prior to viewing. With the improvement of compact high-speed computer processing systems panoramic imagery can be viewed in real time. It is therefore an objective of the present invention to incorporate realtime playback into the panoramic camcorder system (i.e. in camera, in remote control unit, and/or in a linked computer) by using modern processors with a software program to manipulate and view the recorded panoramic imagery live or in playback.

A previous limitation of the camcorder system has been that there is no way to designate what subjects in a recorded panoramic scene to focus in on. There has also not been a method to extract from the panoramic scene a sequence of conventional imagery of a limited FOV of just the designated subjects. It is therefore an objective of the present invention to provide associated hardware and a target tracking/feature tracking software program that allows the user to designate what subjects in the recorded panoramic scene to follow and to make a video sequence of during production or later in post production.

A previous limitation of panoramic camcorder systems is that panoramic manipulation and viewing software was not incorporated/embedded into the panoramic camcorder system and/or panoramic remote control unit. It is therefore an object of the present invention to provide associated hardware and software for manipulating and viewing the panoramic imagery recorded by the panoramic camera in order to facilitate panoramic recording and ease of use by the operator and/or viewer.

The proceeding and other objects and features of this invention will become further apparent from the detailed description that follows. Such description is accompanied by a set of drawing figures. Numerals of the drawing figures, corresponding to those of the written description, point to the various features of the invention. Like numerals refer to like features throughout both the written description and the drawing figures.

Since the early years of film several large formats have evolved. Large format film and very large high definition digital video systems are the enabling technology for creating large spherical panoramic movie theaters as disclosed by the present inventor in his publications for The International Society for Optical Engineering proceedings Volume 1668, (1992) pp 2-14 and in SPIE Volume 1656 High-Resolution Sensors and Hybrid Systems (1992) pp 87-97. The present invention takes advantages of using the above mentioned enabling technologies to build a large panoramic theaters which completely surround the audience in a continuous audio-visual environment.

It is therefore an object of the present invention to provide apparatus for transforming a received field-of-view into a visual stream suitable for application to a three-dimensional viewing system.

The invention provides an apparatus for transforming a stereographic received field-of-view into a panoramic image sequence for application to a camera comprising a single movie film image pickup. Such an apparatus includes means for imparting a predetermined angular differential between a first perspective and a second perspective of the field-of-view. Means are provided for imparting orthogonal polarizations to the perspective views. Means are also provided for receiving and sequentially providing the first and second perspective views to the camera.

The “Basis of Design” of all things invented can be said to be to overcome mans limitations. A current limitation of humans is that while we live in a three-dimensional environment, our senses have limitations in perceiving our three-dimensional environment. One of these constraints is that our sense of vision only perceives things in one general direction at any one time. Similarly, typical camera systems are designed to only facilitate recording, processing, and display of a multi-media event within a limited field-of-view. An improvement over previous systems would be to provide a system that allows man to record, process, and display the total surrounding in a more ergonomic and natural manner independent of his physical constraints. A further constraint is mans ability to communicate with his fellow man in a natural manner over long distances. This invention relates, in general, to an improved panoramic interactive recording and communications system and method that allows for recording, processing, and display of the total surrounding. As with other shortcomings, man has evolved inventions by creating machines to overcome his limitations. For example, man has devised communication systems and methods to do this over the centuries . . . from smoke signals used in ancient days to advanced satellite communication systems of today. In the same vain this invention has as its objective and aim to converge new yet uncombined technologies into a novel, more natural and user friendly system for communication, popularly referred to today as “telepresence”, “visuality”, “videoality”, or “Image Based Virtual Reality” (IBVR).

Strub et al., U.S. Pat. No. 6,563,532, May 13, 2003, entitled Low Attention Recording Unit For Use By Vigorously Active Recorder discloses a system for video images by a individual wearing an input, processing, and a display device. Stub et al. discusses the use of cellular telephone connectivity, use of displaying the processed scene on the wearers eyeglasses, and recording and in general processing of panoramic images. However, Strub et al. does not disclose the idea of incorporating a spherical field-of-view camera system. Such a spherical field-of-view camera system would be an improvement over the systems Strub et al. mentioned because such a system would allow recording of a more complete portion of the surrounding environment. Specifically, the system disclosed by Strub et al. only provides at most for hemispherical recording using a single fisheye lens oriented in a forward direction, while the system proposed by the present inventor records images that facilitate spherical field-of-view recording, processing and display.

Additionally, an additional embodiment of the present invention also includes a mast mounted system that allows the wearers face to be recorded as well as the remaining surrounding scene about the mast mounted camera recording head. This is an improvement over Strub et al. in that it allows viewers at a remote location who receive the transmitted signal to see who they are talking to and the surrounding environment where the wearer is located. Strub et al. does not disclose a system that looks back at the wearers face. Looking at the wearers face allows face allows more natural and personable communication between people communicating from remote locations. Finally, a related embodiment of the present invention that is also an improvement over Strub et al. is the inclusion of software to remove distortion and correct the perspective of facial images recorded when using wide field of view lenses with the present inventions panoramic sensor assembly 10.

Additionally, the present invention puts forth a recording, processing, and display system that is completely housed in a head mounted unit 120 or 122. Several improvements in technologies have made this possible. The following paragraphs discuss these enabling technologies that allow for the convergence of a single head-mounted unit 120 or 122.

In contrast to the present invention Strub et al. incorporates a body harness for housing some portion of the recording, processing, and display system. Including these systems in a single unit is beneficial over Strub et al. in certain situations because of its improved compactness, unobtrusiveness, portability, and reduction of parts.

Additionally, the present invention discloses a panoramic camera head unit 10 incorporating micro-optics and imaging sensors that have reduced volume over that disclosed in the present inventor's U.S. Pat. No. 5,130,794, dated 14 Jul. 1992, and a panoramic camera system marketed by Internet Pictures Corporation (IPIX), Knoxyille, Tenn. Prototypes by Ritchey incorporate the Nikon FC-E8 and FC-E9 Fisheye Lenses. The FC-E8 has a diameter of 75 mm with a field of view of 183 degrees, and the FC-E9 has a diameter of 100 mm and with a field of view of 190 degrees circular Field-Of-View (FOV) coverage. Spherical FOV Panoramic cameras by IPIX incorporate fisheye lenses and have been manufactured Coastal Optical Systems Inc., of West Palm Beach, Fla. A Coastal fisheye lenses used for IPIX film photography mounted of the Aaton cinematic camera and others is the Super 35 mm Cinematic Lens with 185 degrees FOV Coverage with a diameter of 6.75 inches and a depth of 6.583 inches, and for spherical FOV video photograph mounted on a Sony HDTV F900 Camcorder use the ⅔ inch Fisheye Video Lens at $2500 with 185 degrees FOV with a diameter of 58 millimeters and a depth of 61.56 millimeters. Coastal and IPIX use of these lenses infringes on the present inventors claim 4 of the '794 patent. The above Ritchey prototype and IPIX/Coastal systems have not incorporate recent micro-optics which have reduced the required size of the optic. This is an important improvement in that it allows the optic to be reduced in size from several inches to several millimeters, which makes the optical head lightweight and very portable and thus feasible for use in the present invention.

An important aspect of the present invention is the miniaturization of the spherical FOV sensor assembly 10 which includes imaging and may include audio recording capabilities. Small cameras which facilitate this and are of a type used in the present invention include the ultra small Panasonic GP-CX261V ¼ inch 512H Pixel Color CCD Camera Module with Digital Signal Processing board. The sensor is especially attractive for incorporation in the present invention because the cabling from the processing to the sensor can reach ˜130 millimeters. This allows the cabling to be placed in an eye-glass frame or the mast of the panoramic sensor assembly of the present invention which is described below. Alternatively, the company Super Circuits of Liberty Hill, Tex. sells several miniature cameras, audio, and associated transmission systems whose entire systems and components can be incorporated into the present invention, as will be skilled to those in the art. The Super Circuits products for incorporation into unit 120 or 122 include the worlds smallest video camera that is smaller than a dime, and pinhole micro-video camera systems in the form of a necktie cam, product number WCV2 (mono) and WCV3 (color), ball cap cam, pen cam, glasses cam, jean jacket button cam, and eye-glasses cam embodiments. A small remote wireless video transmitter may be attached to any of these cameras. The above cameras, transmitters, and lenses may be incorporated into the above panoramic sensor assembly or other portion of the panoramic capable wireless communication terminals/units 120, 122 to form the present invention. Additionally, Still alternatively, a very small wireless video camera and lens, transceiver, data processor and power system and components that may be integrated and adapted to form the panoramic capable wireless communication terminals/units 120, 122 is disclosed by Dr. David Cumming of Glasgow University and by Dr. Blair Lewis of Mt Sinai Hospital in New York. It is known as the “Given Diagnostic Imaging System” and administered orally as a pill/capsule that can pass through the body and is used for diagnostic purposes.

Objective micro-lenses suitable for taking lenses in the present invention, especially the panoramic taking assembly 10, are manufactured and of a type by AEI North America, of Skaneateles, N.Y., that provide alternative visual inspection systems. AEI sales micro-lenses for use in borescopes, fiberscopes, and endoscopes. They manufacture objective lens systems (including the objective lens and relay lens group) from 4-14 millimeters in diameter, and 4-14 millimeters in length, with circular FOV coverage from 20 approximately 180 degrees. Of specific note is that AEI can provide an objective lens with 180 degree or slightly larger FOV coverage required for some embodiments of the panoramic sensor assembly, like that shown in FIGS. 23 and 43-44c of the present invention required in order to achieve adjacent hemispherical FOV coverage by two fisheye lenses. The above lenses are incorporated into the above panoramic sensor assembly or other portion of the Panoramic capable wireless communication terminals/units 120, 122 to form the present invention. It should be noted that designs of larger fisheye lenses such as the Nikon FC-E9 Fisheye and Coastal Fisheye Video Lens may be downsized by manufacturers of borescopes, fiberscopes, and endoscopes according to those skilled in the art should a demand for these fisheye micro-lenses increase.

Additionally, technologies enabling and incorporated into the present invention includes camcorder and camcorder electronics whose size has been reduced such that those electronics can be incorporated into a HMD or body worn device for spherical or circular FOV coverage about a point in the environment according to the present invention. Camcorder manufacturers and systems that are of a type whose components may be incorporated into the present invention include Panasonic D-Snap SV AS-A10 Camcorder, JVC-30 DV Camcorder, Canon XL1 Camcorder, JVC JY-HD10U Digital High Definition Television Camcorder, Sony DSR-PDX10, and JVC GR-D75E and GR-DVP7E Mini Digital Video Camcorder. The optical and/or digital software/firmware picture stabilization systems incorporated into these systems are incorporated by reference into the present invention.

Additionally, technologies enabling and incorporated into the present invention include video cellular phones and personal digital assistants, and their associated integrated circuit technology. Video cellular phone manufacturers and systems that are a type that is compatible and may be incorporated into the present invention include RVS Remote Video Surveillance System. The system 120 or 122, includes a CellularVideoTransmitter (CVT) unit that includes a Transmitter (Tx) and Receiver (Rx) software. The Tx transmits live video or high-quality still images over limited bandwidth. The Tx sends high quality images through a cellular/PSTN/satellite phone or a leased/direct line to Rx software on a personal computer capable system. The Tx is extremely portable with low weight and low foot-print. Components may integrated into any of the panoramic capable wireless communication terminals/units 120, 122 of the present invention. The Tx along with a panoramic camera means, processing means (portable PC+panoramic software), panoramic display means, and telecommunication means (video capable cellular phone), special panoramic software, may constitute unit 120 or 122. For instance, it could be configured into the belt worn and head unit embodiment of the System shown in FIG. 19 of the present invention.

Correspondingly, makers of video cellular phone of a of a type which in total or whose components may be integrated into the present invention 120 or 122 includes the AnyCall IMT-2000, Motorola, SIM Free V600; the Samsung Inc., Video Cell Phone Model SCH-V300 with 2.4 Megabit/second transfer rate capable of two-way video phonecalls; and other conventional wireless satellite and wireless cellular phones using the H.324 and other related standards that allow the transfer of video information between wireless terminals. These systems a include MPEG3/MPEG4, H.263 video capabilities, call management features, messaging features, data features including Bluetooth™ wireless technology/CE Bus (USB/Serial) that allows them to be used as the basis for the panoramic capable wireless communication terminals/units 120 or 122. Cellular video phones of a type that can be adapted for terminal/unit 120 or 122 includes that by King et al in U.S. Patent Application Publication 2003/0224832 A1, by Ijas et al in U.S Pat. App. Pub. 2002/0016191 A1, and by Williams in U.S. Pat. App. Pub. 2002/0063855 A1. Still alternatively, the Cy-visor, personal LCC for Cell Phones by Daeyang E&C with a head mounted display that projects a virtual 52 inch display that can be used with vide cell phones may be integrated and adapted into a panoramic capable wireless communication terminals/units 120 or 122 according to the present invention. The Cy-visor is preferably adapted by adding a mast and panoramic sensor assembly, a head position and eye tracking system, and a see through display. An advantage of the present system is that embodiments of it may be retrofitted and integrated with new wireless video cell phones and networks. This makes the benefits of the invention affordable and available to many people. Additionally, the present inventors confidential disclosures dating back to 1994 as witnessed by Penny Mellies also provide cellular phone embodiments that are directly related to a type that can be used in the present invention to form panoramic capable wireless communication terminals/units 120 or 122.

The telecommunication network that forms system 100 of the present invention and into which wireless panoramic units 120 or 122 can communicate over and are of a type that can be incorporated into the present invention include that by Dertz et al. in U.S. Patent Application Publication 2002/0093948 A1 and U.S. Pat. App. Pub. 2002/0184630 A1 used to provide examples in this specification in FIG. 26 and FIG. 47, respectively. Other telecommunication network that forms system 100 of the present invention and into which wireless panoramic units 120 or 122 can communicate over and are of a type that can be incorporated into the present invention include that by Buhler et al. in U.S. Pat. App. Pub. 2004/0012620 A1, by Welin in U.S. Pat. App. Pub. 2002/0031086 A1, by Schwaller in U.S. Pat. No. 5,585,850, by Pasanen in U.S. Pat. No. 6,587,450 B1, and satellite communication systems by Horstein et al. in U.S. Pat. No. 5,551,624 and by Dinkins in U.S. Pat. No. 5,481,546.

Additionally, technologies enabling and incorporated into the present invention include wide band telecommunication networks and technology 100. Specifically, video streaming is incorporated into the present invention. A telecommunication system 100 that may incorporate video streaming of a type compatible with the present invention is Dertz et al. in U.S. Patent Application Publication 2002/0093948 A1 and iMove, Inc. Portland, Oreg. in U.S. Pat. No. 6,654,019 B2. Another patent which incorporates video streaming manufacturer and system that may be incorporated into the present invention include the Play Incorporated, Trinity Webcaster and associated system, which can accept panoramic input feeds, perform the digital video effects required for spherical FOV content processing/manipulation, display, and broadcast over the internet.

Additionally, technologies enabling and incorporated into the present invention 120 or 122 include wireless technology that has done away with the requirements for physical connections from the viewers camera, head-mounted display, and remote control of the camera to host computers required for image processing and control processing. Wireless connectivity of can be realized in the panoramic capable wireless communication terminals/units 120, 122 by the use of conventional RF and Infrared transceivers. Corresponding, recent hardware and software/firmware such as Intel™ Centrino™ mobile technology, Bluetooth technology, and Intel's™ Bulverde™ chip processor allows easy and cost-effective incorporation of video camera capabilities into wireless laptops, PDA's, smart cellular phones, HMDs, and so forth that enable wireless devices to conduct panoramic video-teleconferencing and gaming using the panoramic capable wireless communication terminals/units 120, 122 according to the present invention. These technologies may be part of the components and systems incorporated into the present invention. For example, these wireless technologies are enabling and incorporated into the present invention in order to realize the wireless image based remote control unit that is wrist mounted is claimed in the present invention to control spherical FOV cameras and head mounted displays. Chips and circuitry which include transceivers allow video and data signals to be sent wirelessly between the input, processing and display means units 120 when distributed over the users body or off the users body. Specifically, for example, the Intel Pro/Wireless 2100 LAN MiniPCI Adapters Types 3A and 3B provide IEEE 802.11b standard technology. The 2100 PCB facilitates the wireless transmission of up to eleven megabits per second and can be incorporated into embodiments of the Panoramic capable wireless communication terminals/units 120 or 122 of the present invention.

### BRIEF DESCRIPTION OF THE DRAWINGS

FIG. 1a is a perspective view of a conventional camcorder.

FIG. 1b is a perspective view of a conventional camcorder of an alternative design.

FIG. 1c is a perspective view of a conventional remote control unit for conventional camcorder like that shown in FIG. 1a and FIG. 1b.

FIG. 1d is a diagram of an operator using a conventional remote control unit with a conventional camera.

FIG. 1e is a diagram of a sequence of conventional frames recorded by a camera in FIG. 1a or FIG. 1b.

FIG. 1f is a drawing of a sequence of conventional frames recorded by a single monoscopic panoramic camera according to the prior art of U.S. Pat. No. 5,130,794, claim 4.

FIG. 1g is a drawing of a sequence of conventional frames recorded by a single stereoscopic panoramic camera according to the prior art of U.S. Pat. No. 5,130,794, claim 4.

FIG. 1h is a diagram of a sequence of conventional frames recorded by two cameras which each record a respective hemisphere that comprise a panoramic spherical FOV scene are frame multiplexed electronically by a video multiplexer device as described in described in U.S. Pat. No. 5,130,794.

FIG. 2a is an exterior perspective view of a stereographic camcorder of prior art whose electro-optical system has been modified in the present invention to form a panoramic camcorder system. The stereographic camcorder in FIG. 2a is the same camcorder of FIG. 1a, except that a stereographic taking lens has been mounted on the camera body.

FIG. 2b is an exterior perspective view of a conventional camcorder incorporating improvements disclosed herein to the arrangement in FIG. 2a to facilitate an improved monoscopic panoramic recording arrangement of a panoramic scene.

FIG. 2c is a cutaway perspective view of the optical system in FIG. 2b.

FIG. 2d is a drawing of a sequence of conventional frames recorded by a monoscopic panoramic camcorder arrangement shown in FIG. 2b.

FIG. 2e is a schematic diagram showing the construction of an imaging device used in the camera in FIG. 1a, FIG. 2a, and in the improved monoscopic panoramic recording arrangement that forms the present invention depicted in FIG. 2b.

FIG. 2f is a timing chart showing the operating timing and liquid crystal shutter switching timing of the present invention depicted in FIG. 2b.

FIG. 2g is a block diagram showing the construction of the optical shutter depicted in FIG. 2b.

FIG. 2h is a schematic diagram of the monoscopic panoramic camera arrangement of the present invention illustrated in FIG. 2b.

FIG. 3a is a perspective view of a conventional camcorder incorporating improvements disclosed herein to facilitate improved recording of a stereoscopic panoramic scene.

FIG. 3b is a cutaway perspective view of the sterographic optical recording system shown in 3a.

FIG. 3c is a drawing of a sequence of conventional frames recorded by a sterographic panoramic camcorder arrangement shown in FIG. 3a.

FIG. 3d is a timing chart showing the operating timing and liquid crystal shutter switching timing of the present invention depicted in FIG. 2b.

FIG. 3e is a schematic diagram of the sterographic panoramic camera arrangement shown in FIG. 3a.

FIG. 4a is an exterior perspective view of a remote control unit that includes a display unit for use with a panoramic camcorder like that shown in FIGS. 2b and 3a.

FIG. 4b is a perspective of an operator using the remote control unit in FIG. 4a to interact with a panoramic camera like that described in FIGS. 2b and 3a.

FIG. 5a illustrates an method of optically distorting an image using fiber optic image conduits.

FIG. 5b illustrates applying fiber optic image conduits as illustrated in FIG. 5a to the present invention in order to remove or reduce barrel distortion from an image taken with a fisheye or wide angle lens.

FIG. 5c is a cutaway perspective view of an alternative specially designed fiber optic image conduit arrangement according to FIGS. 5a and 5b that is applied to the present invention in order to reduce or remove distortion from wide-angle and fisheye lenses.

FIG. 5a′ is an exterior perspective drawing of a combined panoramic spherical FOV and zoom lens camcorder system.

FIG. 5b′ is a schematic drawing of the electro-optical system and related components and systems associated with the camcorder system shown in FIG. 5a′ that incorporates liquid crystal shutters.

FIG. 5c′ is a schematic drawing of an alternative embodiment of the electro-optical system and related components and systems associated with the camcorder system shown in FIG. 5a′that incorporates polarization.

FIG. 5d′ is a schematic drawing of another electro-optical system and related components and systems associated with the camcorder system shown in FIG. 5a′ that incorporates plural image sensors.

FIG. 6 is a cutaway perspective of an alternative panoramic spherical FOV recording assembly that is retrofitted onto a two CCD or two film plane stereoscopic camera.

FIG. 7 is a diagram illustrating the process and functionality of applying target tracking/feature tracking software to the above panoramic spherical cameras disclosed in the present invention.

FIG. 8 are diagrams and table comparing various current large film formats.

FIG. 8a is a diagram showing the dimensions of a typical IMAX 70 mm movie screen.

FIG. 8b is a photograph of a 5 perforation, 70 mm movie frame.

FIG. 8c is a photograph of a 35 mm movie frame.

FIG. 8d is a photograph of a 15 perforation, 70 mm IMAX 70 mm movie frame.

FIG. 8e is a photograph of a table comparing standard 16 mm, standard 35 mm, standard 70 mm, IMAX 70 mm, and IMAX Dome 70 mm film formats.

FIG. 9 is a side sectional drawing illustrating the state-of-the-art in large format movie theaters . . . the IMAX Dome Theater.

FIG. 10a is a perspective drawing of a cameraman operating a conventional portable filmstrip movie camera with an adapter for recording stereo coded images.

FIG. 10b is a top sectional view of an adapter for a filmstrip movie camera for recording stereo coded images.

FIG. 11a is an exterior perspective view of a conventional portable filmstrip movie camera like that in FIG. 10a, wherein the movie camera and stereo adapter have been modified to receive and record panoramic spherical FOV images.

FIG. 11b is a plan view of a new 11 perforation, 70 mm filmstrip format for recording hemispherical and square images in a panoramic spherical FOV filmstrip movie camera.

FIG. 11c is a schematic drawing of the electro-optical system according to the conventional portable filmstrip movie camera like that in FIG. 10a, wherein the movie camera and stereo adapter have been modified to receive and record panoramic spherical FOV images.

FIG. 11d(1) through 11d(5) comprise a set of timing diagrams that illustrate the operation of the electronic shuttering system of the movie camera and stereo adapter that have been modified to receive and record panoramic spherical FOV images.

FIG. 11e is a circuit schematic diagram of an electronic shuttering system of the movie camera and stereo adapter that have been modified to receive and record panoramic spherical FOV images.

FIG. 12 is a schematic diagram illustrating an alternative arrangement in which the process of converting an IMAX movie camera into a panoramic spherical FOV monoscopic or stereoscopic filmstrip movie camera, production, scanning/digitizing, post production, and presentation steps according to the present invention.

FIG. 13a through 13e are plan views of a set of new film formats for recording hemispherical and square images in a panoramic spherical FOV filmstrip movie camera.

FIG. 14 is a schematic diagram illustrating the process of converting an IMAX movie camera into a panoramic spherical FOV monoscopic or stereoscopic filmstrip movie camera and the associated production, post production, and distribution required

FIG. 15 is a cutaway perspective drawing illustrating the incorporation of relay means such as fiber optic image conduits, mirrors, or prisms to relay images representing a composite panoramic spherical FOV coverage to a film plane of a filmstrip movie camera.

FIG. 16a through 16e illustrate large venue format panoramic film or video projection theaters designed to distribute, project, and display imagery recorded by the panoramic spherical FOV monoscopic and stereoscopic filmstrip movie cameras disclosed in the present invention.

FIG. 17a is a side sectional drawing of a panoramic theater like those shown in FIGS. 16a through 16e depicting the projection, viewing, and architecture that are integrated in such a manner as to provide an unobstructed entry and exit for the audience while minimizing the interruption on continuous projection of the scene surrounding the viewer.

FIG. 17b is a top view drawing of a panoramic theater like those shown in FIGS. 16a through 16e depicting the projection, viewing, and architecture that are integrated in such a manner as to provide an unobstructed entry and exit for the audience while minimizing the interruption on continuous projection of the scene surrounding the viewer.

FIG. 18 is a side sectional drawing of a transparent seating arrangement for a panoramic theater like those shown in FIGS. 16a through 16e depicting the benefit of using such seating to minimize the disruption of view for the audience to all projection surfaces and also provide comfort and safety for the audience.

FIG. 19 is a perspective drawing of a head-mounted wireless panoramic communication device according to the present invention.

FIG. 20 is an exterior perspective drawing of the panoramic sensor assembly according to the present invention that is a component of the head-mounted wireless panoramic communication device shown in FIG. 19.

FIG. 21 is an interior perspective view of the sensor assembly shown in FIG. 19 and FIG. 20 of relay optics (i.e. fiber optic image conduits, mirrors, or prisms) being used to relay images from the objective lenses to one or more of the light sensitive recording surfaces (i.e. charge couple devices or CMOS devices) of the panoramic communication system.

FIG. 22 is an interior perspective view of the sensor assembly shown in FIG. 19 and FIG. 20 comprising six light sensitive recording surfaces (i.e. charge couple devices or CMOS devices) positioned directly behind the objective lenses of the of the panoramic communication system.

FIG. 23 is an interior perspective view of the sensor assembly shown in FIG. 19 and FIG. 20 comprising two light sensitive recording surfaces (i.e. charge couple devices or CMOS devices) positioned directly behind the objective lenses of the of the panoramic communication system.

FIG. 24 is a perspective drawing of a digital cellular phone with a video camera and panoramic sensor assembly.

FIG. 25 is a block diagram of a digital cellular phone with a video camera and panoramic sensor assembly.

FIG. 26 is a schematic diagram of a content distribution system incorporating two alternative embodiments of personal wireless panoramic communication devices disclosed according to the present invention.

FIG. 27 is a schematic diagram disclosing a system and method for dynamic selective image capture in a three-dimensional environment incorporating a panoramic sensor assembly with a panoramic objective micro-lens array, fiber-optic image conduits, focusing lens array, addressable pixilated spatial light modulator, a CCD or CMOS device, and associated image, position sensing, SLM control processing, transceiver, telecommunication system, and users.

FIG. 28 is a schematic diagram detailing the optical paths of a facial image being captured by the panoramic sensor assembly of the invention.

FIG. 29 is a schematic drawing of the numerical interaction procedure used by the computer program to calculate the distortion of the facial image recorded by the panoramic optical assembly.

FIG. 30 is a flowchart for the method of correction of the perspective distortion by the computer program according to the present invention.

FIG. 31 is a schematic diagram detailing the signal processing done to the optical and electrical signals which represent the facial image according to one embodiment of the invention.

FIG. 31a is a perspective drawing showing the one way communication between user #1 and user #2 communicating with a head-mounted wireless panoramic communication device according to the present invention.

FIG. 31b is a drawing the image that is captured by the distorted image recorded by the panoramic sensor assembly.

FIG. 31c is a drawing of the image after the computer program corrects the distorted image for viewing.

FIG. 31d is a drawing of the signal processing of the distortion correction program.

FIG. 31e is a drawing representing the telecommunication network which the corrected image travels over to get to remote user #2.

FIG. 31f is a drawing representing the intended recipient, user #2, of the undistorted facial image.

FIG. 32 is prior art of U.S. Pat. No. 6,337,683 B1 showing a flow chart of the program for viewing a three-dimensional movie containing a sequence of panoramas (FIG. 10), block diagrams of the major components of the panoramic system (FIGS. 1, 2, 3A, 3B, 3C, 3D, 6, 9A, and 9B).

FIG. 33a is a confidential disclosure dated 1994, witnessed by the present inventor and Penny L. Mellies, showing the conception of major aspects of the present invention.

FIG. 33b is the other side of the confidential disclosure page dated 1994.

FIG. 34 is a schematic drawing summarizing the major embodiments of the present invention which generally comprises production/input/recording, electronics/computer processing/distribution, and presentation/display/output of panoramic audio-visual content/media.

FIG. 35 is a flow chart diagram of illustrating the selection options for 3-D interaction by the user(s) according to the present invention.

FIG. 36 is a schematic diagram illustrating the input, processing, and display hardware, software or firmware component means/options that make up the present invention 10, 120, 122 and 100. The schematic illustrates the components that comprise an integrated self contained unit for personal immersive communication like that in FIGS. 19, 38, 39, and 42.

FIG. 36a is a schematic diagram illustrating the input means/option of using a dynamic selective raw image capture using a spatial light modulator illustrated in FIG. 27.

FIG. 36b is a schematic diagram illustrating the input means/option of using a dynamic selective raw image capture from a plurality of cameras according to the present invention.

FIG. 36c is a schematic diagram further illustrating input/option means in which content is input from remote sources on the telecommunications network (i.e. network servers sending 2-D or 3-D content or other remote users sending 3-D content to the local user), or from prerecorded sources (i.e. 3-D movies) and applications (i.e. 3-D games) programmed or stored on the system worn by the user.

FIG. 36d is a schematic diagram illustrating a portion of the hardware and software or firmware processing means that comprise the panoramic communications system that can be worn by a user.

FIG. 36e is a schematic diagram illustrating an additional portion of the hardware and software or firmware processing means that comprise the panoramic communications system that can be worn by a user.

FIG. 36f is a schematic diagram illustrating an additional portion of the hardware and software or firmware processing means that comprise the panoramic communications system that can be worn by a user.

FIG. 36g is a schematic diagram illustrating examples of wearable Panoramic projection communication display means according the present invention.

FIG. 36h is a schematic diagram illustrating wearable head-mounted and portable panoramic communication display means according to the present invention.

FIG. 36i is a is schematic diagram illustrating prior art display means that are compatible with the present invention.

FIG. 37 is a diagram of immersive eve glasses and the associated wearable power, processing, and communication system 120 or 122 used in FIG. 19.

FIG. 38 is a perspective drawing of a head mounted device in which panoramic capture, processing, display, and communication means are integrated into a single device 120 or 122.

FIG. 39 is a diagram of the components and interaction between the components that comprise the integrated head mounted device 120 or 122 shown in FIG. 38.

FIG. 40 is a perspective of a wrist mounted personal wireless communication device 120 or 122 (i.e. cell phone) with a panoramic sensor assembly for use according to the present invention.

FIG. 41 is a perspective illustrating the interaction between the user and the wrist mounted personal wireless communication device 120 or 122 (i.e. cell phone) with a panoramic sensor assembly shown in FIG. 40.

FIG. 42 is a perspective drawing of a laptop with an integrated panoramic camera system 120 or 122 according to the present invention.

FIG. 43 is a side sectional diagram illustrating an embodiment of the present invention 10 comprising a spatial light modulator liquid crystal display shutter for dynamic selective transmission of image segments imaged by a fisheye lens and relayed by fiber optic image conduits and focused on an image sensor.

FIG. 44a-c are drawings of a telescoping panoramic sensor assembly 10 according to the present invention.

FIG. 44a is an side sectional view showing the unit 10 in the stowage position.

FIG. 44b is a side sectional view of the unit 10 in the operational position.

FIG. 44c is a perspective drawing of the unit 10 is the operational position.

FIG. 45a-f are drawings of the present invention 120 or 122 integrated into various common hats.

FIG. 45a-c are exterior perspectives illustrating the integration of the present invention into cowboy hat 120 or 122.

FIG. 45d-f are exterior perspectives illustrating the integration of the present invention into a baseball cap 120 or 122.

FIG. 46 is a perspective view of an embodiment of the present invention wherein the panoramic sensor assembly 10 is optionally being used to track the head and hands of the user who is playing an interactive game. The head mounted unit is connected to a belt worn stowage and housing system that includes the flip-up panoramic sensor assembly 10, computer processing system (including wireless communication devices), and a head-mounted display system. Alternatively, the sensor assembly 10 may also be used to record, process, and display images for video telepresence and augmented reality applications as illustrated in other figures disclosed within this invention 120 or 122.

FIG. 47 is a block diagram of a packet based multimedia communications system 100 that facilitates transmission of panoramic video and other content over a wireless network between terminals 120 and 122 according to the present invention. (ref. US 2002/0093948, FIG. 1)

FIG. 48 is a message sequence chart associated with an embodiment of a two-way telepresence video call supported by a packet-based multimedia communication system 100 according to the present invention. (ref. US 2002/0093948, FIG. 7)

FIG. 49 is a message sequence chart associated with an embodiment of a one-way telepresence video call supported by a packet-based multimedia communication system 100 according to the present invention. (ref. US 2002/0093948)

FIG. 50 is a message sequence chart associated with an embodiment of a one-way video playback call supported by a packet-based multimedia communication system 100 according to the present invention. (ref. US 2002/0093948)

FIG. 51 is a message sequence chart associated with an embodiment of a web browsing request supported by a packet-based multimedia communication system 100 according to the present invention. (ref. US 2002/0093948)

### DETAILED DESCRIPTION OF THE PRESENT INVENTION

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

In all aspects of the present invention, references to “camera” mean any device or collection of devices capable of simultaneously determining a quantity of light arriving from a plurality of directions and or at a plurality of locations, or determining some other attribute of light arriving from a plurality of directions and or at a plurality of locations. Similarly references to “display”, “television” or the like, shall not be limited to just television monitors or traditional televisions used for the display of video from a camera near or distant but shall also include computer data display means, computer data monitors, other video display devices, still picture display devices, ASCII text display devices, terminals, systems that directly scan light onto the retina of the eye to form the perception of an image, direct electrical stimulation through a device implanted into the back of the brain (as might create the sensation of vision in a blind person), and the like.

With respect to both the cameras and displays, as broadly defined above, the term “zoom” shall be used in a broad sense to mean any lens of variable focal length, any apparatus of adjustable magnification, or any digital,

computational, or electronic means of achieving a change in apparent

magnification. Thus, for example, a zoom viewfinder, zoom television, zoom

display, or the like, shall be taken to include the ability to display a picture

upon a computer monitor in various sizes through a process of image

interpolation as may be implemented on a body-worn computer system.

References to “processor”, or “computer” shall include sequential instruction, parallel instruction, and special purpose architectures such as digital signal processing hardware, Field Programmable Gate Arrays (FPGAs), programmable logic devices. as well as analog signal processing devices.

References to “transceiver” shall include various combinations of radio transmitters and receivers, connected to a computer by way of a Terminal Node Controller (TNC), comprising, for example, a modem and a High Level Datalink Controller (HDLCs), to establish a connection to the Internet, but shall not be limited to this form of communication. Accordingly, “transceiver” may also include analog transmission and reception of video signals on different frequencies, or hybrid systems that are partly analog and partly digital. The term “transceiver” shall not be limited to electromagnetic radiation in the frequence bands normally associated with radio, and may therefore include infrared or other optical frequencies. Moreover, the signal need not be electromagnetic, and “transceiver” may include gravity waves, or other means of establishing a communications channel.

While the architecture illustrated shows a connection from the headgear, through a computer, to the transceiver, it will be understood that the connection may be direct, bypassing the computer, if desired, and that a remote computer may be used by way of a video communications channel (for example a full-duplex analog video communications link) so that there may be no need for the computer to be worn on the body of the user.

The term “headgear” shall include helmets, baseball caps, eyeglasses, and any other means of affixing an object to the head, and shall also include implants, whether these implants be apparatus imbedded inside the skull, inserted into the back of the brain, or simply attached to the outside of the head by way of registration pins implanted into the skull. Thus “headgear” refers to any object on, around, upon, or in the head, in whole or in part.

For clarity of description, a preliminary summary of the major features of the recording, processing, and display portions of a preferred embodiment of the system is now provided, after which individual portions of the system will be described in detail.

Referring to the drawings in more detail:

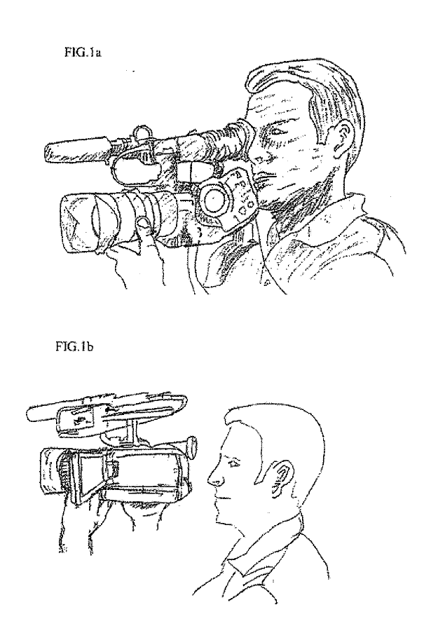

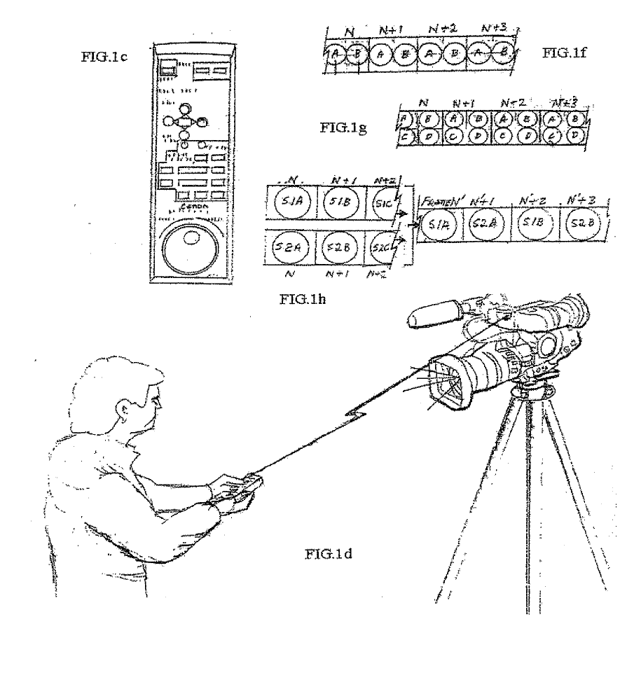

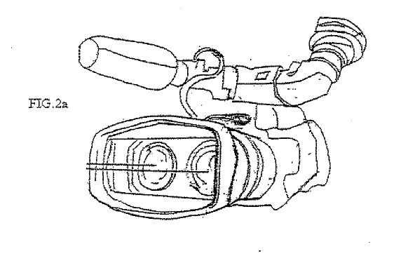

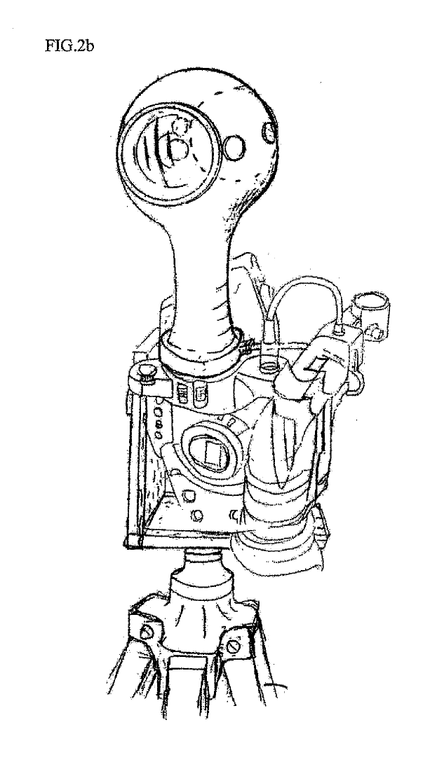

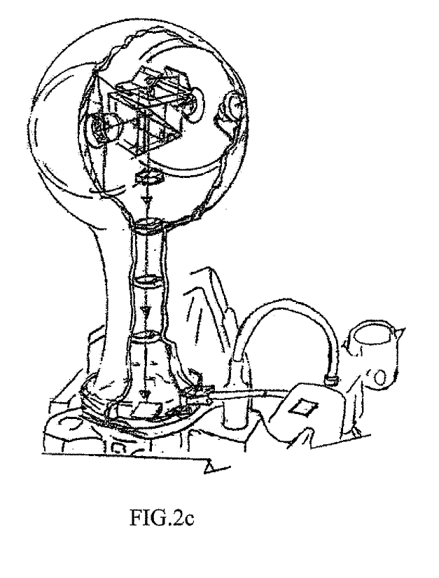

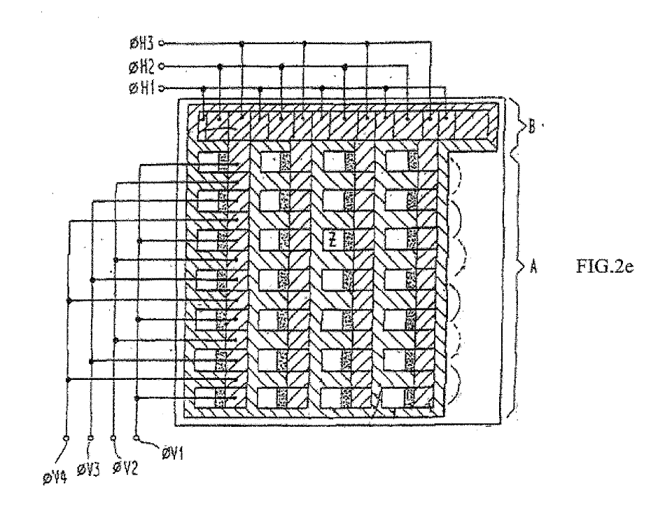

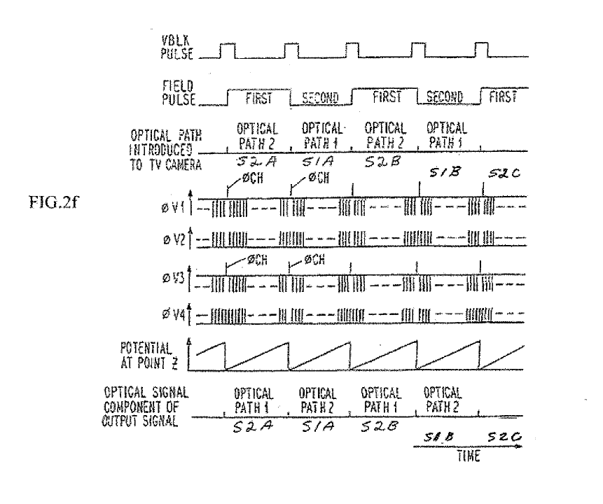

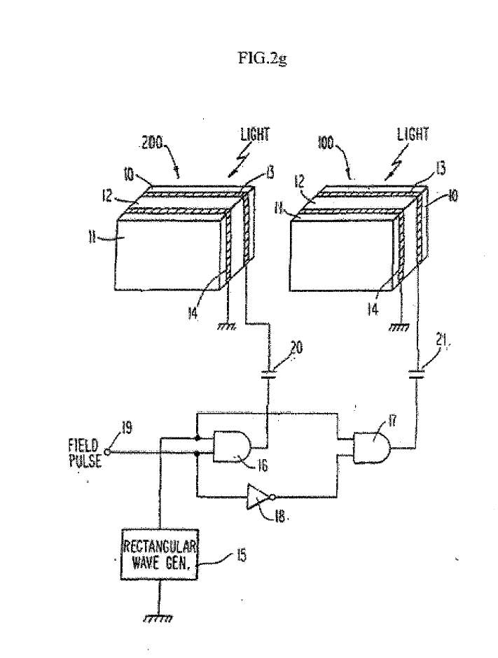

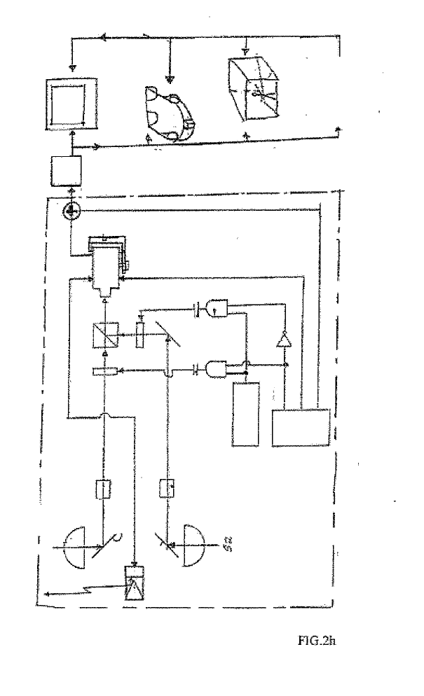

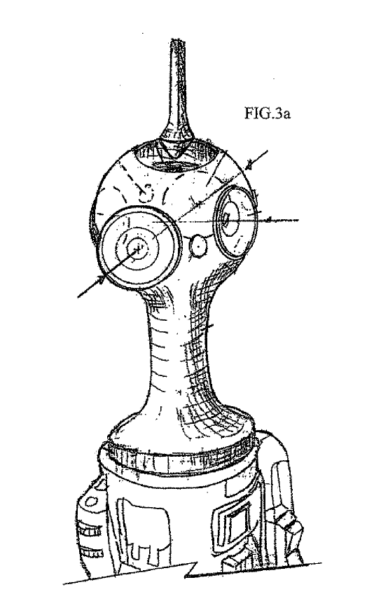

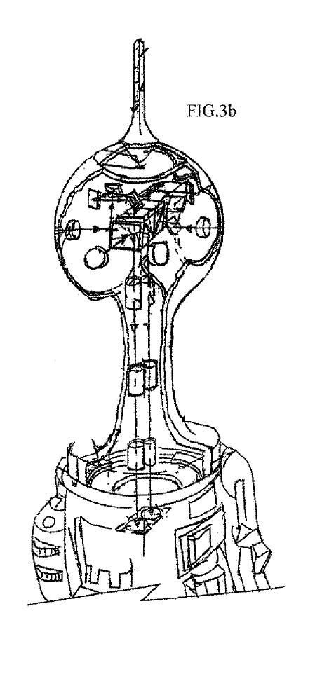

As shown in FIG. 1a and FIG. 1b the reference 1 generally designates a prior art conventional camcorder, and in FIG. 2a and FIG. 2b the reference 2 designates a conventional camcorder that has been modified into a panoramic camcorder. The parts and operation of conventional camcorder 1 is generally well known to those skilled in the art and will not be described in detail except to point out parts and operations not conducive to panoramic recording and that are modified in the present invention to make them conducive to panoramic recording. The conventional camcorder includes a camera body with electronics and power supply within and includes view finder(s) 3, manual control buttons and setting buttons 4 with LED displays, videotape cassette with recorder 5, boom microphone 6, conventional video camera taking lens 7 with a lens mount 8 that may or may not be interchangeable, remote control signal receiver(s) 9, and a screw-in tripod socket 10 on the bottom of the camera.

FIG. 1c shows a prior art conventional remote control unit 11 that comes with a conventional camera that includes standard control buttons 12. Controls include play, rewind, stop, pause, stop/start. The remote control unit includes a transmitter for communicating with the camera unit. The transmitter 13 sends a radio frequency signal 14 or infrared signal 15 over the air to receiver 9 sensors located on the camera body that face forward and backward from the camera. The remote control unit is powered by batteries located in a battery storage chamber 16 within the housing/body of the remote control unit.

FIG. 1d shows a camera operator using conventional remote control unit to control a conventional video camcorder mounted on a tripod. This is shown to illustrate the limitations of using a conventional camcorder, remote control unit, and camera mount for recording panoramic camcorder images.

FIG. 1e through FIG. 1g illustrate prior art methods of recording composite images of spherical FOV imagery on a single frame. The limitation with conventional frames is that they only have so much resolution, and when a portion of the frame is later enlarged it lacks the resolution necessary required for panoramic videography. In the figures N corresponds to a single frame, N+1 to a second frame, and so on and so forth in a sequence of video frames. FIG. 1e is a prior art diagram of a sequence of conventional frames recorded by a camera in FIG. 1a or FIG. 1b. FIG. 1f is a prior art drawing of a sequence of conventional frames recorded by a single monoscopic panoramic camera according to the prior art of U.S. Pat. No. 5,130,794, claim 4. A and B refer to hemispherical images recorded on a single frame N by two back-to-back fisheye lenses that have adjacent FOV coverage. FIG. 1g is a prior art drawing of a sequence of conventional frames recorded by a single stereoscopic panoramic camera according to the prior art of U.S. Pat. No. 5,130,794, claim 4. A, B, C, and D refer to hemispherical images recorded on a single frame N by four back-to-back fisheye lenses that have adjacent overlapping FOV coverage. It is plane to see as the amount of information is compressed on a single frame with constant resolution the resultant resolution of the images when enlarges goes down.

FIG. 1h is a prior art diagram of a sequence of conventional frames recorded by two separate cameras which each record a respective hemisphere that comprise a panoramic spherical FOV scene are frame multiplexed electronically by a video multiplexer device as described in described in U.S. Pat. No. 5,130,794. Interlacing and alternating image frame information from two cameras increases the resolution. However, it requires two cameras, which can be costly. Most consumers can only afford to have a single camcorder. The present invention uses an electro-optical adapter to multiplex two alternating images onto a single conventional camcorder.

In view of the above difficulties with the prior art, it is an object of the present invention to provide a three-dimensional image pickup apparatus which is inexpensive in construction and easy in adjustment. To achieve the above object, the three-dimensional image pickup apparatus of the present invention employs a television camera equipped with an imaging device which has at least photoelectric converting elements and vertical transfer stages and which is so designed as to read out signal charges stored in the photoelectric converting elements one or more times for every field by transferring them almost simultaneously to the corresponding vertical transfer states, and alternately selects object images projected through two different optical paths for every field for picking up an image, the selection timing being approximately in synchronization with the transfer timing of the signal charges from the photoelectric converting elements to the vertical transfer stages. (Pat 994, p 7). In the above construction, object images projected through the two optical paths are alternately selected in synchronization with the field scanning of the imaging device, thereby permitting the use of a single television camera for picking up an image in three dimensions. The imaging device employed in the television camera has at least photoelectric converting elements and vertical transfer stages. In the case where the photoelectric converting elements contains the vertical transfer stages, the imaging device has a storage site for the signal charges on the extension of each vertical transfer stages in the transferring direction, and since the signal charges stored in the photoelectric converting elements are transferred almost simultaneously to the corresponding vertical transfer stages for simultaneous pickup of the whole screen of the image, the imaging device capable of surface scanning is used. The storage time of the signal charges in each photoelectric converting element of the imaging device is equal to, or shorter than the time needed for scanning one field. The object images projected through the two optical paths onto the imaging device are alternately selected using optical shutters, approximately in synchronization with the timing of transferring the signal charges from the photoelectric converting elements to the vertical transfer stages of the imaging device. By using the above-mentioned imaging device, by setting the signal charge storage time in each photoelectric converting element of the imaging device to be less than the time needed for scanning one field, and by approximately synchronizing the selection timing of the optical paths with the timing of transferring the signal charges from the photoelectric converting elements to the vertical transfer stages of the imaging device, it is possible to pick up an image of good quality in three dimensions using a single television camera. (Pat 994, p 7)

FIG. 2a is an exterior perspective view of a stereographic camcorder of prior art. The stereographic camcorder in FIG. 2a is the same camcorder of FIG. 1a, except that a stereographic taking lens has been mounted on the camera body. Such a stereographic camera is disclosed in U.S. Pat. No. 5,028,994, and the taking lens was sold by Canon Corporation as the “3D Zoom Lens for the XL1 DV Camcorder” starting in October 2001. The stereo adapter lens and camera cooperate to record alternating left/optical path 2 and right eye/optical path 1 images.

Correspondingly, the stereographic camcorders electro-optical system in FIG. 2a is modified in the present invention to form an adapter for panoramic recording. In FIG. 2b and FIG. 2c the panoramic lens and camera cooperate to record alternating optical path 2 and optical path one images. The subject in front of fisheye lens #1 is transmitted on-center along optical path #1. The image from objective lens, here a fisheye lens is relayed by relay means, here a concave lens, to through shutter #1. If shutter #1 is open the image proceeds down the optical path through the beamsplitter. The cube beamsplitter contains a semi-transparent mirror oriented at 45 degrees to the optical path. The image is reflected by the semi-transparent mirror #1 thorough relay lenses #1 to the light sensitive recording surface of the camera. If the shutter is closed then transmitted image from relay lens #1 is blocked. Correspondingly, the subject in front of fisheye lens #2 is transmitted on-center along optical path #2. The image from objective lens, here a fisheye lens of greater than 180 degree field-of-view, is relayed by relay lenses, reflected by mirrors #2a, b, and c, through shutter #2. If shutter #2 is open the image proceeds down the optical path through the beamsplitter. The image transmitted through the semi-transparent mirror #1 to relay lenses #2a to the nth to the light sensitive recording surface of the camera. If the shutter is closed then transmitted image from relay lens #2 that is reflected by the mirrors a, b, and c is blocked. The shutters alternate in the open and closed position to allow a full frame image from one objective lens and then the other to be recorded frame after frame. In this manner image resolution is increased over trying to put both images on a single frame, the flexibility of using an adapter lens is realized, and the cost of only having to buy one camera to do panoramic or zoom lens videography is accomplished.

FIG. 2d is a drawing of a sequence of conventional frames recorded by the monoscopic panoramic camcorder arrangement shown in FIG. 2b and FIG. 2c. The sequence of alternating optical path #1 and optical path #2 hemispherical A and B images are frame multiplexed by the electro-optical arrangement shown in those figures and FIG. 2g and FIG. 2h.

FIG. 2h is a schematic diagram of the monoscopic panoramic camera arrangement of the present invention illustrated in FIG. 2b. In FIG. 2h, shown on side A of the dashed line is a panoramic image pickup apparatus, while a three-dimensional display apparatus is shown on side B. The numeral 40 indicates a television camera, the numeral 4 a synchronizing signal generator, the numeral 6 an adder, the numerals 22, 23 and 26 mirrors, the numerals 24 and 27 liquid crystal shutters, the numeral 25 a semitransparent mirror, the numeral 28 an inverter, the numerals 16 and 17 AND circuits, the numeral 15 a rectangular wave generator, the numerals 20 and 21 capacitors, and the numeral 100 a liquid crystal shutter driving circuit. The mirrors 22 and 23, the liquid crystal shutter 24, and the semitransparent mirror 25 constitute a first optical path while the mirror 26, the liquid crystal shutter 27, and the semitransparent mirror 25 constitute a second optical path. The synchronizing signal generator 4, the adder 6, the mirrors 22, 23 and 26, the liquid crystal shutters 24 and 27, the semitransparent mirror 25 and the television camera 40 constitute the three-dimensional image pickup apparatus.

The operation of the panoramic apparatus is now described. To the television camera 40, pulse signals necessary for driving the television camera are supplied from the synchronizing signal generator 4. The television camera driving pulses, field pulses, and synchronizing pulses supplied from the synchronizing signal generator 4 are all in synchronizing relationship with one another. The light from an object introduced through the mirrors 22 and 23 and the liquid crystal shutter 24 is passed through the semitransparent mirror 25, and then focused onto the photoelectric converting area of an imaging device

provided in the television camera 40. The light from the object introduced

through the mirror 26 and the liquid crystal shutter 27 is deflected by 90

degrees by the semitransparent mirror 25, and then focused onto the

photoelectric converting area of the imaging device provided in the television

camera 40. The optical paths 1 and 2 are disposed with their respective optical

axes forming a given angle .theta. (not shown) with respect to the same object.

(The optical paths 1 and 2 correspond to the human right and left eyes,

respectively).

FIG. 2g is a block diagram showing the construction of the optical shutter depicted in FIG. 2b.

The optical shutters useful in the present invention are which liquid crystal

shutters which capable of transmitting and obstructing light by controlling the voltage, which respond sufficiently fast with respect to the field scanning frequency of the television camera, and which have a long life. The optical shutters using liquid crystals may be of approximately the same construction as those previously described with reference to FIG. 2g. Since they operate in the same principle, their construction and operation are only briefly described herein.

Each of the liquid crystal shutters 24 and 27 comprise the deflector plates 10 and 11, the liquid crystal 12, and the transparent electrodes 13 and 14 shown in FIG. x. The liquid crystal shutters 24 and 27 are controlled by the driving pulses supplied from the liquid crystal shutter driving circuit. As previously described with reference to FIGS. x and x, description is given here supposing that the liquid crystal shutters become light permeable when the field pulse supplied to the AND circuits 16 and 17 that form part of the liquid crystal shutter driving circuit is at a low level. It is also supposed that the field pulse is at a high level for the first field and at a low level for the second field. Therefore, the liquid crystal shutter 27 shown in FIG. x transmits light in the first field, while the liquid crystal shutter 24 transmits light in the second field. This means that in the first field the light signals of the object image introduced through the second optical path is projected onto the imaging device, while in the second field the light signals of the object image introduced through the first optical path is projected onto the imaging device.

The imaging device receives the light signals of the object image on its photoelectric converting area, basically, over the period of one field or one frame, and integrates (stores) the photoelectrically converted signal charges over the period of one field or one frame, after which the thus stored signal charges are read out. Therefore, the output signal is provided with delay time equivalent to the period of one field against the light signals projected on the imaging screen.

If a line-sequential scanning image device such as an image pickup tube or an X-Y matrix imaging device (MOS imaging device) is used for the television camera 40, three-dimensional image signals cannot be obtained. The reason will be explained with reference to FIG. x. FIG. x shows diagrammatically the conditions of the television camera scanning field and the liquid crystal shutters and the potential at a point A on the imaging screen (photoelectric converting area) of the above line-sequential scanning imaging device, while FIG. x shows the imaging screen of the line-sequential scanning imaging device.

The light signals of the optical image to be projected onto the imaging device are introduced through the second optical path (liquid crystal shutter 27) in the first field, and through the first optical path (liquid crystal shutter 24) in the second field. For convenience of explanation, the light signals introduced through the first optical path are hereinafter denoted by R, and the light signals introduced through the second optical by L. Description will be given by taking the above mentioned image pickup tube which is a line-sequential scanning imaging device, as an example of the imaging device. The potential at the point A on the imaging screen of the image pickup tube gradually changes with time as the stored signal charge increases. The signal charges at the point A are then read out when a given scanning timing comes. At this point of time, however, as is apparent from FIG. x, the signal charge component SR generated by the light introduced through the first optical path and the signal charge component SL generated by the light introduced through the second optical path are mixed in the signal charge generating at the point A. This virtually means

that the light from the two optical paths are mixed for projection onto the

imaging device, and therefore, the television camera 40 is only able to produce

blurred image signals, thus being unable to produce three-dimensional image

signals. Therefore, for the television camera 40, this embodiment of the

invention uses an imaging device which has at least photoelectric converting

elements and vertical transfer stages, or in the case where photoelectric

converting elements and vertical transfer stages are combined, an imaging device which has a storage site provided on the extension of each vertical transfer stage in its transferring direction. Also, the storage time of the signal charge in the photoelectric converting elements of the imaging device is set at less than the time needed for scanning one field. The optical images introduced

through the two optical paths into the imaging device are alternately selected

for every field using optical shutters approximately in synchronization with the

timing of transferring the signal charges from the photoelectric converting

elements to the vertical transfer stages of the imaging device of the above

construction.

FIG. 2e is a schematic diagram showing the construction of an imaging device used in the camera in FIG. 1a, FIG. 2a, and in the improved monoscopic panoramic recording arrangement that forms the present invention depicted in FIG. 2b. The image device includes a buffer that allows the storage of a complete frame of imagery prior to scanning for the next frame. Each shutter is synchronized with the timing of the imaging device in order record alternating side 1 and side 2 fisheye images that comprise the composite spherical field of view scene.

Imaging devices useful in the present invention include an interline transfer charge-coupled device (hereinafter abbreviated as IL-CCD), a frame transfer charge-coupled device (hereinafter abbreviated as FT-CCD), and a frame/interline transfer charge-coupled device (hereinafter abbreviated as FIT-CCD). In the description of this embodiment, we will deal with the case where an IL-CCD is used as the imaging device. FIG. x is a schematic diagram showing the construction of an interline transfer charge-coupled device (IL-CCD) used in the three-dimensional image pickup apparatus according to this embodiment of the invention. Since the IL-CCD is well known, its construction and operation are only briefly described herein. As shown in FIG. x, the IL-CCD is composed of a light receiving section A and a horizontal transfer section B. The numeral 41 indicates a semiconductor substrate. The light receiving section A comprises two-dimensionally arranged photoelectric converting elements (light receiving elements) 42, gates 44 for reading out signal charges accumulated in the photoelectric converting elements, and vertical transfer stages 43 formed by CCDs to vertically transfer the signal charges read out by the gates. All the areas except the photoelectric converting elements 42 are shielded from light by an aluminum mask (not shown).

The photoelectric converting elements are separated from one another in both vertical and horizontal directions by means of a channel stopper 45. Adjacent to each photoelectric converting element are disposed an overflow drain (not shown) and an overflow control gate (not shown). The vertical transfer stages 43 comprise polysilicon electrodes .phi.V1, .phi.V2, .phi. V3, and .phi.V4, which are disposed continuously in the horizontal direction and linked in the vertical direction at the intervals of four horizontal lines. The horizontal transfer section B comprises horizontal transfer stages 46 formed by CCDs, and a signal charge detection site 47. The horizontal transfer stages 46 comprise transfer electrodes .phi.H1, .phi.H2, and .phi.H3, which are linked in the horizontal direction at the intervals of three electrodes. The signal charges transferred by the vertical transfer stages are transferred toward the electric charge detection site 47, by means of the horizontal transfer stages 46. The electric charge detection site 47, which is formed by a well known floating diffusion amplifier, converts a signal charge to a signal voltage. The operation will now be described briefly.

The signal charges photoelectrically converted and accumulated in the photoelectric converting elements 42 and 42 are transferred from the photoelectric converting sections 42 and 42 to the vertical transfer stages 43 during the vertical blanking period, using the signal readout pulse .phi.CH superposed on .phi.V1 and .phi.V3 of the vertical transfer pulses .phi.V1-.phi.V4 applied to the vertical transfer stages. When the signal readout pulse .phi.CH is applied to .phi.V1, only the signal charges accumulated in the photoelectric converting elements 42 are transferred to the potential well under the electrode .phi.V1, and when the signal readout pulse .phi.CH is applied to .phi.V3, only the signal charges accumulated in the photoelectric converting section 42 are transferred to the potential well under the electrode .phi.V3.

Thus, the signal charges accumulated in the two-dimensionally arranged numerous photoelectric converting elements 42 and 42 are transferred to the vertical transfer stages 43, simultaneously when the signal readout pulse .phi.CH is applied. Therefore, by superposing the signal readout pulse .phi.CH alternately on .phi.V1 and .phi.V3 in alternate fields, signals are read out from each photoelectric converting section once for every frame, and thus the IL-CCD operates to accumulate frame information.

The signal charges transferred from the photoelectric converting elements 42 to the electrodes .phi.V1 or .phi.V3 of the vertical transfer stages 43 are transferred to the corresponding horizontal transfer electrode of the horizontal transfer stages 46 line by line in every horizontal scanning cycle, using the vertical transfer pulses .phi.V1, .phi.V2, .phi.V3, and .phi.V4. Also, if the signal readout pulse .phi.CH is applied almost simultaneously to both .phi.V1 and .phi.V3 in one field period, the signal charges accumulated in the photoelectric converting element 42 are transferred to the potential well under the electrode .phi.V1, and the signal charges accumulated in the photoelectric converting element 42 to the potential well under the electrode .phi.V3. Signals are read out from each photoelectric converting element once for every field, and thus the IL-CCD operates to accumulate field information. In this case, the signal charges from the vertically adjacent photoelectric converting elements, i.e. L for the first field and M for the second field, are mixed in the vertical transfer stages, thereafter the signal charges which had been transferred from the photoelectric converting elements 42 to the electrodes .phi.V1 and phi. V3 of the vertical transfer stages 43 are transferred to the corresponding horizontal transfer electrodes of the horizontal transfer stages 46 line by line in every horizontal scanning cycle, using the vertical transfer pulses .phi.V1, .phi.V2, .phi.V3, and .phi.V4. The signal charges transferred to the horizontal transfer electrodes are transferred to the horizontally disposed signal charge detection site 47, using high-speed horizontal transfer pulses .phi.H1, .phi.H2, and .phi.H3, where the signal charges are converted to a voltage signal to form the video signal to be outputted from the imaging device.

FIG. 2f is a timing chart showing the operating timing and liquid crystal shutter switching timing of the present invention depicted in FIG. 2b.

The signal readout timing of the above IL-CCD in the three-dimensional image pickup apparatus of the present invention, the driving timing of the liquid crystal shutter, and the potential change in the photoelectric converting element at point Z shown in FIG. 2b are now shown in FIG. x. FIG. x shows the pulse (VBLK) representing the vertical blanking period, the field pulse emitted from the synchronizing signal generator 4 of FIG. x, the signal readout timing of the IL-CCD, the driving timing of the liquid crystal shutter, the potential change in the photoelectric converting element at point Z, and the output signal from the imaging device. The signal readout (transfer of signal charges) from the photoelectric converting elements to the vertical transfer stages is performed during the vertical blanking period, while the switching of the liquid crystal shutters is approximately coincident with the signal readout timing from the photoelectric converting elements to the vertical transfer stages. The switching timing of the field pulses is also approximately coincident with the signal readout timing from the photoelectric converting elements to the vertical transfer stages. When the imaging device and the liquid crystal shutters are driven with the above timing, the light signals of the optical image are introduced through the second optical path in the first field to be projected onto the imaging device, and, in contrast, the light signals of the optical image are introduced through the first optical path in the second field to be projected onto the imaging device. In this case, the potential at point Z on the imaging screen of the image pickup element gradually changes with time, as shown in FIG. x.

The signal charge at point Z is transferred to the vertical transfer stage at the specified timing (application of the pulse for reading out the signal from the photoelectric converting element to the vertical transfer stage). As is apparent from FIG. 2b, obtained at this time from the point Z is either the signal charge generated from the light introduced through the first optical path or the signal charge generated from the light introduced through the second optical path, thus preventing the light from two different optical paths from being mixed with each other for projection onto the photoelectric converting elements in the imaging device. By using the above construction and by picking up an object image with the above driving timing, the television camera 40 shown in FIG. x is capable of alternately outputting the video signal of the object image transmitted through the first optical path for the first field, and the video signal of the object image transmitted through the second optical path for the second field, thus producing a three-dimensional image video signal. In this embodiment, the signal charges at all photoelectric converting elements are first transferred (read out) to the vertical transfer stages, and then the signal charges from the adjacent photoelectric converting elements are mixed with each other in the vertical transfer stages for further transfer, thus obtaining the video information of field accumulation from the imaging device.

A second embodiment of the present invention will be described with reference to FIG. x. In an IL-CCD, it is possible to obtain video information of field accumulation without mixing the signal charges from two adjacent photoelectric converting elements as is done in the case of the foregoing embodiment. The principle is described referring to FIGS. x and x. FIG. x shows the pulse (VBLK) representing the vertical blanking period, the field pulse emitted from the synchronizing signal generator 4 shown in FIG. x, the signal readout timing of the IL-CCD, the driving timing of the liquid crystal shutters, the potential change in the photoelectric converting element at point Z, and the output signal from the imaging device.

The following describes the operation. During the first field, the signal readout pulse .phi.CH is applied to .phi.V3 to transfer the signal charges generated at the photoelectric converting element 42 to the vertical transfer stage. The signal charges are then transferred at high speed, using a high-speed transfer pulse .phi.VF attached to the vertical transfer pulses .phi.V1-.phi.V4, and are emitted from the horizontal transfer stage. Thereafter, the signal readout pulse .phi.CH is applied to .phi.V1 to transfer the signal charges generated at the photoelectric converting element 42 to the vertical transfer stage 43. The signal charges are then transferred, line by line in every horizontal scanning cycle, to the corresponding horizontal transfer electrode of the horizontal transfer stage 46, using the vertical transfer pulses .phi.V1-.phi.V4, thereby conducting the horizontal transfer. During the second field, the signal readout pulse .phi.CH is applied to .phi.V1 to transfer the signal charges generated at the photoelectric converting element 42 to the vertical transfer stage 43. The signal charges are then transferred at high speed, using a high-speed transfer pulse .phi.VH attached to the vertical transfer pulses .phi.V1-.phi.V4, and are emitted from the horizontal transfer stage. After that, the signal readout pulse .phi.CH is applied to .phi.V3 to transfer the signal charges generated at the photoelectric converting element 42 to the vertical transfer stage. The signal charges are then transferred, line by line in every horizontal scanning cycle, to the corresponding horizontal transfer electrode of the horizontal transfer stage 46, using the vertical transfer pulses .phi.V1-.phi.V4, thereby conducting horizontal transfer. With the above operation, it is possible to obtain the video signal of field accumulation. As is apparent from FIG. x, the above-mentioned emission of unnecessary signal charge and transfer of the signal charges from the photoelectric converting section to the vertical transfer stage are performed during the vertical blanking period, thus preventing the light from the two optical paths from being mixed with each other for projection onto the photoelectric converting elements in the imaging device. Therefore, the television camera 40 shown in FIG. x alternately outputs the video signal of the object image transmitted through the optical path 1 for the first field, and the video signal of the object image transmitted through the optical path 2 for the second field, thus producing a three-dimensional image video signal.

In the IL-CCD, it is also possible to set the storage time of the signal charges in the photoelectric converting elements so as to be shorter than the field period. The purpose of a shorter storage time of the signal charges is to improve the dynamic resolution of the video signal. The imaging device produces the video signal by integrating (accumulating) the signal charges generated by the light signals projected onto the photoelectric converting element.

Therefore, if the object moves during the integrating time of the signal charges, the resolution (referred to as the dynamic resolution) of the video signal will deteriorate. To improve the dynamic resolution, it is necessary to provide a shorter integrating (accumulating) time of the signal charges. The present invention is also applicable to the case where a shorter integrating (accumulating) time of the signal charges is used.

The following describes the principle with reference to FIGS. x and x. FIG. x shows the pulse (VBLK) representing the vertical blanking period, the field pulse emitted from the synchronizing signal generator 4 shown in FIG. 1, the signal readout timing of the IL-CCD, the driving timing of the liquid crystal shutters, the potential at the overflow control gate, the potential change in the photoelectric converting element at point Z, and the output signal from the imaging device.

An overflow drain (abbreviated as OFD) is provided, as is well know, to prevent the blooming phenomenon which is inherent in a solid-stage imaging device including the IL-CCD. The amount of charge which can be accumulated in the photoelectric converting element is set in terms of the potential of an overflow control gate (abbreviated as OFCG). When the signal charge is generated exceeding the set value, the excess charge spills from the OFCG into the OFG, thus draining the excess charge from the imaging device.

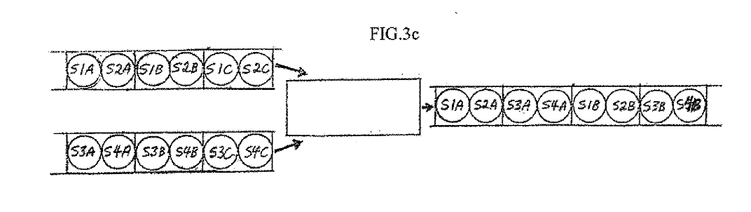

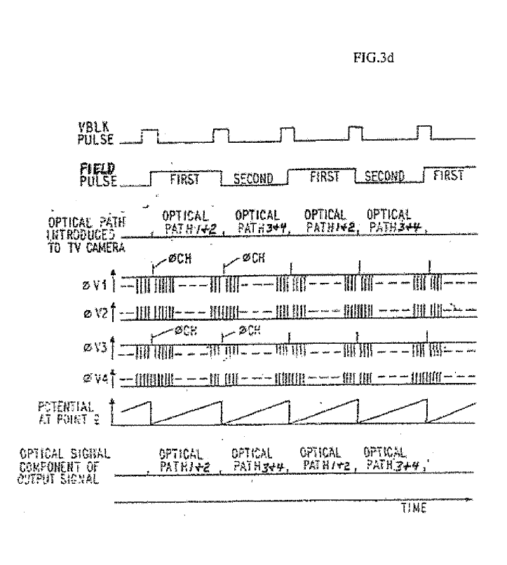

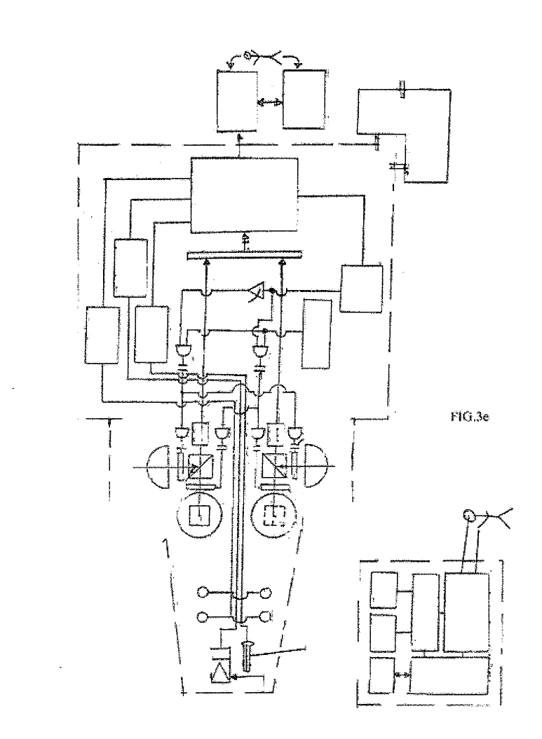

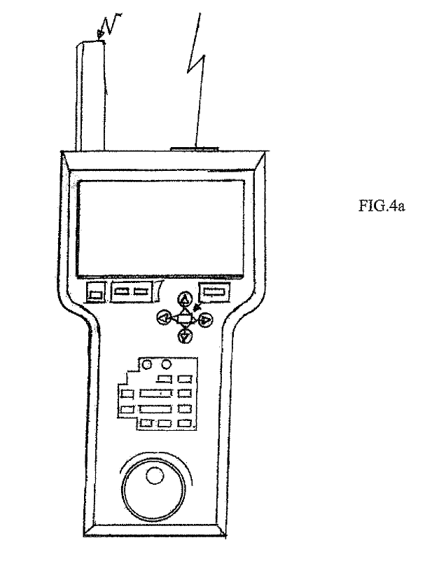

Therefore, when the potential barrier of the OFCG is lowered (i.e., the voltage applied to the OFCG is increased) while the light signals from the object are projected onto the photoelectric converting elements (i.e., during the vertical blanking period), the signal charges accumulated in the photoelectric converting elements are spilled into the OFD. As a result, the potential of the photoelectric converting element at point Z is as shown in FIG. 3b. The above operation makes it possible to obtain a video signal with the storage time shorter than the field period. Thus, the light from the two optical paths is prevented from being mixed with each other and being projected onto the photoelectric converting elements in the imaging device. Therefore, the television camera 40 shown in FIG. x alternately outputs the video signal of the object image transmitted through the optical path 1 for the first field, and the video signal of the object image transmitted through the optical path 2 for the second field, thus producing a three-dimensional image video signal.

In this embodiment, description has been giving dealing with the case of a horizontal OFD with and OFCG and an OFG which are disposed adjacent to each photoelectric converting element, but the present invention is also applicable to the case in which a vertical OFD disposed in the internal direction of the imaging device is used. The operating principle described with reference to FIG. x can be directly applied to the case in which the storage time is controlled by using an frame/interline transfer solid-state imaging device. Since the frame/interline transfer solid-state imaging device is described in detail in

Japanese Unexamined Patent Publication (Kokai) No. 55(1980)-52675, a description of this device will not be given. This imaging device is essentially the same device as the above-mentioned interline transfer solid-state imaging device except that a vertical transfer storage gate is disposed on the extension of each of the vertical transfer stages. The purpose of this construction is to reduce the level of vertically generated smears by sequentially reading out the signal charges in the light receiving section after transferring them at high speed to the vertical storage transfer stage, as well as to enable the exposure time of the photoelectric element to be set at any value. Setting the exposure time of the photoelectric converting element at any value has the same effect as described in FIG. x in terms of an example of control of the exposure time (storage time) using the interline solid-state imaging device. Referring again to FIG. x, the optical paths are alternately selected to project light into the television camera, approximately in synchronization with the timing of reading out the signal charges from the photoelectric converting elements to the vertical transfer stages. Alternatively, as is apparent from FIG. x, the optical paths may be alternately selected using the liquid crystal shutters, approximately in synchronization, for example, with the timing at which the pulse voltage is input to be applied to the OFCG. Also, an object image through each optical projected onto the photoelectric converting elements may be approximately equal to the period from the timing of application of the pulse voltage to the OFCG to the timing of application of the readout pulse.

It is also apparent that in the case where a storage period of the signal charges in the photoelectric converting elements is shorter than the field period, the projection periods from the two optical paths into the television camera are not necessary to be equal. In other words, the object image through each optical path projected onto the photoelectric converting elements of the solid-stage imaging device should be approximately equal to or cover the signal storage time.

As described above, according to the present invention, object images introduced through two different optical paths are alternately selected in synchronization with the field scanning of the imaging device, thus permitting the use of a single television camera for picking up an image in three dimensions. In this embodiment, the timings shown in FIGS. x and x are used, but the signal charge readout timing and the switching timing of the liquid crystal shutters have only to be set inside the vertical retrace period. Also, the relative division of the signal charge readout timing with respect to the switching timing of the liquid crystal shutters is allowable for practical use if the deviation is inside the vertical retrace period. In this embodiment, description of the three-dimensional image pickup apparatus has been omitted as it is exactly the same as the one described with reference to FIG. x. Industrial Applicability

As described above, the present invention can provide a panoramic image pickup apparatus using a single television camera which is inexpensive. Therefore, the panoramic image pickup apparatus of the present invention does not only allow anyone who does not have a special skill to shoot an object to produce an image in three dimensions, but in the preferred embodiment as a camcorder also provides improved mobility of the apparatus.

And finally, the above specification teaches several new ways for building a panoramic camcorder. The present invention teaches that generally any stereographic camera can be modified into a panoramic camera by swapping out the stereographic lenses that are oriented in parallax and replacing them with two fisheye lenses faced in opposite directions that have adjacent FOV coverage. And furthermore the present invention teaches the swapping out of the stereographic lenses and replacing one of the image paths with an electro-optical assembly comprising two fisheyes faced in opposite directions that have adjacent FOV coverage and using the second image path with a conventional zoom lens to record conventional imagery such that either type of imagery may be recorded, or that imagery from path one and path two may be recorded in an alternating manner.

FIG. 3a is an exterior perspective view of a conventional camcorder incorporating improvements disclosed herein to facilitate improved recording of a stereoscopic panoramic scene. To accomplish this the stereographic panoramic audio-visual recording assembly is attached to a conventional camcorder. FIG. 3e is a schematic diagram of the sterographic panoramic camera arrangement shown in FIG. 3a. The assembly consists of a housing that holds the assembly components in place. Principal components of the system include optical and electro-optical elements to enable the recording of images representing a panoramic scene, microphones to enable recording of audio signals representing a panoramic environment, and a lens mount for attaching the assembly in communicating relationship to the camera mount of an associated camera. Other principal components include an antenna and associated components to receive wirelessly transmitted video signals from the camera and transmit control signals to the camera from a remote control unit.

FIG. 3b is a cutaway perspective view of the panoramic sterographic optical recording system shown in 3a that illustrates the general operation of the system. In operation images are recorded in alternating fashion by fisheye lens S1 and S2 are recorded simultaneously, and then recorded from fisheye lens S3 and S4. The optical shutters useful in the present invention are liquid crystal shutters capable of transmitting and obstructing light by controlling the voltage, which respond sufficiently fast with respect to the field scanning frequency of the television camera, and which have a long life. The optical shutters using liquid crystals may be of approximately the same construction as those previously described with reference to FIG. 2g.

FIG. 3c is a drawing of a sequence of conventional frames recorded by a sterographic panoramic camcorder arrangement shown in FIG. 3a. FIG. 3d is a timing chart showing the operating timing and liquid crystal shutter switching timing of the present invention depicted in FIG. 3a. There operation is accomplished in a similar way to that previously described above in FIG. 2c through 2h. Only instead of using two shutters, four shutters are used. In one time interval two of the shutters of S1 and S2 obstruct associated images from fisheyes of S1 and S2, while the other two shutters are open to allow the transmission of the images of S3 and S4. In the second time interval two of the shutters of S3 and S4 obstruct allow images from fisheye lenses of S1 and S2, while the other two shutters are open to allow the transmission of the images from fisheye lenses of S1 and S2.

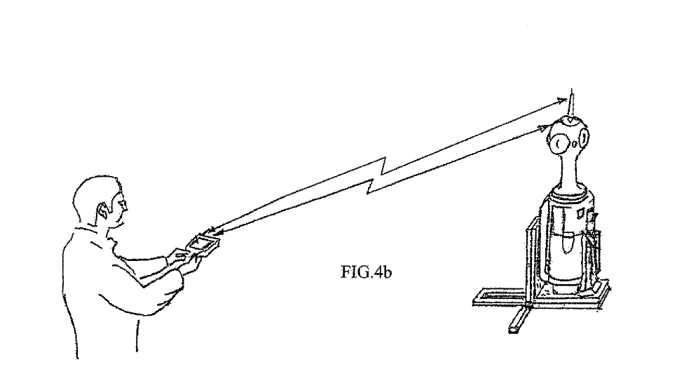

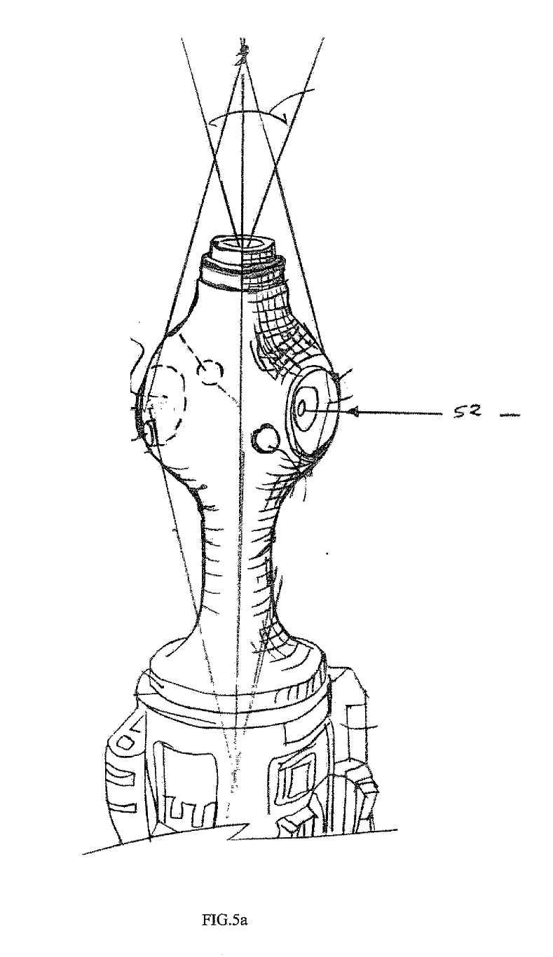

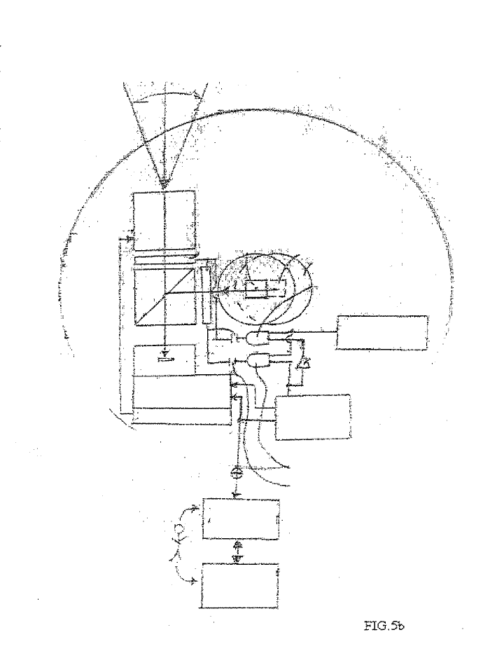

FIG. 4a is an exterior perspective view of a generalized design for a remote control unit that includes a display unit for use with a panoramic camcorder like that shown in FIGS. 2b and 3a. The remote control unit includes an antenna for an antenna and associated components to receive wirelessly transmitted video signals from the camera and transmit control signals to the camera from a remote control unit, electrical power unit, image display, audio means, control buttons, processing unit, and assembly housing.

In it's simplest form, the remote control unit generally described in FIG. 4a may be constructed by bundling a conventional remote control unit and a wireless video transmitter and receiver unit. The remote control unit may be like that shown in FIG. 1c.

The wireless video transmitter and receiver unit may be like that described in FIG. Radio Electronics magazine articles, such as those by William Sheets and Rudolf F. Graf, entitled “Wireless Video Camera Link”, dated February 1986, and entitled “Amateur TV Transmitter” dated June 1989. Similarly, U.S. Pat. No. 5,264,935, dated November 1993, by Nakajima presents a wireless unit that may be incorporated in the present invention to facilitate wireless video transmission to the control unit and reception by the panoramic camera control unit. In this arrangement the wireless video transmitter transmits a radio frequency signal from the camera to the receiver located on the remote control unit.

In this arrangement the control unit uses a transmitter arrangement like that found with typical camcorder units. The remote control unit transmits an infrared signal to the panoramic camera system. However, it is preferable that the typical camcorder transmitters have been reoriented so that they face the sides when the camera is pointed in the vertical direction to facilitate panoramic recording. For example, the infrared sensor arrangement shown in FIG. 3a and FIG. 3b facilitate the reception of infrared signals sent by the panoramic camera remote control unit.

FIG. 4b is a perspective of an operator using the remote control unit in FIG. 4a to interact with a panoramic camera like that described in FIGS. 2b and 3a.

Alternatively, a modem with transceiver may transmit video signals from the camcorder to a transceiver and modem that form part of the remote control unit. And the same modem and transceiver may transmit control signals back to the camera. A modem and transceiver to accomplish this is presented in U.S. Pat. No. 6,573,938 B1, dated June 2003, by Schulz et al. Similarly, in U.S. Pat. No. 6,307,589 B1 dated October 2001 by Maquire and U.S. Pat. Nos. 6,307,526 dated 23 Oct. 2001 and 6,614,408 B1 dated September 2003 by Mann wireless modems and signal relay systems that are incorporated into the present invention for sending video signals to the panoramic remote control unit and the panoramic camera to remote devices are disclosed. In those systems they are not used with panoramic recording and control system. The present invention takes advantage of those systems to advance the art of panoramic videography.

Discuss incorporation of the modem on the camera.

Discuss incorporation of the modem on the remote control unit.

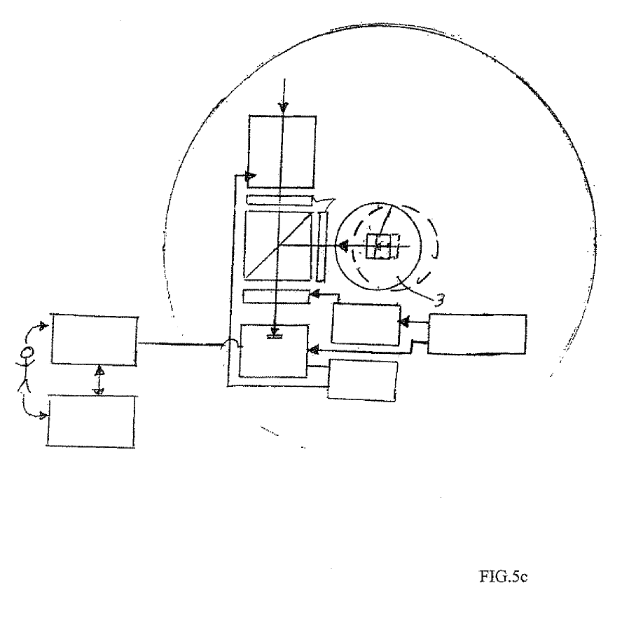

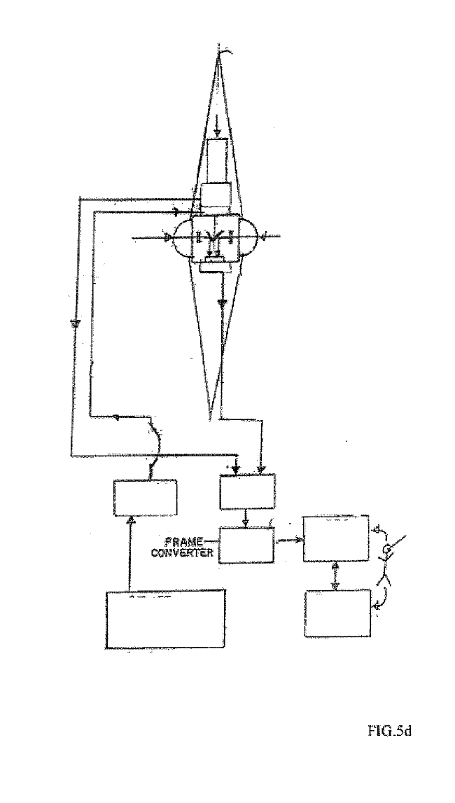

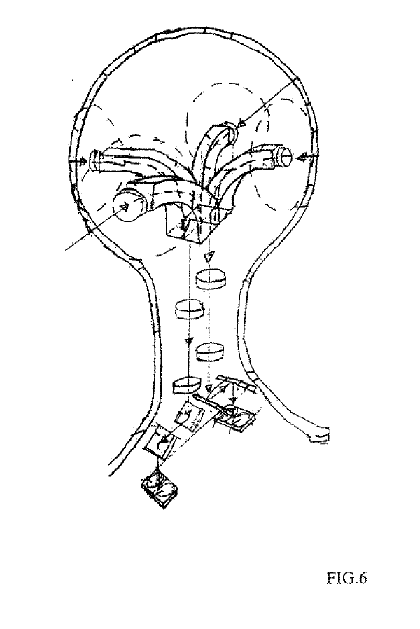

FIG. 5a illustrates a method of optically distorting an image using fiber optic image conduits according to U.S. Pat. No. 4,202,599, dated 1978 and U.S. Pat. No. 4,202,599 dated 1980 by Tosswill, consistent with and an undated “technical memorandum 100 titled fiber optics: theory and applications” by Galileo Electro-Optics Corporation, pp. 1-12. Specifically, page 12 of this document describes a fiber optic assembly called “Fibreye”, Trademarked by Galileo, that can magnify or compress an image with controlled non-linearity.

FIG. 5b illustrates applying fiber optic image conduits as illustrated in FIG. 5a to the present invention in order to remove or reduce barrel distortion from an image taken with a fisheye or wide-angle objective lens.

FIG. 5c is a cutaway perspective view of an alternative specially designed fiber optic image conduit arrangement according to FIGS. 5a and 5b that is applied to the present invention in order to reduce or remove distortion from wide-angle and/or fisheye objective lenses. The Fibreye arrangement is positioned in the optical path between the objective lens and the recording surface of the camera. The barrel distorted image taken by the objective lens is focused onto the entrance end of the fiber optic image conduit. The fiber optic image conduits in the Fibreye arrangement are oriented and arranged to remove or eliminate the barrel distortion as described in FIG. 5a and FIG. 5c. The resultant image that appears on the exit end of the fiber optic image conduit is then transmitted to the recording surface of the camera. The exit end of the fiber optic image conduit may be affixed directly to the CCD. However, typically relay or focusing lenses are provided at the entrance and exit end of the fiber optic image conduit to transmit the image to its intended target.

FIG. 5a′ is an exterior perspective drawing of a combined panoramic spherical FOV and zoom lens camcorder system. Fisheye lens #1 and fisheye lens #2 cooperate to record two hemispherical images on a frame when the camera is set to record in the panoramic mode. Alternatively, the camera may be held and set to be operated like a normal camera to record a directional image using the cameras zoom lens.

FIG. 5b′ is a schematic drawing of the electro-optical system and related components and systems associated with the camcorder system shown in FIG. 5a′ that incorporates liquid crystal shutters. In operation, the user uses camera controls to select whether which liquid crystal shutters of S1 or S2 transmit and obstruct images by controlling the voltage, which respond sufficiently fast with respect to the field scanning frequency of the television camera. The optical shutters using liquid crystals may be of approximately the same construction as those previously described with reference to FIG. 2g. Since they operate in the same principle, their construction and operation are only briefly described herein. When the shutter of S1 is open each respective images from each respective fisheye lenses S1 and S2 are reflected by mirrors S1 and S1 through the shutter to the beamsplitter and reflected by the semi-transparent mirror of the beamsplitter at 45 degrees to the image surface of the camera. The fisheye objective lenses, their associated relay lenses, and 45 degree mirrors are positioned back-to-back such that the two hemispherical images are imaged beside one another on the image surface of the camera as shown in FIG. 1f. Alternatively, when the shutter for panoramic lenses is blocked, the shutter for zoom lens recording is open and the image from the zoom lens and its associated relay lenses transmit the image through the open shutter through the shutter and beamsplitter to the image surface of the camera. Relay optics may be positioned at various points along the optical axis of the zoom or panoramic lenses to insure proper relay and focusing of the respective zoom or panoramic image on the image surface of the camera.

FIG. 5c′ is a schematic drawing of an alternative embodiment of the electro-optical system and related components and systems associated with the video camcorder system shown in FIG. 5a′that incorporates polarization. Generally any stereographic electro-optical and optical system that uses polarizers like U.S. Pat. No. 6,259,865, dated July 2001, by Burke et al., U.S. Pat. No. 5,003,385, dated 1991, by Sudo, and U.S. Pat. No. 5,007,715 by Verhulst, dated April 1991, can be modified into a panoramic camcorder system consistent with the present invention. (starting here U.S. Pat 715).

In FIG. 5c′ an adapter enables panoramic motion photography by means of a single camera, video or film, that includes a single lens system and image pickup. The adapter replaces the conventional zoom lens of the camera and is engageable to a conventional camera. Back-to-back fisheye lenses and associated relays transmit adjacent hemispherical images in an alternating fashion to the image surface of the camera. The two perspective views are alternatingly and orthogonally polarized and applied to a single switchable liquid crystal polarization rotator that is driven by a periodic SYNC signal derived from the camera. A polarization filter receives the output of the rotator which alternately passes perspective views unaltered and rotated by ninety degrees in polarization, providing alternating frames of one or another perspective view to the camera. The stream of alternating adjacent hemispherical images when processed by conventional video and film camera systems. The alternating images may then be stitched together, distortion removed, and then viewed using computer processing and panoramic manipulation and viewing software application programs.

As shown in FIG. 1, an operator 14 employs the single video camera 12 with the three-dimensional adapter 10 affixed to the lens assembly 18 of the video camera 12 in accordance with the invention. The adapter 10 enables a single operator 14 to record and store images suitable for creation of depth perception within the recorded field-of-view when projected, displayed or otherwise played-back.

FIG. 2 is a cross-sectional view of the adapter 10 of FIG. 1 taken generally in the direction of line 2-2 of FIG. 1. The adapter 10 is shown engaged to the representative video camera 12 with top portions of a housing 16 removed to facilitate comprehension. As can be seen, the adapter 10 is coupled to the front of the lens assembly 18 of the video camera 12 by means of a threaded coupling 20. A glass window 22 is provided at the front of the adapter 10. The interior of the adapter housing 16 accommodates both an optical system and associated electronics. A glass cube 24 houses a beamsplitter layer 26. The cube 24 is positioned so that the layer 26 intercepts both the left and right eye views generated by the adapter 10. The cube 24 lies between a polarizer 29 that may comprise a polarizing film fixed to the front vertical surface of the cube 24 and a switchable polarization rotator 28 that contacts the rear surface of the cube 24. A second polarizer 30 (shown in FIG. 3) is parallel to, and may comprise a polarizing film fixed to the bottom surface of the cube 24. It is an essential feature of the present invention that the first polarizer 29 and the second polarizer 30 are arranged so that light, upon passage through the first polarizer 29, assumes a first linear polarization while, after passage through the second polarizer 30, it assumes a second, orthogonal linear polarization.

A mirror 31 completes the gross optical system of the adapter 10. The mirror 31 is so positioned within the adapter housing 16 and with respect to the optical axis 32 of the lensing system of the attached video camera 18 that the image received through the window 22 upon the mirror 31 will vary from that transmitted to the left shutter by a predetermined angle to provide a “right eye perspective” that differs from a “left eye perspective” in a way that mimics human vision. It has been found that a 1.5 degree angle of parallax is appropriate to obtain convergence between the right and left eye perspectives at a distance of about three meters, the distance at which the primary subject is commonly located within a camera's field-of-view. To obtain such a setting the mirror 31 is oriented so that the angle .theta. of FIG. 2 is 46.5 degrees (45 degrees plus 1.5 degrees). The angle theta. is controllable by rotating the mirror 31 about a central post or rod 33 rotatably mounted within the adapter housing 16. A conventional mirror drive 34 such as a hand crank or a motor may be engaged to the central post or rod 33 to actuate rotation thereof. In this way, the angle .theta. of the mirror 31 may be adjusted, even during taping (or filming), to provide subtle three-dimensional effects and to “correct” the system for any variation in the distance between the cameraman and the primary visual subject.

The electronics of the adapter 10 serves to regulate the passage of a visual stream through the adapter 10 and to the camera 12. Such electronics is arranged upon a circuit board 35 that is fixed to a side panel of the adapter housing 16. A battery 36 stored within a battery compartment 37 of the housing 16 energizes the circuitry mounted upon the circuit board 35 to control the operation of the light shutter 28 as described below.

The circuitry of the adapter 10 comprises, in part, a standard video stripper circuit for extracting the SYNC pulses from a video-format signal. The adapter 10 receives such video signal by tapping the “VIDEO OUT” terminal 38 of the camera 12 through a plug connector 40.

FIG. 3 is a detailed optical schematic view of elements of the adapter 10 for illustrating the operation thereof. Referring first to the switchable polarization rotator 28, this device includes a layer 42 of liquid crystal material that is sandwiched between opposed glass plates 44 and 46. The layer 42 preferably comprises nematic liquid crystal material with the inner surfaces of the glass plates 44 and 46 appropriately treated so that the liquid crystal material is maintained in the twisted nematic mode. As such, the polarization of light passing through the layer 42, when quiescent (i.e. no excitation signal applied), is rotated by ninety degrees. When activated by an electrical signal (generally a.c.) applied between a counterelectrode 48 and an active electrode 50 fixed to the inner surfaces of the plates 44 and 46 respectively, light passes through the layer 42 without its polarization affected. A quarter wave plate 56 for adjusting image chromaticity and a polarization filter 54 that acts as an analyzer complete the optical structure of the portion of the adapter 10 for processing images received from the cube 24.

In operation, a ray “L” represents the path of a ray of the “left eye image” received by the adapter 10 while “R” represents a ray of light of the “right eye image” received. As mentioned above, the specific right eye perspective (with respect to the left eye perspective) or parallax desired is determined by the angle .theta. of the surface of the mirror 31 with respect to the face plate 22.

The light rays L and R are unpolarized upon passing through the glass face plate 22. Thereafter the L image passes through the first polarizer, attaining a first linear polarization prior to entering the cube 24. (The direction of polarization of light passing along a ray or path is indicated in FIG. 3 by either a small transverse arrow or a circle. The two symbols refer to orthogonal directions of polarization.) Conversely, R image light, upon passage through the face plate 24, is reflected from the surface of the mirror 30 toward the cube 24 and beamsplitter 26. Prior to entering the glass cube 24, the R image light passes through the second polarizer 30. After passage through such polarizer 30, the R image light is linearly polarized with polarization orthogonal to the L image light.

Although shown with separation distances therebetween in FIG. 3, the existence of intimate contact between the optical elements traversed by the L image effectively transfers the L image as incident upon the face plate 22 to the lens of the camera 12. Additionally, the intimate contact between the switchable polarization rotator 28 and the glass cube 24 assures that the R image is also essentially input to the lensing system of the camera 12 as received through the face plate 22. The essentially “solid” optical system within the adapter 10 minimizes the degree of convergence of the rays defining the L and R images within the adapter due to the refractive index of the glass. This permits essentially the entire field of view received at the adapter 10 to be transferred to the lensing system of the camera 12.

Returning to the processing of the R and L images within the optical system of the adapter 10, the internal beamsplitter coating 26 of the glass cube 24 acts to pass the L image through while reflecting the R image. Hence, after passage through the glass cube 24, L and R images of orthogonal polarizations are received at the front window 46 of the switchable polarization rotator 28.

It is a property of the layer of twisted nematic mode liquid crystal material 42 that, when quiescent, the polarization of light passing therethrough is rotated by ninety degrees while, when activated (generally, by the imposition of an a.c. signal), no change in polarization occurs. The polarization filter 54 passes light of preselected polarization. Either of the two orthogonal polarization modes of the L and R images is suitable. Accordingly, the image having a polarization, upon exiting the glass cube 24, that is the same as the polarization selectivity of the filter 54 will pass through the liquid crystal polarization rotator 28 when the layer 42 of liquid crystal material is actuated by the imposition of an a.c. electrical signal. Conversely, when no signal is applied and, thus, the polarization of that particular image is rotated by ninety degrees upon passage through the quiescent layer 42, the filter 54 will block the transmission of that image to the camera lensing system. The orthogonally-polarized image (containing the other perspective view) can only pass through the filter 54 after a rotation in polarization of ninety degrees. Therefore, that image is blocked by the filter 54 when an a.c. signal is applied across the electrodes 48 and 50 and it will pass through the filter 54 only after its polarization is rotated (i.e. no signal applied). Thus, it can be seen that the arrangement of the adapter 10 requires only a single liquid crystal polarization rotator to generate a sequence of images that alternates between right and left eye perspective views.

FIG. 4 is a circuit schematic diagram of the electronic shuttering system of an adapter suitable for use with a video camera. As mentioned earlier, the electronic system is, in part, mounted upon a circuit board 35 within the adapter housing 16. While the system illustrated in FIG. 4 is designed for use with a video camera and is based upon the optical system of FIG. 2, it will become apparent from the discussion that substantially the same system and operational principles, with minor modifications, are suitable for an adapter for a film camera.

Referring back to FIG. 4, the video output of the camera 12 (VIDEO OUT signal), tapped at 38 by means of the plug connector 40, is first applied to a conventional video stripper circuit 58. The stripper circuit 58 is a standard modular accessory that derives a series of SYNC pulses, each indicating the beginning of a new field of information within the video signal. In a standard video format such as NTFC, the video signal that is input to the gun of a cathode ray tube (CRT) is formatted to contain video information consistent with the scanning of the video display raster in two interlaced “fields” that, in combination, define a video “frame”. This is in contrast to a frame of film which is not scanned and thus the concept of interlaced fields has no application in film. Each video field is typically scanned in 1/60 second with, for example, the field of odd-numbered raster lines scanned during the first 1/60 second and the interfaced field of even-numbered raster lines scanned during the second 1/60 second. Thus a full frame of video is displayed in 1/30 second.

In contrast, in a film camera, a shutter pulse stream permits one to “slave” together various optical effect generators. Such a pulse stream is typically of 24 Hz frequency corresponding to the standard film format of 24 frames per second.

Returning to FIG. 4, the output of the stripper circuit 58 is applied to exclusive-OR gate 60. An oscillator 62 provides the other input to the gate 60. In addition to providing an input to the gate 60, the output of the oscillator 62 is conductively-coupled to the counter-electrode 48 of the liquid crystal polarization rotator 28.

The active electrode 50 receives the output of the exclusive-OR gate 60. FIGS. 5(a) through 5(e) comprise a set of timing diagrams for illustrating the operation of the above-described electronic shuttering system for a video camera adapter. Referring first to FIG. 5(a), a square wave of period 1/30 second is output from the video stripper circuit 58. As mentioned earlier, the circuit 58 extracts a square wave, comprising a train of SYNC pulses, from a standard video output. The duration of each pulse, as well as the duration of time between pulses is, of course, 1/60 second. This corresponds to the time required to record (and display) a field of a video frame. FIG. 5(b) illustrates the output of the oscillator 62. As mentioned earlier, the oscillator 62 generates a high-frequency square wave (e.g. 10 kHZ). It will be seen that the high frequency of the oscillator pulses, greatly exceeding that of the stream of SYNC pulses from the video stripper circuit 58, results in the application of an a.c. voltage across the layer of liquid crystal material 42, activating it to clarity.

FIG. 5(c) is a waveform of the output of the exclusive-OR gate 60. The time scale of the waveform of FIG. 5(c) is greatly expanded from that of the preceding diagram, with the diagram illustrating the output of the exclusive-OR gate over only a single period of the SYNC signal received from the video stripper circuit 58. As indicated, each period of a SYNC signal comprises one video frame that encodes two interlaced video fields (indicated as “Field 1” and “Field 2”).

As can be seen, during the first 1/60 second (Field 1) the output from the video stripper circuit 58 is high. Adopting, as a convention, that an exclusive-OR gate outputs a high output only when its inputs differ, then, for the duration of a pulse from the stripper circuit 58, pulses are output from the gate 60 in a stream of the same frequency, but out-of-phase with, the high frequency pulse stream from the oscillator 62.

The active electrode 50 receives the output of the exclusive-OR gate 60 at the same time that the counterelectrode 48 receives the output of the oscillator 62. As a result of the out-of-phase relationship between the signals applied to the opposed electrodes of the rotator 28, an a.c. voltage V.sub.28 (illustrated in FIG. 5(d)), whose peak-to-peak amplitude is double that of the pulses from the oscillator 62, appears across the layer of liquid crystal material 42 for the ( 1/60 second) duration of Field 1. As indicated in FIG. 5(e), such a.c. voltage disorients the alignment of the molecules of the layer 42 whereby polarized light passes therethrough without any change in polarization during video Field 1. Assuming that the polarization filter 54 is preselected to pass p-polarized light, the L image light emergent from the glass cube 24 is s-polarized and the R image light is p-polarized, then the p-polarized R image will pass through the filter 54 to the camera lens system while the s-polarized L image light is blocked during Frame 1.

The above-described process is reversed during the second 1/60 second period (Field 2) when the output from the video stripper circuit 58 goes low. The high frequency stream of pulses from the oscillator 62 produces an output of frequency and phase unchanged from the output of the oscillator 62. The pulses of the voltage waveforms applied to the active electrode 50 and to the counterelectrode 48 accordingly arrive in-phase during Field 2. Thus, no voltage difference is applied across the layer of liquid crystal material 42. During Field 2 the molecules of the layer of liquid crystal material 42 remain quiescent and aligned. Thus, the polarization of light is twisted by ninety degrees upon passage therethrough. Again, assuming inputs of s-polarized L light and p-polarized R light and a p-oriented polarization filter 54, the L light image (rotated to p-polarization) now passes through the adapter 10 and to the lens system of the camera 12 while the R image light, rotated to s-polarization, is blocked by the filter 54.

The above-described sequence is repeated over every 1/30 second video frame. Referring to the previous figures, it is thus seen that right and left eye perspective views are accordingly transmitted to the image pickup within the video camera every 1/60 second in accordance with standard video protocols. Thus, without modification, the internal image sensor of the camera (e.g. a charge-coupled-device (CCD)), sequentially receives right and left eye perspectives of the field-of-view. Without modification to the readout and detection mechanisms of a standard camera, the images picked up by that camera will then provide a video signal which, when applied to a display (perhaps after recordation onto videotape) produces interlaced left eye perspective and right eye perspective fields suitable for viewing by a commercially-available viewing system such as a pair of shuttered eyeglasses or a three-dimensional headset to produce the desired three-dimensional viewing sensation. (to here U.S. Pat 715)

FIG. 5d′ is a schematic drawing of another electro-optical system and related components and systems associated with the camcorder system shown in FIG. 5a′ that incorporates plural image sensors to achieve. (starting here Pat. '994)

As a basic method for picking up an object image in three dimensional, it has been known to shoot an object using two television cameras each disposed at a given angle to the object, the output signals from these two television cameras being alternately selected for every field. FIG. 5 illustrates diagrammatically the configuration of such a three-dimensional image pickup apparatus. In FIG. 5, shown on side A of the dashed line is a three-dimensional image pickup apparatus, while a three-dimensional display apparatus is shown on a side B. In this figure, the numeral 1 indicates an object, the numeral 2 a television camera A, and the numeral 3 a television camera B, each of the television cameras A and B having a lens disposed forwardly of an imaging screen provided therein. These are combined with a synchronizing signal generator 4, a switch 5, and an adder 6 to compose the three-dimensional image pickup apparatus. The three-dimensional display apparatus comprises a sync separator 7, a monitor television 8, and a pair of glasses 9.

Since the three-dimensional image pickup apparatus and three-dimensional display apparatus having the above configuration are well known in the art, only a brief description is given herein, and the three-dimensional image pickup apparatus will be described. The television cameras 2 and 3 are disposed forming a given angle theta. between them with respect to the object 1. The scanning timings of the television cameras 2 and 3 are in synchronizing relationship with each other. For this purpose, the synchronizing signal generator 4 supplies pulse signals necessary for driving the television cameras, simultaneously to the television camera 2 and the television camera 3 (the television camera 2 corresponds to the human right eye, and the television camera 3 to the human left eye). The video signals from the television cameras 2 and 3 are respectively supplied to terminals a and b of the switch 5. The switch 5 is controlled by field pulses supplied from the synchronizing signal generator 4, alternately switching the output signals at the terminal c of switch 5 from field to field in such a way that the video signal fed from the television camera 1 is output in the first field and that the video signal fed from the television camera 2 is output in the second field. Both the video signal thus obtained by switching and the synchronizing signals supplied from the synchronizing signal generator 4 are supplied to the adder 6 which combines these signals to produce a three-dimensional image video signal. Needless to say, the television camera driving pulses, field pulses, and synchronizing signals supplied from the synchronizing signal generator 4 are all in synchronizing relationship with one another.

Next, the three-dimensional display apparatus will be described. The three-dimensional image video signal produced by the three-dimensional image pickup apparatus having the above-mentioned structure is transmitted via an appropriate means to the three-dimensional display apparatus. The transmitted three-dimensional image video signal is fed into the monitor television 8 for displaying the image. Since the three-dimensional image video signal is produced by alternately selecting the video signals from the television cameras 2 and 3, the image displayed on the monitor television 8 when directly viewed appears double and unnatural, and does not give a three-dimensional effect to the human eye.

In order to view the image displayed on the monitor television 8 in three dimensions, it is necessary for the observer to view the image shot by the television camera 2 only with his right eye, and the image shot by the television camera 3 only with his left eye. That is, the image displayed on the monitor television 8 must be selected so that the image pattern of the first field enters the right eye and the image pattern of the second field enters the left eye. To achieve this object, the light signals from the monitor television 8 are selected by means of the glasses 9 having optical shutters so that the image pattern of the first field is viewed with the right eye and the image pattern of the second field with the left eye. The sync separator 7 outputs field pules synchronous with the synchronizing signals. Here it is supposed that the field pulse signals output from the sync separator 7 are at a high level for the first field and at a low level for the second field. The field pulses are supplied to the glasses 9 to alternately operate the optical shutters provided therein, thus selecting the light signals from the monitor television 8 between the right and left eyes. To describe specifically, during the first field, the optical shutter for the right eye of the glasses 9 transmits the light while the optical shutter for the left eye blocks the light. Conversely, during the second field, the optical shutter for the left eye of the glasses 9 transmits the light while the optical shutter for the right eye blocks the light. The light signals from the monitor television 8 are thus selected, making it possible to view the image in three dimensions.

The outline of the optical shutters will be described. A mechanical shutter may be used as the optical shutter, but here we will describe an optical shutter using a liquid crystal. A liquid crystal shutter is capable of transmitting and blocking light by controlling the voltage applied to the liquid crystal, and has a sufficiently fast response to the field scanning frequency of the television camera. It also has other advantages of longer life, easier handling, etc., as compared with the mechanical shutter.

Referring to FIG. 6, the liquid crystal shutter will be briefly described. FIG. 6 is a schematic diagram of an object image. The numerals 10 and 11 indicate deflector plates, the numeral 12 a liquid crystal, the numerals 13 and 14 transparent electrodes, the numeral 15 is a rectangular wave generator, the numerals 16 and 17 are AND circuits, the numerals 20 and 21 capacitors, the numeral 18 an inverter, and the numeral 19 a field pulse input terminal. The optical shutter is basically constructed so that the liquid crystal (twisted nematic type) 12 is interposed between the two kinds of deflector plates 10 and 11, and that an electric field is applied to the liquid crystal which transmits or blocks light to serve as an optical shutter. Since the twisted nematic type liquid crystal is well known in the art, its description is omitted.

The deflector plates, the liquid crystal, and the transparent electrodes constitute the optical section of each of optical shutters 100 and 200. The deflector plate 10 transmits only the horizontal polarization wave of the light transmitted from the object, while the deflector plate 11 works to transmit only the vertical polarization wave. The transparent electrode 14 is grounded. The transparent electrode 13 is used to apply an electric field to the liquid crystal 12. In the above construction, when a voltage is not applied to the transparent electrode 13, the horizontal polarization wave transmitted through the deflector plate 10 is phase-shifted to a vertical polarization wave when it passes through the layer of the liquid crystal 12, and the vertical polarization wave passed through the layer of the liquid crystal 12 is transmitted through the deflector plate 11. This means that the liquid crystal shutter is in a permeable state, allowing the light from the monitor television to reach the human eye. On the other hand, when a voltage is applied to the transparent electrode 13, the horizontal polarization wave transmitted through the deflector plate 10 is not phase-shifted, but passes through the layer of the liquid crystal 12, retaining the state of the horizontal polarization. Therefore, the horizontal polarization wave passed through the layer of the liquid crystal 12 cannot permeate the deflector plate 11. This means that the liquid crystal shutter is in a non-permeable state, preventing the light from the monitor television from reaching the human eye. The transparent electrode 14 is grounded, as previously noted, and a driving signal is supplied to the transparent electrode 13 via the capacitors 20 and 21. The driving voltage applied to the transparent electrode 13 is approximately 10 V, and the driving frequency is approximately 200 Hz. The driving signal is produced using the rectangular wave generator 15, the AND circuits 16 and 17, the inverter 18, and the field pulse input terminal 19. To describe in detail, the rectangular wave generator 15 is caused to generate a rectangular wave of approximately 200 Hz, and the output signal from the rectangular wave generator 15 is supplied to the AND circuits 16 and 17 simultaneously. To the AND circuit 16, the field pulse which is at a high level for the first field and at a low level for the second field is supplied via the field pulse input terminal 19. Therefore, the driving signal for the liquid crystal layer is derived from the AND circuit 16 only when the first field is being reproduced. On the other hand, the field pulse supplied via the field pulse input terminal 19 is inverted by the inverter 18, and then supplied the AND circuit 17. Thus, the driving signal for the liquid crystal layer is derived from the AND circuit 17 only when the second field is being reproduced. The crystal shutter is constructed in this way. Namely, the light is allowed to pass through the right side shutter 100 of the glasses 9 shown in FIG. 6 during the reproduction of the first field, and through the left side shutter 200 of the glasses 9 during the reproduction of the second field.

However, the three-dimensional image pickup apparatus having the above-described structure requires two television cameras, thus making it expensive to construct the system. Also, since two television cameras are used to shoot the same object, preciseness is required in adjusting the shooting angles, the focusing, the angle between the two television cameras to the object, and other settings. Therefore, the above construction requires a lot of time for adjustment as compared with the time needed for shooting the object, and thus lacks mobility. (to here Pat '994)

FIG. 6 is a cutaway perspective of an alternative panoramic spherical FOV recording assembly that is retrofitted onto a two CCD or two film plane of a conventional stereoscopic camera. In FIG. 6 objective lenses and associated optical relay means S1 and S3 transmit respective subject images S1 and S3 in focus to a first optical recording surface of the adapted stereoscopic camera. And objective lenses and associated optical relay means S2 and S4 transmit respective subject images S2 and S4 in focus to a second optical recording surface of the adapted stereoscopic camera. The relay means is comprised of conventional lenses, mirrors, prisms, and/or fiber optic image conduits whose use and function is well known to those skilled in the art. The recording surface of the camera may comprise a CCD, CMOS, still or movie film. All components are held in place by the rigid opaque housing assembly which can be made of metal or plastic. A opaque baffle between image paths keeps stray light from going between image path S1 and S3, and image path S2 and S4. Objective lenses may have adjacent field of view coverage to facilitate monoscopic coverage of the surrounding scene, or alternatively may have overlapping field of view coverage to facilitate stereoscopic coverage of the surrounding scene. Microphones and associated audio recording means may be added to the housing as previously described in FIG. 2b or FIG. 3a. The housing assembly is constructed such that it may be mounted/adapted to the camera mount(s) of the adapted conventional stereoscopic camera. In the present example a conventional bayonet or screw mount is described.

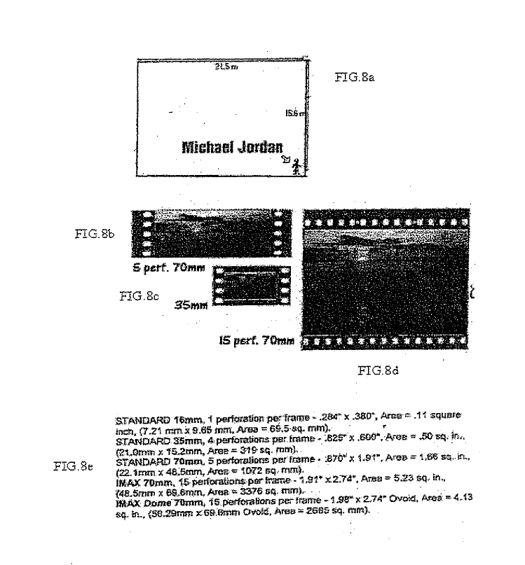

FIG. 7 is a diagram illustrating the process and functionality of applying target tracking/feature tracking software to the above panoramic spherical cameras disclosed in the present invention. While video camera recording of a complete surrounding scene is advantageous it also has limitations when played back. The limitation is that a viewer may only wish to select certain subjects within the scene for viewing, and he or she may not wish to view other large areas of the spherical panoramic scene for recording or playback. Instead of the viewer having to search for and track a certain subject within a scene it would be advantageous if target tracking or feature tracking software automatically captured video/image sequences of a defined field-of-view based on user preferences. It is therefore an object of the present invention to provide a user defined target/feature tracking means for use with panoramic camera systems generally like those described in the present invention.

The use of target/feature tracking software is well known. It's use was generally anticipated in image based virtually reality applications in U.S. Pat. '794 by the present inventor. Target tracking and feature tracking software has been commonly used in industrial inspection, the military, and security security since the 1970's. (i.e. Data Translation, Inc. has provided such software). Image editing software that incorporates feature tracking software that may be incorporated with the panoramic cameras described in this invention includes that in U.S. Pat. No. 6,289,165 B1 by Abecassis dated September 2001, and U.S. Pat. No. 5,469,536 by Blank dated November 1995. This software is applicable for use in the present invention. More specifically, and more recently target/feature tracking software has been used in tracking subjects in U.S. Pat. No. 5,850,352 granted 15 Dec. 1998 by Moezzi et al. Moezzi teaches that subject characteristics and post production criteria can be defined by the use of software when used with multiple video cameras placed in different locations. In this manner a user of the panoramic camcorder can during live recording or in post production define the scene he or she wishes to view. Moezzi teaches a conventional computer with “Viewer Selector” software is used to define a variety of criteria and metrics to determine a “best” view. (Ref. 3.3 Best View Selection, Pat. '352).

For example, in FIG. 7 a panoramic camcorder like the ones described in the present invention records panoramic imagery. A computer with target tracking/feature tracking software receives the panoramic imagery. The user of the computer operates the computer and software to designate his or her target and feature tracking preferences. In the present example the user has designated a standing peson, with a cap, who is audibly loud, and only their head as being preferred. Those imagery and audio signals are recorded in a feature preference database of the computer. The actual imagery and audio signals recorded by the panoramic camera are compared to the users preferences. The comparitor/correlation software algorithms that form a portion of the target tracking/feature tracking software identify the subject that has those features. Additionally, based on other user preferences, the target tracking/feature tracking software defines the field-of-view the user has previously defined. The target tracking/feature tracking software defines and tracks those features in the subsequent sequence of frames.

It is important to note that when a feature is found in separate image segments the computer is normally programmed to choose the best fit of signatures that the user preferences have designated. Additionally, software that anticipates movement to overcome latency problems of a tracked subject from frame to frame is available and may be incorporated into the target tracking/feature tracking software (i.e. U.S. Pat. Appl. 2002/0089587 A1).

Once the target tracking/feature tracking software defines the subject the scene is seamed together and distortion is removed by panoramic software. Software to accomplish this may be done in near real time so that it appears to the viewer to be accomplished live (i.e. 10-15 frames per second or faster), or may be done in post production. Software to seam image segments to form panoramic imagery and for viewing that panoramic imagery is available from many venders to include: Helmet Dersch entitled Panoramic Tools, from MindsEye Inc. entitled Pictosphere (Ref. U.S. Pats. 2004/0004621 A1, U.S. Pat. No. 6,271,853 B1, U.S. Pat. No. 6,252,603 B1, U.S. Pat. No. 6,243,099 B1, U.S. Pat. Nos. 6,157,385, 5,936,630, 5,903,782, and 5,684,937), from Internet Pictures Corporation (Ref. U.S. Pats. TBP), from iMove Incorporated (Ref. U.S. Pat. 2002/0089587 A1, U.S. Pat. No. 6,323,858, 2002/0196330, U.S. Pat. No. 6,337,683 B1, U.S. Pat. No. 6,654,019 B2) Microsoft (Ref. U.S. Pat. No. 6,018,349), and others referenced by the present inventor in his U.S. Pat. Nos. 5,130,794 and 5,495,576.

Conventional computer processing systems may be used to perform said processing, such that the target tracking/feature tracking software, camera control software, display control software, and panoramic image manipulation software may on incorporated on a personal computer or incorporated into a set-top box, digital video recorder, panoramic camera system, cellular phone, personal digital assistant, panoramic camcorder system or the remote control unit of a panoramic camcorder system. Specific applications for the target tracking/feature tracking embodiment of the present invention include video teleconferencing and surveillance. General applications include making home and commercial panoramic video clips for education and entertainment.

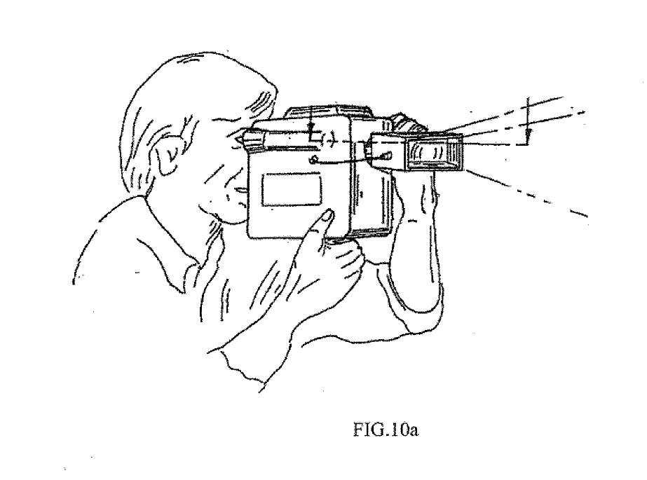

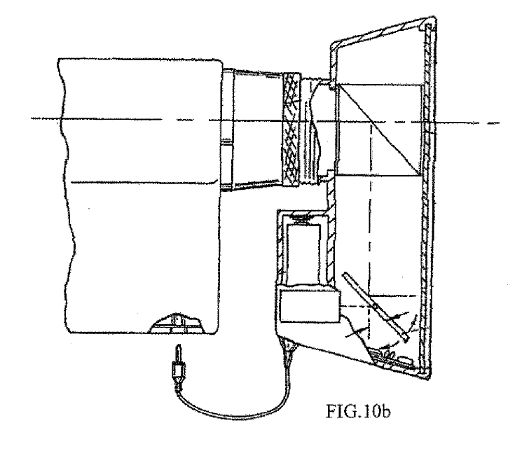

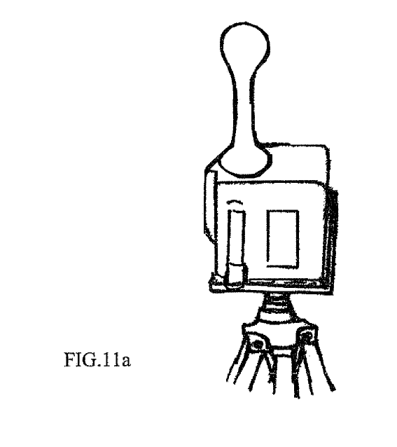

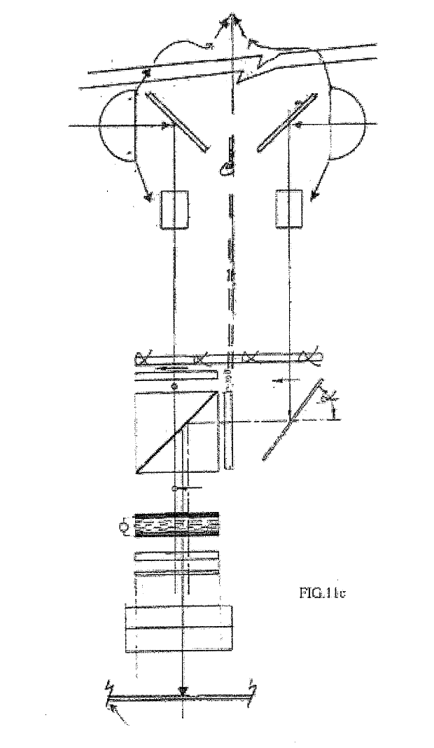

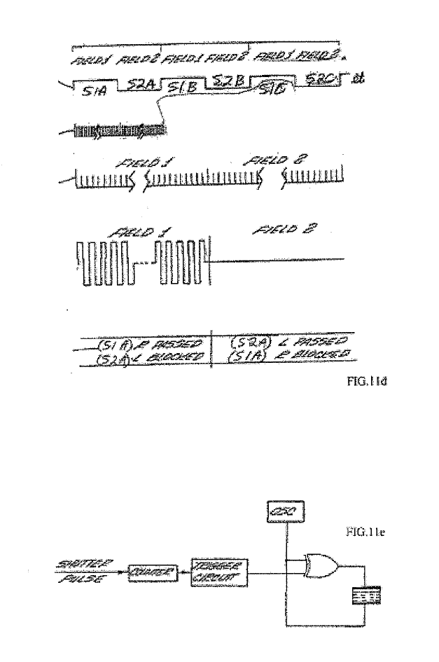

FIG. 10a is a perspective drawing of a cameraman operating a conventional portable filmstrip movie camera with an adapter for recording stereo coded images. The conventional stereoscopic camera has a limited field-of-view. For immersive applications it is advantageous to record a panoramic scene of substantially spherical FOV coverage. Such a camera is described in detail in U.S. Pat. No. 6,259,865, by Burke et al, dated 10 Jul. 2001, and sold under the name Nu-View Stereographic 3-D adapter for video and film cameras by 3-D Video, Inc.

FIG. 10b is a top sectional view of a stereographic adapter for a filmstrip movie camera for recording stereo coded images.

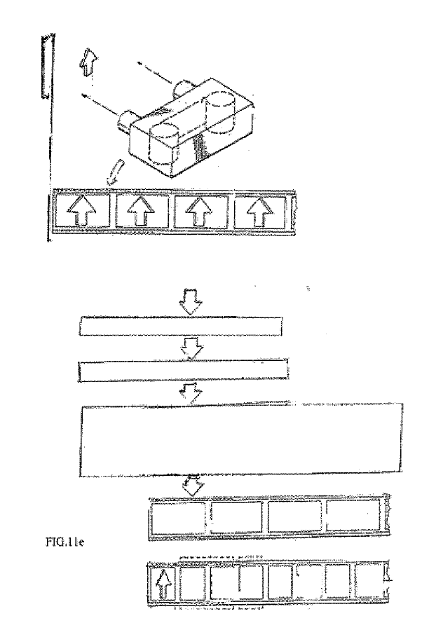

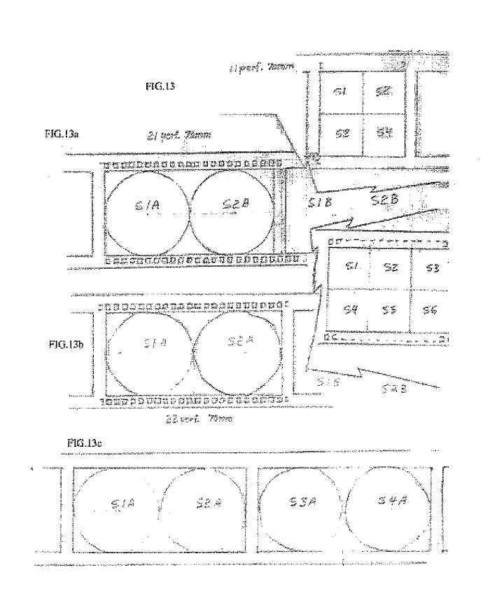

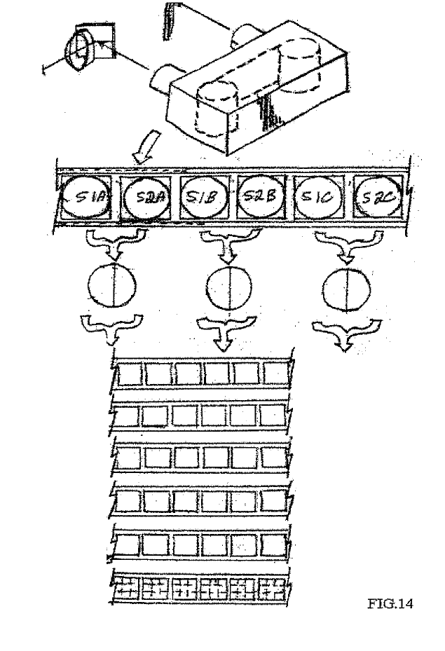

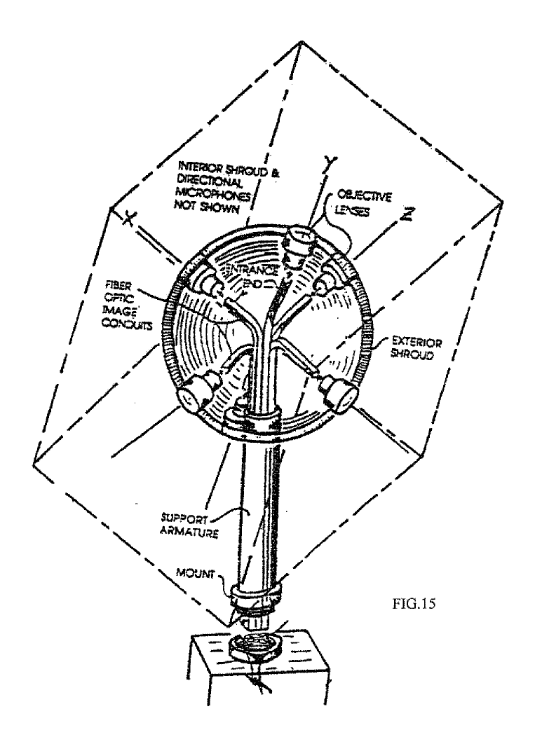

FIG. 11a is an exterior perspective view of a conventional portable filmstrip movie camera like that in FIG. 10a, wherein the movie camera and stereo adapter have been modified to receive and record panoramic spherical FOV images. FIG. 11a illustrates a panoramic adapter 10 in accordance with the invention as employed for recording a three-dimensional coded image by means of a conventional hand-held video camera 12. It should be pointed out that the adapter is employed to obtain panoramic photography by means of a film camera employing a single lensing system and image detector. However, like advantages may be obtained by the invention in the video medium as in film as demonstrated in the copending patent application referenced at the beginning of this disclosure.

As shown in FIG. 11a, a film camera is stopped and started by an operator (not shown) who has tripod mounted the single film camera 12 with the panoramic adapter 10 affixed to the lens assembly 18 of the film camera 12 in accordance with the invention. The adapter 10 enables a single operator 14 to record and store panoramic images suitable for creation of panoramic scenes within the recorded field-of-view when projected, displayed or otherwise played-back. The objective lenses S1 and S2 of the camera have overlapping adjacent coverage that facilitates spherical FOV coverage about the camera. In the present example two fisheye lens of greater that 180 degrees FOV are employed.

FIG. 11b is a plan view of a new 11 perforation, 70 mm filmstrip format for recording hemispherical and square images in a panoramic spherical FOV filmstrip movie camera.

FIG. 11c is a schematic drawing of the electro-optical system according to the conventional portable filmstrip movie camera like that in FIG. 10a, wherein the movie camera and stereo adapter have been modified to receive and record panoramic spherical FOV images. FIG. 11c is a cross-sectional view of the adapter 10 of FIG. 11a taken generally in the direction of line 2-2 of FIG. x. The adapter 10 is shown engaged to the representative film camera 12 with top portions of a housing 16 removed to facilitate comprehension. As can be seen, the adapter 10 is coupled to the front of the lens assembly 18 of the film camera 12 by means of a threaded coupling 20. A glass window 22 is provided at the front of the adapter 10. The interior of the adapter housing 16 accommodates both an optical system and associated electronics. A glass cube 24 houses a beamsplitter layer 26. The cube 24 is positioned so that the layer 26 intercepts both the S1 objective lens and S2 objective lens views generated by the adapter 10. The cube 24 lies between a polarizer 29 that may comprise a polarizing film fixed to the front vertical surface of the cube 24 and a switchable polarization rotator 28 that contacts the rear surface of the cube 24. A second polarizer 30 (shown in FIG. 3) is parallel to, and may comprise a polarizing film fixed to the bottom surface of the cube 24. It is an essential feature of the present invention that the first polarizer 29 and the second polarizer 30 are arranged so that light, upon passage through the first polarizer 29, assumes a first linear polarization while, after passage through the second polarizer 30, it assumes a second, orthogonal linear polarization.

A mirror 31 completes the gross optical system of the adapter 10. The mirror 31 is so positioned within the adapter housing 16 and with respect to the optical axis 32 of the lensing system of the attached film camera 18 that the image received through the window 22 upon the mirror 31 will vary from that transmitted to the left shutter by a predetermined angle to provide a “S1 perspective” that differs from a “S2 perspective”.

The electronics of the adapter 10 serves to regulate the passage of a visual stream through the adapter 10 and to the camera 12. Such electronics is arranged upon a circuit board 35 that is fixed to a side panel of the adapter housing 16. A battery 36 stored within a battery compartment 37 of the housing 16 energizes the circuitry mounted upon the circuit board 35 to control the operation of the light shutter 28 as described below.

FIG. 11e is a circuit schematic diagram of an electronic shuttering system of the movie camera and stereo adapter that have been modified to receive and record panoramic spherical FOV images. FIG. 11e is a schematic diagram of the electronic shuttering system of an adapter suitable for use with film, as opposed to video, cameras. With certain minor exceptions, the electronic shuttering system that corresponds to that of a video camera adapter. For this reason, elements of the video camera adapter that could correspond to those of an adapter for a film camera are given the same numerals.

The primary distinction between the role of an adapter for use with a film, as opposed to a video, camera derives from the different processes employed in film and video photography. As discussed earlier, while a video camera is arranged to convert an input image into a video signal to then re-create the image on a raster through the scanning of interlaced 1/60 second video fields, a film camera captures a moving image by exposing a series of still images onto a strip of film. Conventionally, twenty-four (24) still images are photographed per second. This requires that the strip of unexposed film be advanced by means of a film transport mechanism, then held still and exposed by means of a shutter, the process recurring twenty-four times per second. Numerous operations, including the synchronization of picture with sound, require the use of a common signal, known as a “shutter pulse” for synchronization. The shutter pulse waveform comprises a series of pulses separated by 1/24 second that directs the film transport mechanism, in coordination with the shutter, to create a sequence of twenty-four still images per second.

Referring to the schematic diagram of FIG. 11e, a counter 64 receives the shutter pulse waveform from the film camera. A trigger circuit 66 receives the least significant bit of the counter 64. The trigger circuit 66 outputs a pulse of 1/24 second duration every time the least significant bit from the counter 64 is toggled from “0” to “1” (or vice versa). As can be seen, the remainder of the circuitry for controlling the shuttering of the optical system of an adapter for a film camera is identical to the corresponding structure of the video camera adapter as seen in U.S. Pat. No. 6,259,865, and FIG. 4 of that patent.

FIG. 11d(1) through 11d(5) comprise a set of timing diagrams that illustrate the operation of the electronic shuttering system of the movie camera and stereo adapter that have been modified to receive and record panoramic spherical FOV images. FIGS. 11d1 through 11d5 comprise a series of waveforms for illustrating the operation of the electronic shuttering system of 11e. As can be seen, FIG. 11d1 comprises a series of pulses spaced 1/24 second from one another. The time between two adjacent shutter pulses is employed by the camera to (1) advance the film, (2) open the shutter to expose the film and (3) close the shutter. Thereafter, this process is repeated upon the arrival of the next shutter pulse. Accordingly, the periods between pulses are marked “Frame 1”, “Frame 2”, etc. in FIG. 11e with each frame indicating the exposure of a distinct still image of the field-of-view.

FIG. 11d1 is a diagram of the output of the trigger circuit 66. As mentioned earlier, the trigger circuit 66 is tied to the stage of the least significant bit stored in the counter 64 and arranged to trigger a 1/24 second duration pulse upon detection of a predetermined transition in the state of that stage. For example, as shown in FIG. 11d1, a pulse is triggered at the beginning of each odd-numbered frame. That is, the trigger circuit 66 outputs a pulse whenever the least significant bit of the count goes from even to odd (0 to 1). For purposes of the invention, the opposite transition could be employed as well.

FIGS. 11d2 and 11d3 correspond exactly to FIGS. 5(b) and 5(c) is grouped into two film frames corresponding to the exposure of adjacent images onto an advancing strip of film. Assuming that the output of the oscillator 60 is a 10 kHz pulse stream, then each 1/24 second film frame spans 416.67 oscillator pulses.

As in the case of the adapter for a video camera, the result of the application of pulses to the liquid crystal polarization rotator 28 is the production of waveform V.sub.28 as shown in FIG. 11d4 that includes periodic segments of alternating current. As shown in FIG. 11d5, the staggered application of a.c. signals to the liquid crystal layer 42 results in alternating 1/24 second periods of quiescence and activation of the liquid crystal material. As before, this corresponds to alternating periods during which the light passing therethrough is rotated by ninety degrees in polarization and periods in which it passes through without rotation. Adopting the same conventions and assumptions with regard to the S1 and S2 images and the filter 54 as were employed with respect to the video camera example, the adapter 10 will pass alternating S1 and S2 images to the lens systems of a film camera. As the polarization filter 54 is assumed to pass only p-polarized light, the frames recorded by the film camera are all of the same polarization.

FIG. 12 is a schematic diagram illustrating an alternative arrangement in which the process of converting an IMAX movie camera into a panoramic spherical FOV monoscopic or stereoscopic filmstrip movie camera, production, scanning/digitizing, post production, and presentation steps according to the present invention.

FIG. 13a through 13e are plan views of a set of new film formats for recording hemispherical and square images in a panoramic spherical FOV filmstrip movie camera.

FIG. 14 is a schematic diagram illustrating the process of converting an IMAX movie camera into a panoramic spherical FOV monoscopic or stereoscopic filmstrip movie camera and the associated production, post production, and distribution required

FIG. 15 is a cutaway perspective drawing illustrating the incorporation of relay means such as fiber optic image conduits, mirrors, or prisms to relay images representing a composite panoramic spherical FOV coverage to a film plane of a filmstrip movie camera.

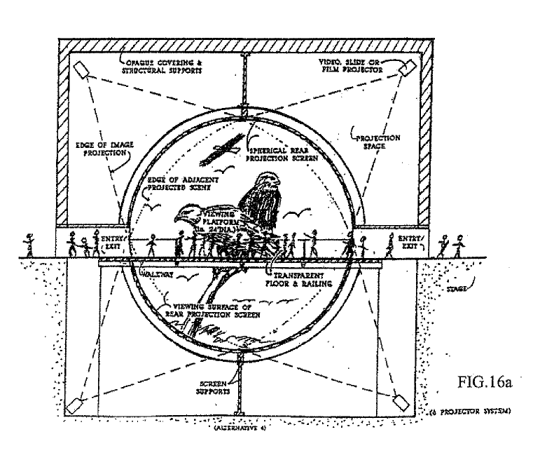

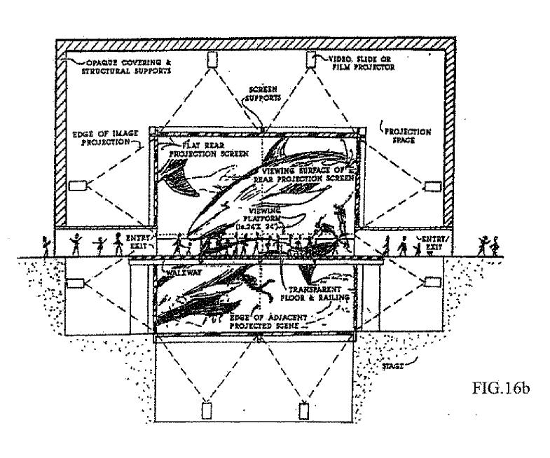

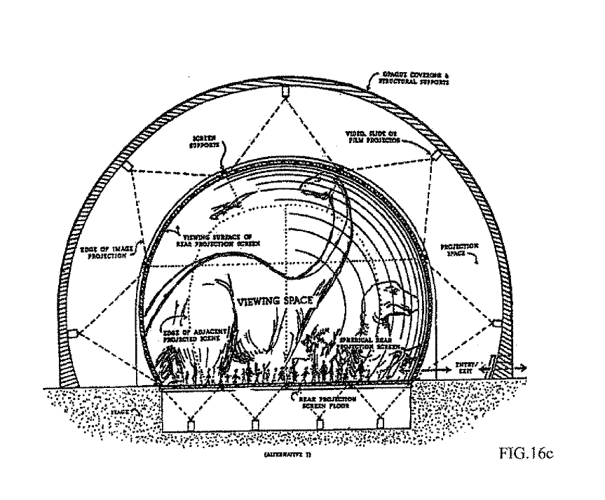

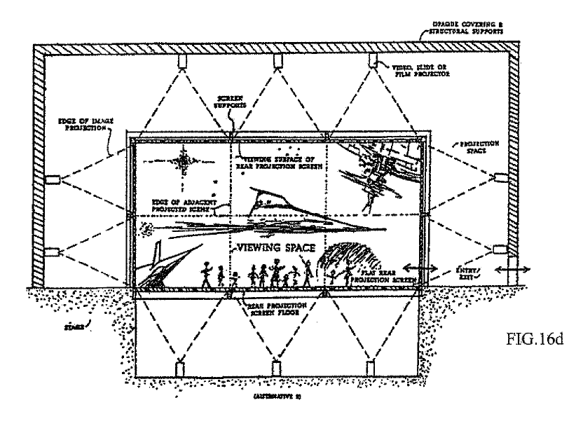

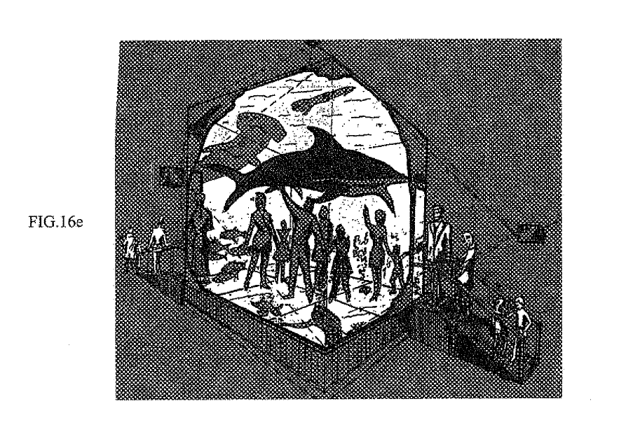

FIG. 16a through 16e illustrate large venue format panoramic film or video projection theaters designed to distribute, project, and display imagery recorded by the panoramic spherical FOV monoscopic and stereoscopic filmstrip movie cameras disclosed in the present invention.

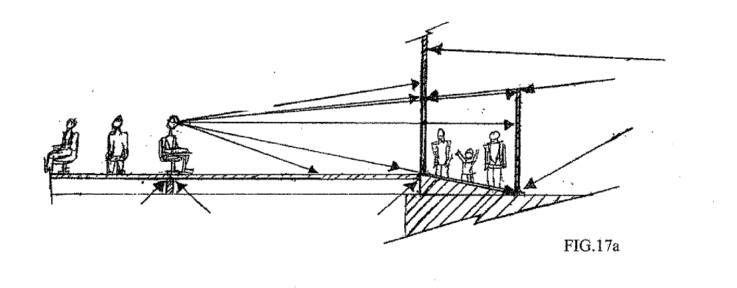

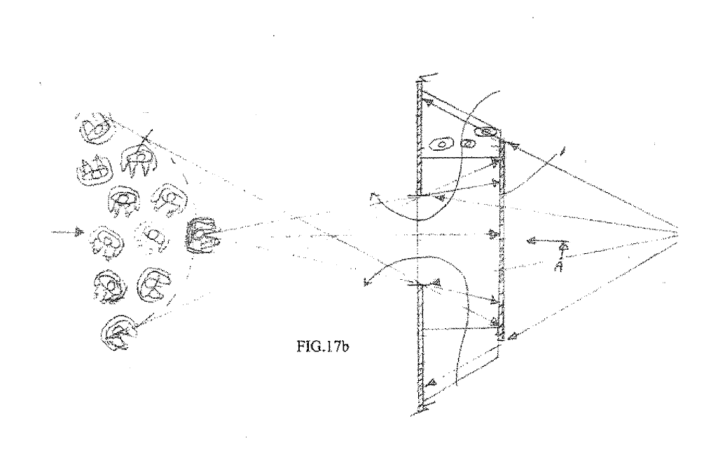

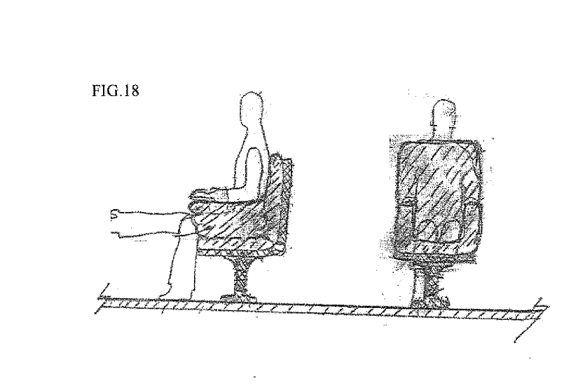

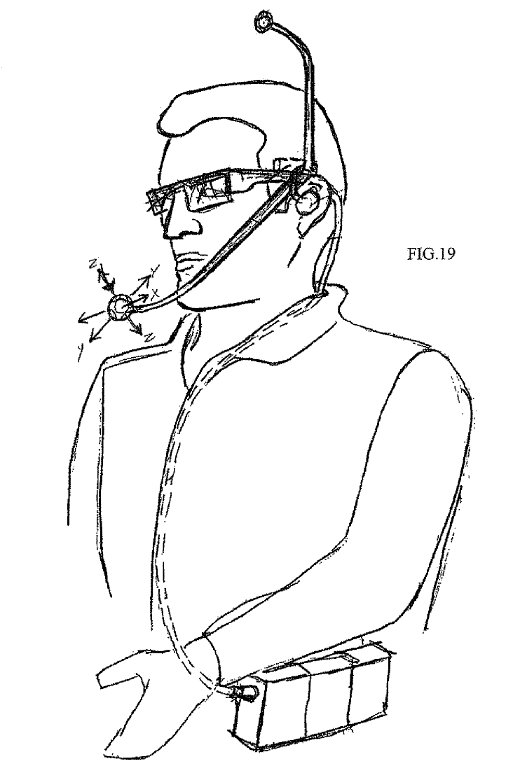

FIG. 17a is a side sectional drawing of a panoramic theater like those shown in FIGS. 16a through 16e depicting the projection, viewing, and architecture that are integrated in such a manner as to provide an unobstructed entry and exit for the audience while minimizing the interruption on continuous projection of the scene surrounding the viewer.

FIG. 17b is a top view drawing of a panoramic theater like those shown in FIGS. 16a through 16e depicting the projection, viewing, and architecture that are integrated in such a manner as to provide an unobstructed entry and exit for the audience while minimizing the interruption on continuous projection of the scene surrounding the viewer.

FIG. 18 is a side sectional drawing of a transparent seating arrangement for a panoramic theater like those shown in FIGS. 16a through 16e depicting the benefit of using such seating to minimize the disruption of view for the audience to all projection surfaces and also provide comfort and safety for the audience.

The term “System” generally refers to the hardware and software that comprises the Panoramic Image Based Virtual Reality/Telepresence Personal Communication System.

Additionally, “system” may refer to the specific computer system or device referenced in the specific discussion as the System is made up of many sub-systems and devices.

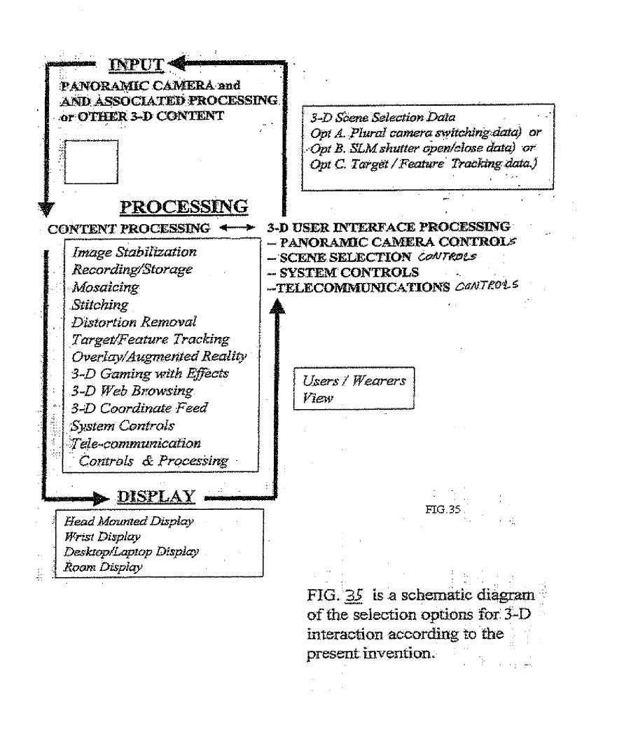

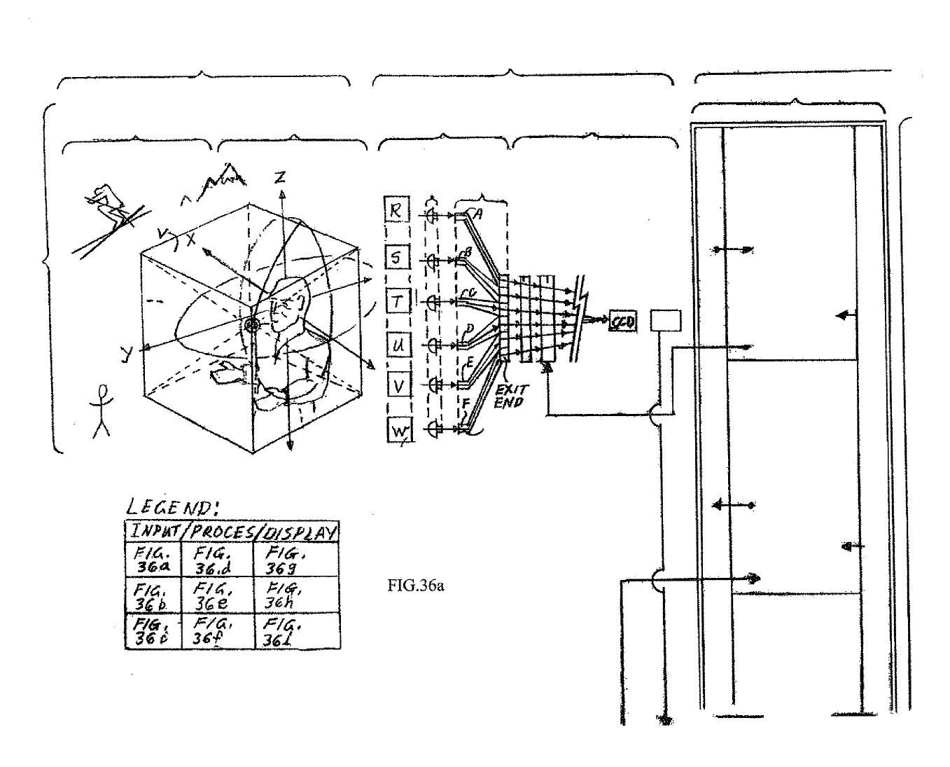

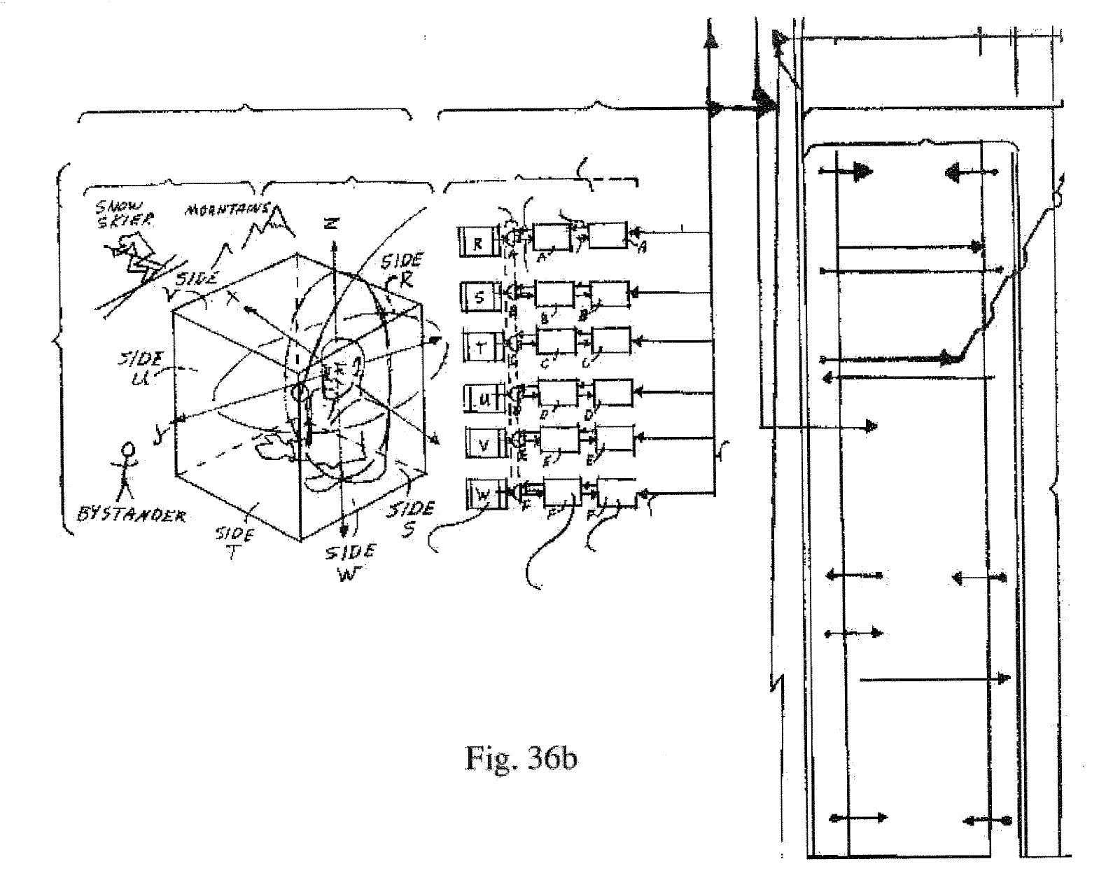

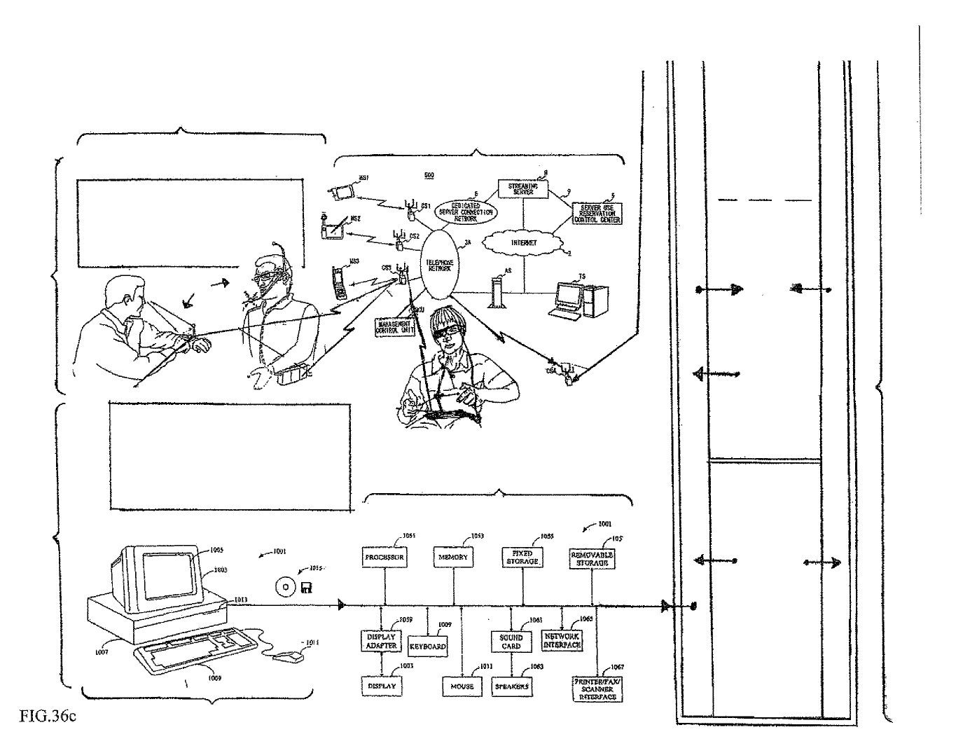

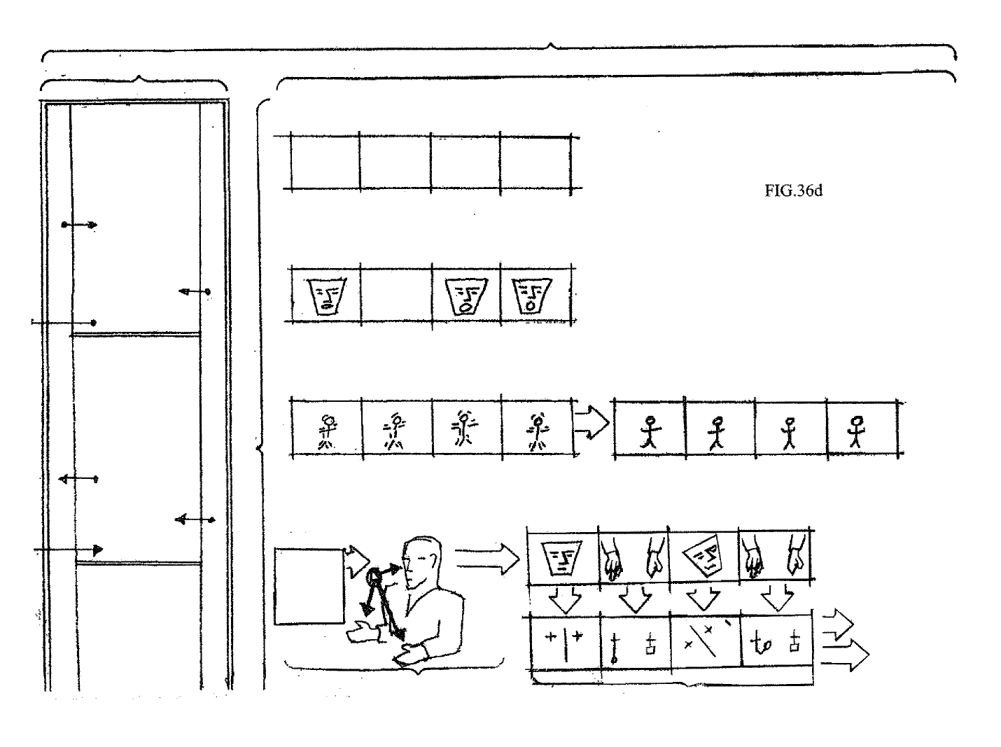

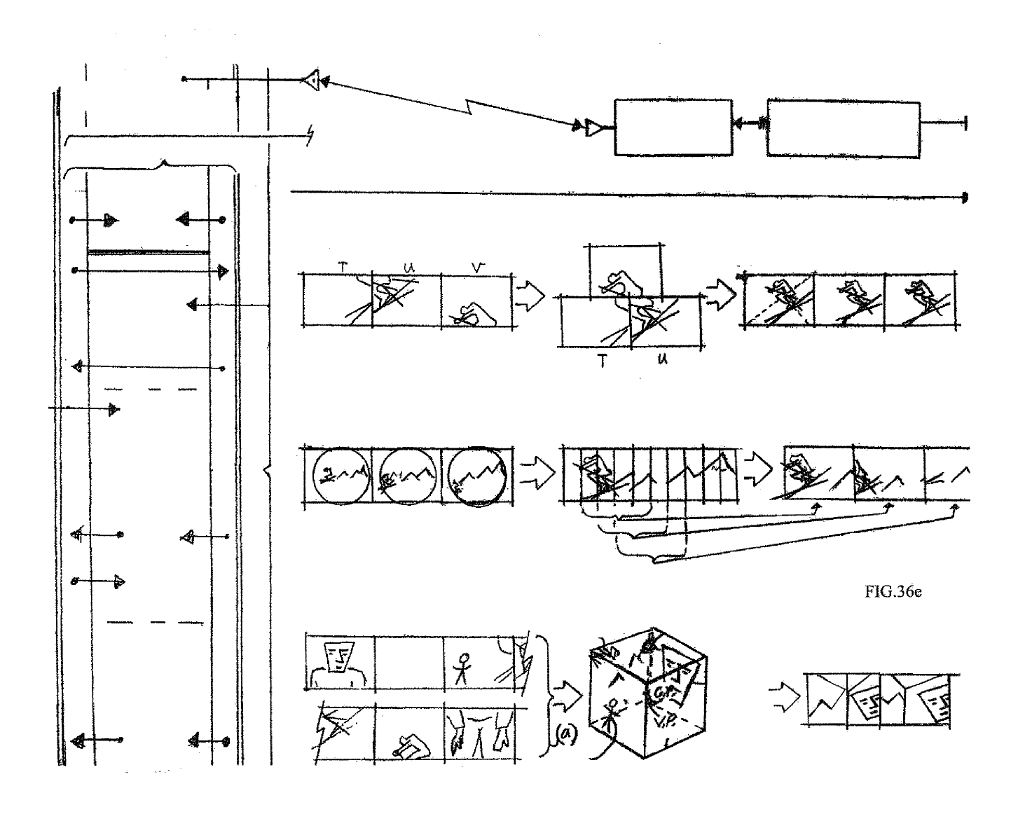

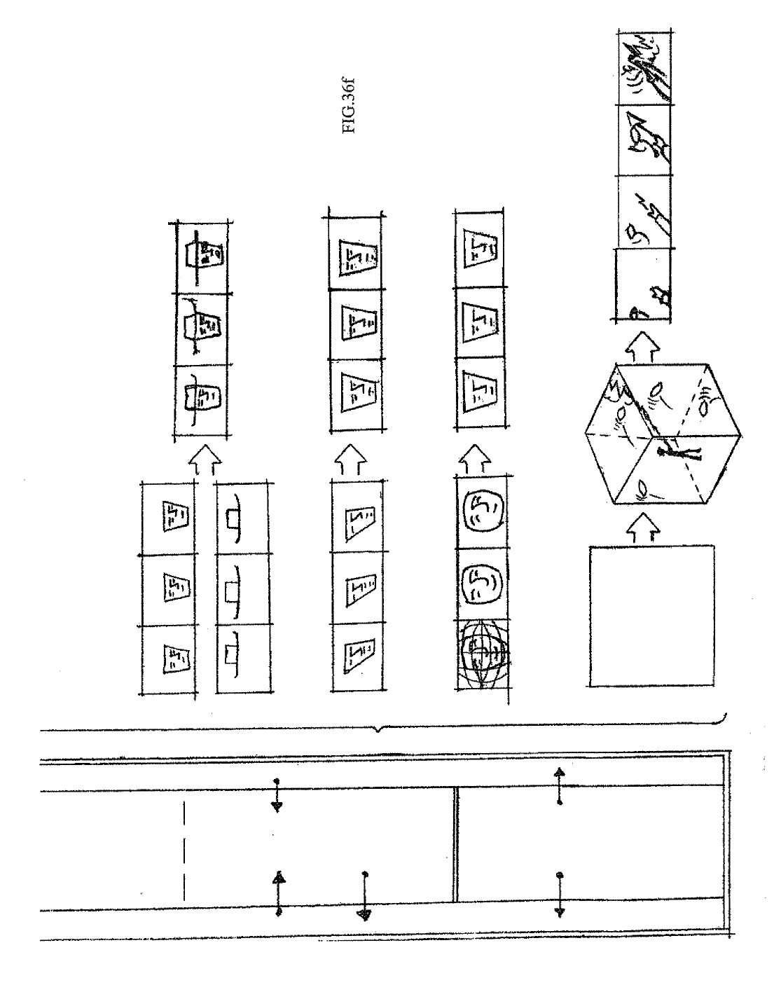

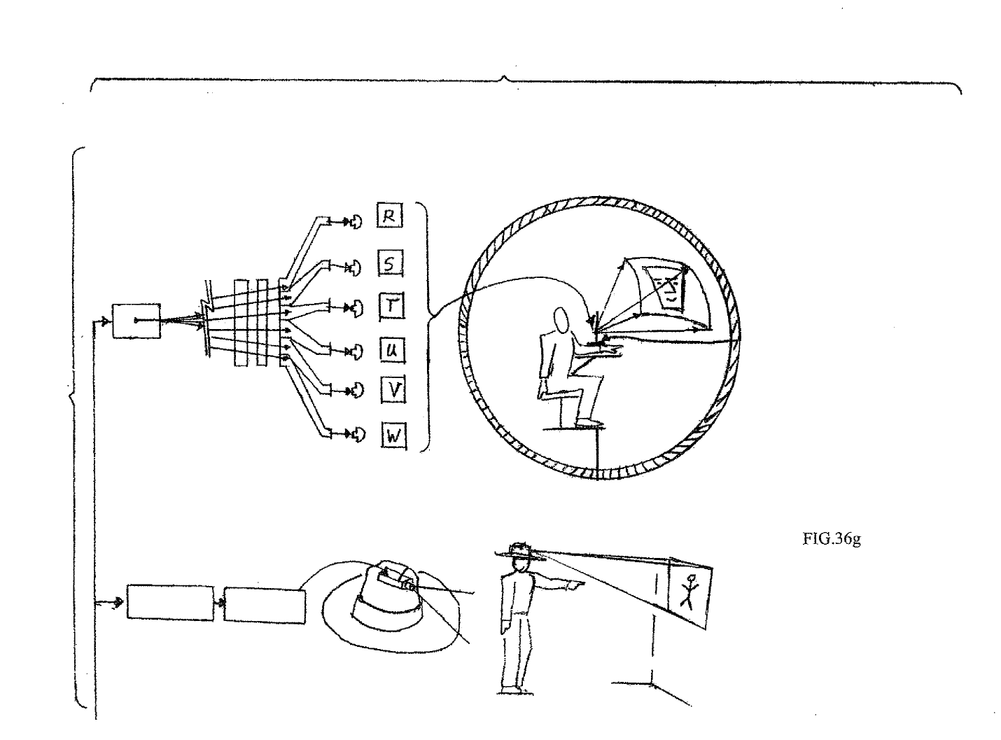

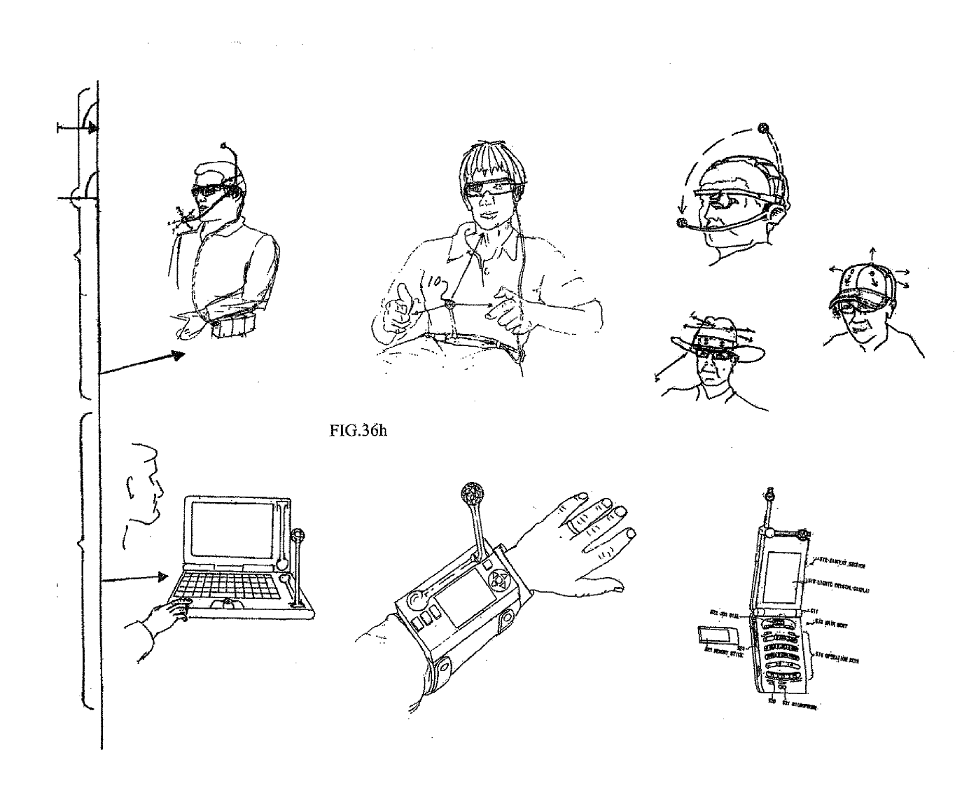

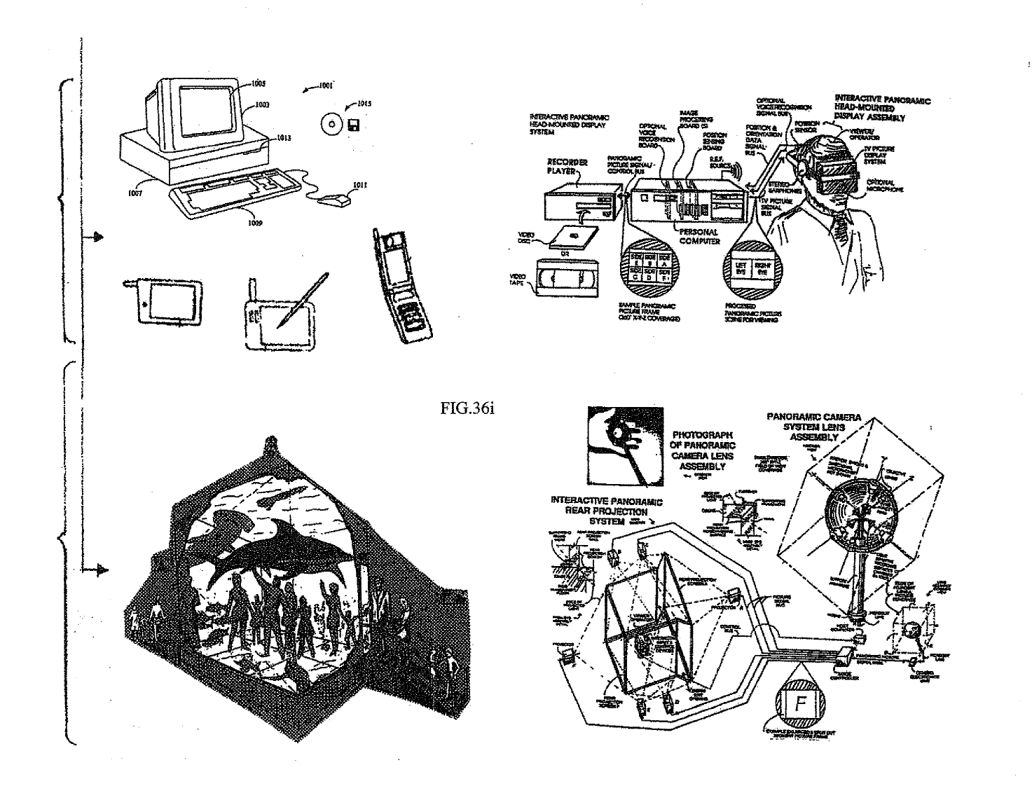

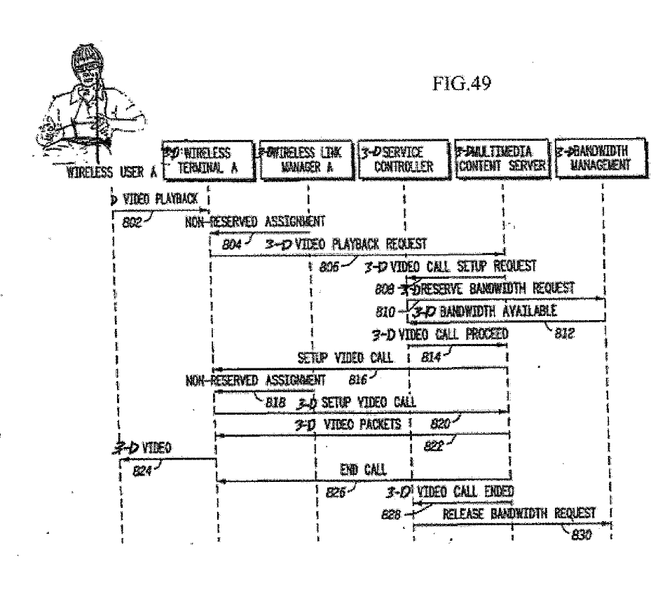

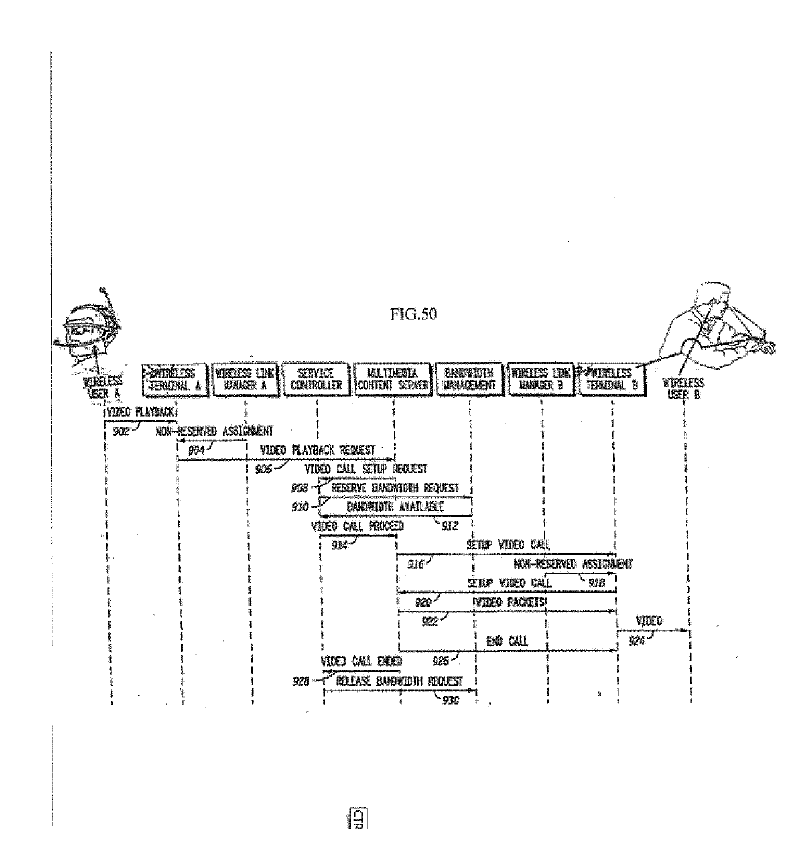

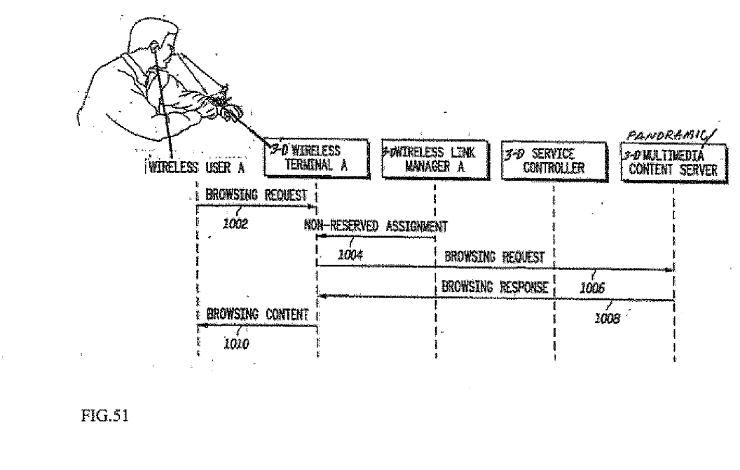

System Overview: As illustrated in FIG. 35 and FIG. 36a-i, FIG. 47, FIG. 48, FIG. 49, FIG. 50 and FIG. 51 the Panoramic Image Based Virtual Reality/Telepresence Personal Communication System and Method are comprised of a personal panoramic communication system 120 or 122 and a telecommunications system 100. The personal communication system includes a panoramic camera system, a processing system, and a display system. Several embodiments of the personal communication device are presented which offer varying levels of immersion. The personal communication system 120 or 122 may be manifested in a head or helmet mounted device, body worn device, cell phone, personal digital assistant, wrist worn device, laptop computer, or desktop computer, or set-top device embodiment. The processing system of the personal communication system 120 or 122 preferably includes means for communicating over a wireless telecommunications network 100. Although a LAN or CAN is also possible. Operation of the personal communication network/system 100 offers the user the ability to conduct one-way panoramic video teleconferencing, two-way panoramic video teleconferencing, immersive video gaming, immersive web based video and graphics browsing, along with non-immersive content services offered today by internet and cellular telephone providers of user A, and of user A and B of the panoramic terminal units 120 or 122.

Wireless Panoramic/3-D Multimedia Input Means Overview: Still referring to FIG. 35 and FIG. 36, the Panoramic Image Based Virtual Reality/Telepresence Personal Communication System and Method that is the present invention offers improved three-dimensional input capabilities over previous systems. Specifically, the present invention has the capability to provide raw or original content consisting of either panoramic video and/or three-dimensional (3-D) data coordinates. Conventional two-dimensional and 3-D input devices, processors, display devices, formats, operating systems, and standards typically associated with the internet, local-are-networks, campus-area-networks, wide-area-networks, and telephony are compatible with the present invention. For example, conventional input devices such as single camera video, still cameras, video servers, video cell phones, 2-D and 3-D games, graphic systems, and associated and so on and so forth may provide content compatible with the present invention. Signals from input means are transmitted to computer processing means.

Wireless Panoramic/3-D Multimedia Processing Means Overview: The processing means consists of computers, networks, and associated software and firmware that operates on the signals from the input means. The processing means is typically part of unit 120 or 122, and part of system 100. The distribution of processing on unit 120 or 122 and 100 can vary. In the preferred embodiment the input means consists of a panoramic camera system which provides panoramic imagery.

Preferrably, the raw image content received from the panoramic camera system is processed for viewing. Image processing software or firmware that is applied to the images are selected by the user using graphic user interfaces common to computer systems and unique to the present invention. Applications that may be selected include but are not limited to image selection, image stabilization, recording and storage, image segment mosaicing, image segment stitching, image distortion reduction or removal, target/feature tracking, overlay/augmented reality operations, 3-D gaming, 3-D browsing, 3-D video-teleconferencing, 3-D video playback, system controls, graphic user interface controls, and interactive 3-D input controls.

Besides processing means to operate on incoming raw content or prerecorded content, the processing means of the present invention also includes 3-D user interface processing means. Interface processing means includes both hardware and software or firmware that facilitates the user interacting with a panoramic camera system, 3-D game, or other 3-D content.

Wireless Panoramic/3-D Multimedia Display Means Overview:

The display means receives imagery for display from the processing means. The display means may comprise but is not limited to any multi-media device associated with head or helmet mounted, body worn device, desktop, laptop, set-top, television, handheld, room-like, or any other suitable immersive or non-immersive systems that are typically used to display imagery and present audio information to a viewer.

Wireless Panoramic/3-D Multimedia Communication Means Overview:

In the preferred embodiment, a packet-based, multimedia telecommunication system 100 is disclosed that extends IP host functionality to panoramic wireless terminals 120 or 122, also referred to as communications unit 120 or 122 serviced by wireless links. The wireless communication units may provide or receive wireless communication resources in the form of panoramic or three-dimensional content. Typical panoramic and three dimensional content will included imagery stitched together to form panoramic prerecorded movies or a live feed which the user/wearer can pan and zoom in on, or three-dimensional video games which the user can interact with. Multimedia content is preferably sensed as panoramic video by the panoramic sensor assembly of the present invention. The content is translated into packet-based information for wireless transmission to another wireless terminal 122. A service controller of the communication system manages communications services such as voice calls, video calls, web browsing, video-conferencing and/or internet communications over a wireless packet network between source and destination host devices. The ability to manipulate panoramic video is currently well known in the computer and communications industry (i.e. IPIX movies). And the ability to manipulate and interact with three-dimensional games and imagery is also well known in the computer and communications industry (i.e. Quicktime VR). Similar storage and transfer of panoramic content generated by the present panoramic sensor assembly 10 may be transmitted from the novel wireless panoramic personal communications terminals 120 or 122 that comprise the present invention. Correspondingly, three-dimensional input can also be transmitted to and from the terminals just as is done in manipulating IPIX movies and Quicktime VR.

Terminals 120 and 122 may interact with one another over the internet or with servers on the internet in order to share and manipulate panoramic video and interact with three-dimensional content according to the System disclosed in the present invention. A multimedia content server of the communication system provides access to one or more requested panoramic multimedia communication services. A bandwidth manager of the communication system determines an availability of bandwidth for the service requests and, if bandwidth is available, reserves bandwidth sufficient to support the service requests. Wireless link manager(s) of the communication system manage wireless panoramic communication resources required to support the service requests. Methods are disclosed herein including the service controller managing a call request for a panoramic video/audio call; the panoramic multimedia content server accommodating a request for panoramic multimedia information (e.g., web browsing or video playback request); the bandwidth manager accommodating a request for a reservation of bandwidth to support a panoramic video/audio call; execution of a panoramic two-way video calls, panoramic video playback calls, and panoramic web browsing requests.

The present invention extends communication system that extends the usefulness of packet transport service over both wireline and wireless link(s). Adapting existing and new communication systems to handle panoramic and three-dimensional content according to the present invention supports high-speed throughput of packet data, including but not limited to streaming voice and video between IP host devices including but not limited to wireless communication units. In this manner the wireless panoramic personal communications systems/terminals described in the present invention may be integrated into/overlaid onto any conventional video capable telecommunications system.

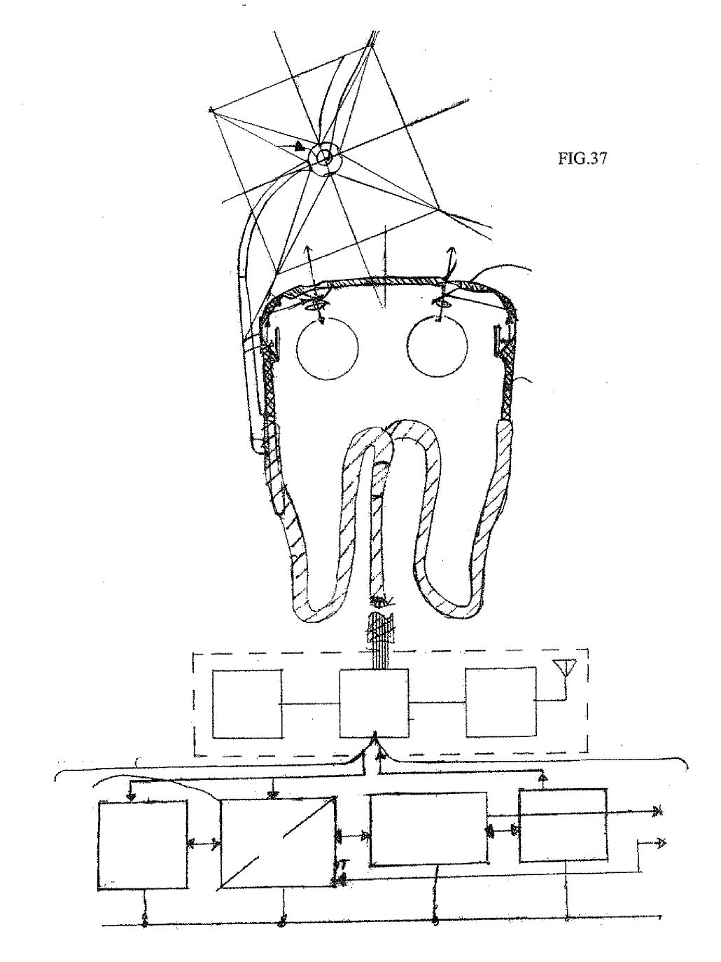

For example, and now referring to the drawings in more detail, FIG. 19 and FIG. 37 is a perspective drawing of a personal communication system 120 or 122 comprising a head-mounted wireless panoramic communication system according to the present invention. This first embodiment of the personal communication system includes a camera system comprising objective lenses, relay optics, focusing lenses, shutters, and imaging sensor means. FIG. 36a through FIG. 36i is a schematic diagram comprising nine drawings that can be placed next to one another to describe all major embodiments of the present invention and will be referenced throughout the detailed description. A legend of how the images fit together can be found on the bottom left corner of FIG. 36a.

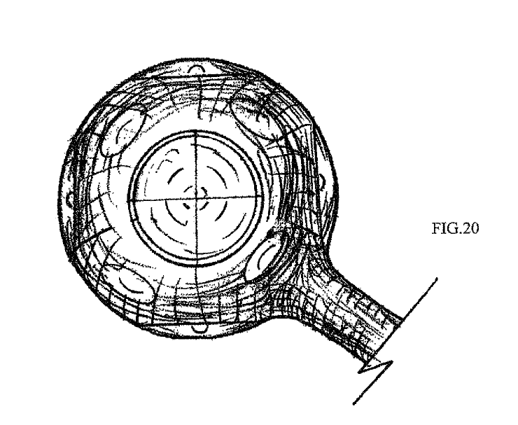

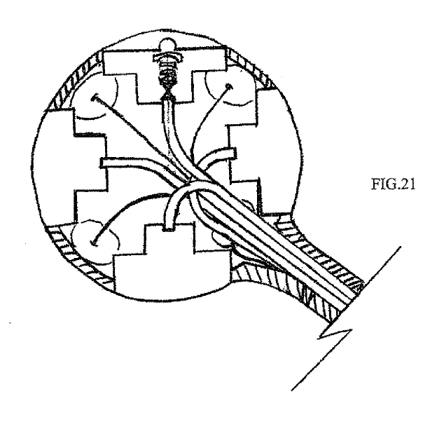

Referring to embodiment A of FIG. 19 and FIG. 37, shown in FIG. 20, FIG. 21, FIG. 27, and FIG. 36a, the objective lenses and associated objective relay or focusing lenses transmit images representing the environment surrounding the panoramic sensor assembly 10 to the entrance end of fiber optic image conduits. The objective lenses and associated relay lens of each objective lens focuses it's respective image on the entrance end of a respective fiber optic image conduit. The fiber optic image conduits transmit the image to the exit end of the fiber optic image conduit in focus.

FIG. 20 is a greatly enlarged exterior perspective drawing of the panoramic sensor assembly 10 according to the present invention that is a component of the head-mounted wireless panoramic communication device 120 or 122 shown in FIG. 19. Preferrably the sensor assembly is not more than a couple of centimeters in diameter. Objective lenses face outward about a center point to record a wide field of view image. Objective lenses may be arranged to achieve less than a spherical image. However, preferably objective lenses are arranged adjacent to one another in order to facilitate recording a continuous panoramic portion or all of a spherical field of view image. A larger optical assembly was first disclosed by the present inventor in 1986 and subsequently patented in 1992 in U.S. Patent 794 and may be applied to the present invention. Manufacturers of micro lenses of a type that may be used in the present invention as objective lenses are AEI North America, of Skaneateles, N.Y., that provide alternative visual inspection systems. AEI sales micro-lenses for use in borescopes, fiberscopes, and endoscopes. They manufacture objective lens systems (including the objective lens and relay lens group) from 4-14 millimeters in diameter, and 4-14 millimeters in length, with circular FOV coverage from 20 approximately 180 degrees. Of specific note is that AEI can provide an objective lens with 180 degree or slightly larger FOV coverage required for some embodiments of the panoramic sensor assembly. Lenses well known in the endoscope and borescope industry may be incorporated to construct the objective and relay optics of the panoramic sensor assembly in the present invention. The panoramic sensor assembly is designed to be small and light weight so it can be situated on the mast in as unobtrusive manner to the user as possible. In the present example, the objective lenses many have greater than a 90 degree field of view to achieve adjacent lens field of view spherical coverage to facilitate monoscopic viewing of a spherical image. Or alternatively, the objective lenses in this arrangement could have greater than 180 degree field of view coverage to achieve overlapping adjacent FOV coverage and facilitate stereoscopic viewing. Objective lenses are designed to include focusing or relay lenses at their exit ends to focus the objective subject image onto a given surface at a given size.

FIG. 21 is a greatly enlarged interior perspective view of the sensor assembly 10 shown in FIG. 19 and FIG. 20 of relay optics (i.e. fiber optic image conduits, mirrors, or prisms) being used to relay off axis images from the objective lenses to one or more of the light sensitive recording surfaces (i.e. preferably a charge couple device(s) or CMOS device(s)) of the panoramic communication system 100. Each objective lens transmits its subject image in focus to the entrance end of a fiber optic image conduit. The fiber optic image conduit reflects the image through the fiber optic image conduits in focus to the exit end of the fiber optic image conduit. While fiber optic image conduits are used in the present example, it is known to those skilled in the art that mirrors, prisms, and consecutive optical elements may be used to transmit an image over a distance in focus from location to another, and that the image may be transmitted off axis by arranging these optics in various manners. Manufacturers of fiber optic image conduits of a type that may be incorporated into the present invention are Edmunds Scientific, Inc.: Barrington, N.J.; Schott Fiber Optics Inc., Southbridge, Mass.: and Galileo Electro-Optics Corp., Sturbridge, Mass. A manufacturer of relay lenses, mirrors, prisms, and optical relay lens pipes (like used in borescopes) of a type that may be used in the present invention is Edmunds Scientific, Inc., Barrington, N.J. A prototype using a small fiber optic image conduit 2 mm diameter, 150 mm long from shot optics and a micro-lens with screw clamp and about 7 mm length and 4 mm diameter from a manufacturer of micro-optics was constructed to demonstrate the feasibility of using fiber optics for the optics for a panoramic sensor assembly in 1994.

FIG. 27 is a schematic diagram disclosing a system 120 or 122 and method for dynamic selective image capture in a three-dimensional environment incorporating a panoramic sensor assembly 10 with a panoramic objective micro-lens array, fiber-optic image conduits, focusing lens array, addressable pixilated spatial light modulator, a CCD or CMOS device, and associated image, position sensing, SLM control processing, transceiver, telecommunication system, and users. The relay optics, such as fiber optic image conduits shown in FIGS. 21 and 27 transmit images from the objective lens group to the entrance end of the fiber optic image conduits. The image focused on the exit end of the fiber optic image conduit is focused by a respective associated focusing lens onto the light sensitive imaging device surface. The focusing lens may be part of a lens array. Between the exit ends of the fiber optic image conduits and the imaging device surface is a addressable liquid crystal display (LCD) shutter. The LCD shutter is comprised of pixels that are addressable by a control unit controlled by signals transmitted over a control bus or cable that provides linkage to the computer. In the present invention the control unit comprises a printed circuit board that is integrated with the computer and form a portion of the processing unit shown in FIG. 27. The exit ends of the fiber optic image conduit, focusing lenses, and shutters are aligned so that images are transmitted to the imaging device surface in focus when the shutter system is open. When the shutter is closed the images are blocked from reaching the imaging device surface. While a single shutter is used in the present invention it is known to those in the art that a plural number of LCD or mechanical shutters may be incorporated to provide image shuttering. Manufacturers of LCD shutters of a type that have been specifically incorporated into the present invention is the Hex 63 or Hex 127 Liquid Crystal Cell Spatial Light Modulator (SLM) from Meadowlark Optics Inc., Bolder, Colo. Meadowlark also sales a Spatial Light Modulator Controller in board and unit configurations. The units can handle multiple SLM, facilitate selectively and dynamically addressing up to 256 pixels, and for personal computer architecture control. Other manufacturers of SLM's that can be incorporated to build input means, embodiment A, include Collimated Holes Inc., Boulder, Colo. SLM products; the Integrated Circuit Spatial Light Modulators-FLC, with a 256×256 pixel shutter with personal computer controller manufactured by Displaytech, Boulder, Colo.; a 512×512 multi-level/Analog Liquid Crystal SLM manufactured by Boulder Nonlinear Systems; and the LCS2-G liquid crystal shutter manufactured by CRL OPTO, GB.

Manufacturers of mechanical shutters of a type that may be incorporated into the present invention are known by those skilled in the art, and so are not referenced in detail in this specification.

Fiber optic image conduits of a type suitable for incorporation into the present invention are manufactured by Schott Fiber Optics Inc., Southbridge, Mass. The exit ends of the fiber optic image conduits are situated so that the image focused on the exit ends of the fiber optic image conduits are optically transmitted through corresponding respective micro-lenses. The micro-lenses are preferably part of a micro-lens array. The exit ends of the fiber optic image conduits may be dispersed and held in place by a housing such that each fibers associated respective image is directed through a corresponding micro-lens, through the spatial light modulator liquid crystal display shutter, and focused on the imaging surface.

Manufacturers of micro-lens arrays suitable for inclusion in the present invention are made by MEM Optical, Huntsville, Ala. MEM's manufactures spherical, aspherical, positive (convex), and negative (concave) micro-lens arrays. Images transmitted through the micro-lens array are transmitted through the spatial light modulator liquid shutter to an imaging surface. Alternatively, the micro-lens array may be put on the other side of the spatial light modulator shutter. The imaging surface may be film, a charge coupled display device, CMOS, or other type of light sensitive surface. The image sensor can be comprised of a single or plural number of image sensors.

The optical system may be arranged such that all images, say R, S, T, U, V, and W from an objective lens may be transmitted through corresponding fiber optic image conduits to fill up the image sensor frame simultaneously. However, preferably, the optical system is arranged such that each image, say R, S, T, U, V, or W from an objective lens is transmitted through corresponding fiber optic image conduits to fill up the image sensor frame. However, alternatively, the system may also be arranged such that a subset of any image, R, S, T, U, V, or W is transmitted from an objective lens through corresponding fiber optic image conduits to fill up the image sensor frame. The later is especially advantageous when using two fisheye lenses and the user only wants the system to capture a small portion of the field-of-view imaged by fish-eye lens.

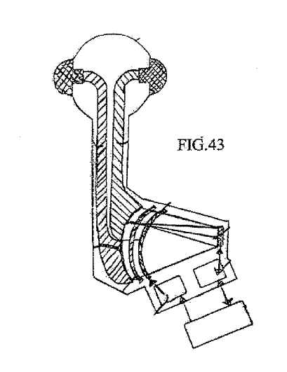

For instance, FIG. 43 is a side sectional diagram illustrating an embodiment of the present invention comprising a spatial light modulator liquid crystal display (SLM LCD) shutter for dynamic selective transmission of image segments imaged by two fisheyes lens and relayed by fiber optic image conduits and focused on an image sensor. In this arrangement the SLM LCD shutter is curved to facilitate projection onto the CCD. The fiber optic image conduits are distributed and held in place such that image sub-segments of the fisheye images may be dynamically selected by opening and closing the pixels of the SLM LCD.

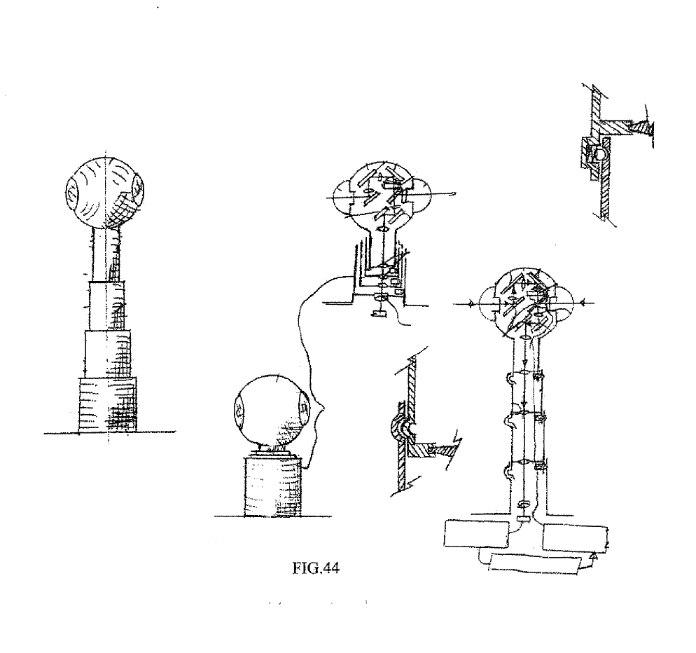

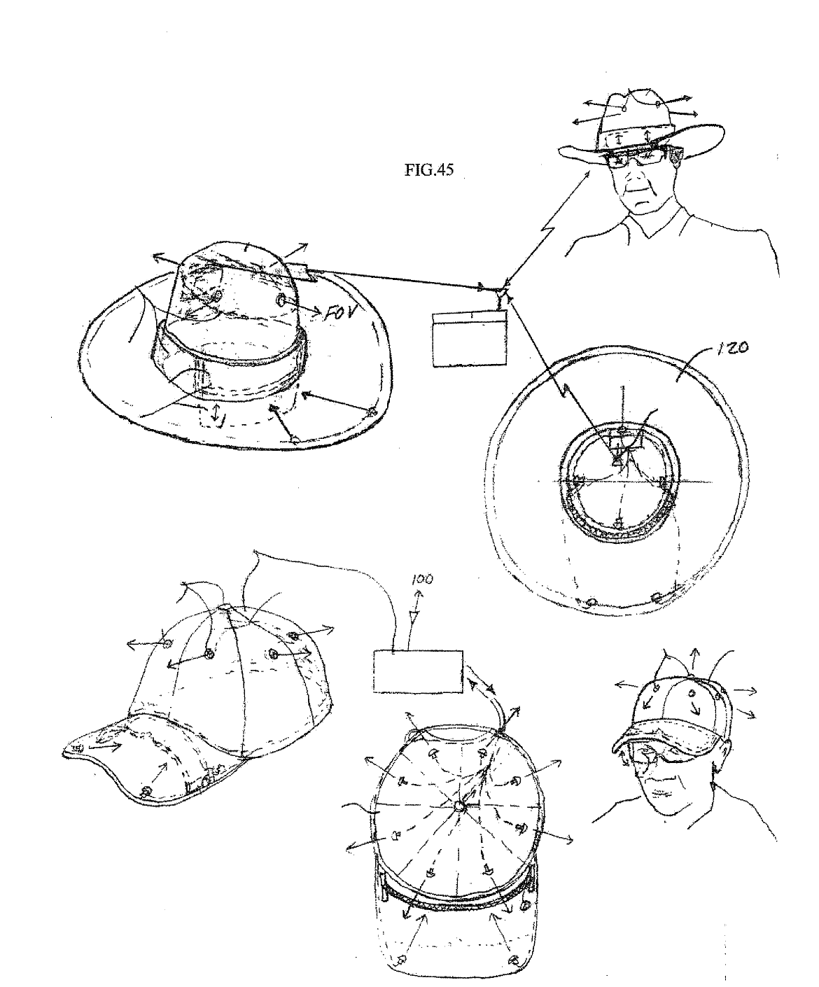

Images focused onto the image sensor may be slightly off axis. But the images will still be in a focal distance imaged such that the image is high enough quality for the purpose of accomplishing the objectives of the present invention. Alternatively, to improve the image quality by achieving perpendicular focus of the of the image across the optical path to the image sensor plane a beam splitter arrangement may be used to transmit the image to the image sensor similar to the arrangement taught by FIG. 44C. Still alternatively, diachroic prisms similar to that used in the Canon XL-1 video camera may be incorporated to bend the image to the image surface and compensate for the slight off axis projection of the image from the fiber optic image conduits to the surface of the image sensor.

The spatial light modulator liquid crystal display shutter contains pixels that are addressable. The pixels may be addressed by a computer controlled control unit such that they block the transmitted image or let the image go through. A manufacturer and type of liquid crystal display shutter suitable for use in the present invention is the Meadowlark Optics Corporation, Boulder, Colo. Operation of the spatial light modulator liquid crystal display system will be described in additional detail below in the processing section of this disclosure.

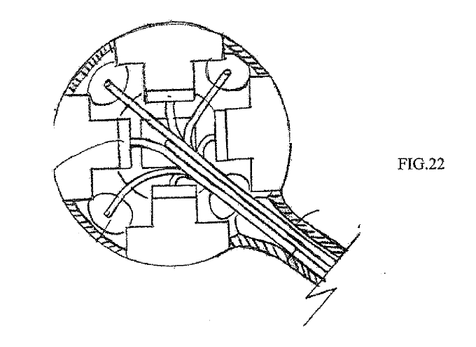

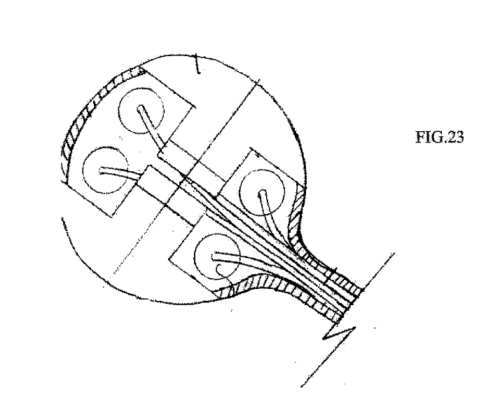

The housing for holding the components that comprise the assemblies in FIGS. 19-23 are of an opaque rigid material such as plastic or metal. Material is placed between optical paths in appropriate manner to keep stray light from other light paths from interfering with images from adjacent light paths. And material is preferably finished in a flat black surface to negate reflection and glare interfering with the desired transmission of light through the assembly. In FIGS. 22-23, wires powering the CCD's and transmitting image readout signals of the CCD's are run from the head of the sensor assembly 10 through the mast to associated electronics. In FIGS. 20-21, fiber optic image conduits are run from the sensor assembly 10 through the mast to associated optics and electro-optics. Likewise, microphone wires powering and reading out audio signals run from the head of the sensor assembly through the mast to associated electronics. Preferably, the sensor head and mast/armature are positionable. This is accomplished an adjustable swivel mechanism that is typical in audio headsets with positionable microphones. Manufacturers of headsets with adjustable armature mechanisms that may be incorporated into the present invention include the Motorola Audio Headset used by professional football team coaches to communicate from the sidelines; or those like the Plantronics, Inc., Santa Cruz, Calif., Circumaural Ruggedized Headset with adjustable boom microphone, model SHR 2083-01. The wires or fiber optic image conduits associated with the mast may be brought around swivel mechanism or brought through the center nut if it is of an open nature.

Alternatively, referring to embodiment B of FIG. 19, shown in FIG. 20, FIG. 22, FIG. 23, and FIG. 36b embodiment includes switching between plural cameras oriented in different directions to record portions of a surrounding panoramic scene. FIG. 22 is a greatly enlarged interior perspective view of the sensor assembly 10 shown in FIG. 19 and FIG. 20 comprising six light sensitive recording surfaces (i.e. charge couple devices or CMOS devices) positioned directly behind the objective lenses of the of the panoramic sensor assembly 10. FIG. 23 is an interior perspective view of the sensor assembly shown in FIG. 19 and FIG. 20 comprising two light sensitive recording surfaces (i.e. charge couple devices or CMOS devices) positioned directly behind the objective lenses of the panoramic sensor assembly. The camera and electronics unit may be placed either in the panoramic sensor assembly or may be separated. Still alternatively, relay optics such as fiber optic image conduits, prisms, mirrors and optical pipes like that described in U.S. Pat. '794 may be used to transmit to image sensor or sensors located on and worn by the viewer. A small camera, suitable for use in small-production runs of the invention is the Elmo QN42H camera, which has a long and very slender (7 mm diameter) construction. If input embodiment B is used a complete plural camera system providing NTSC video may be installed in the panoramic sensor assembly 10.

Other cameras suitable for use include those previously mentioned. It is known in the camera industry that camera processing operations may be placed directly onto or adjacent to the image sensing surface of the CCD or CMOS device. It is conceived by the present inventor that in some instances of the present invention that placing image processing operations such as compression functions and region of interest operation on the CCD or CMOS chip may be beneficial to save space and promote design efficiency. For instance, the Dalsa 2M30-SA, manufactured by Dalsa, Inc., Waterloo, Ontario, Canada, has a 2048×2048 pixel resolution and color capability incorporates Region Of Interest processing on the image sensing chip. In the present invention this allows users to read out the image area of interest the user is looking at instead of the entire 2K picture. In FIG. 23 this would mean that two 2K sensors put back to back and the region or regions of interest would be dynamically and selectively addressed depending on the view defined by the users interactive control device. The sensors would be addressable using software or firmware located on the computer processing portion of the system worn by the user. Alternatively, one 2K processor could be used and fiber optic image conduits could transmit the image from each objective lens, 1 to n, to the image sensor located in a housing remote located beyond the panoramic sensor assembly 10 and mast.

Audio system components and systems suitable for use in the present example are small compact systems typically used in conventional cellular phones that are referenced in this text elsewhere. Microphones are preferably incorporated into the panoramic sensor assembly 10 or at the into the HMD housing that becomes a expanded part of assembly 10 in FIG. 19. A modular panoramic microphone array that is of a type that may be incorporated into the present invention is described in U.S. Pat. App. Pub. 2003/0209383 A1; U.S. Pat. No. 6,654,019 hardware and software by Gilbert et al.; and by the present inventor in U.S. Pat. Nos. 5,130,794 and 5,495,576.

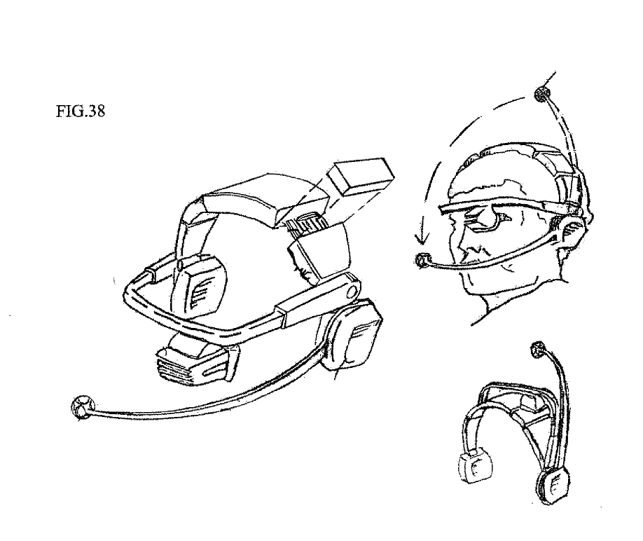

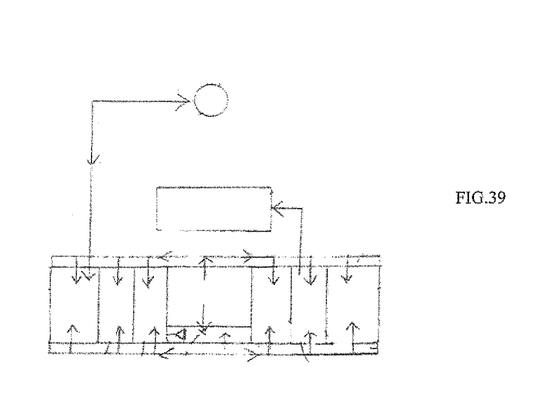

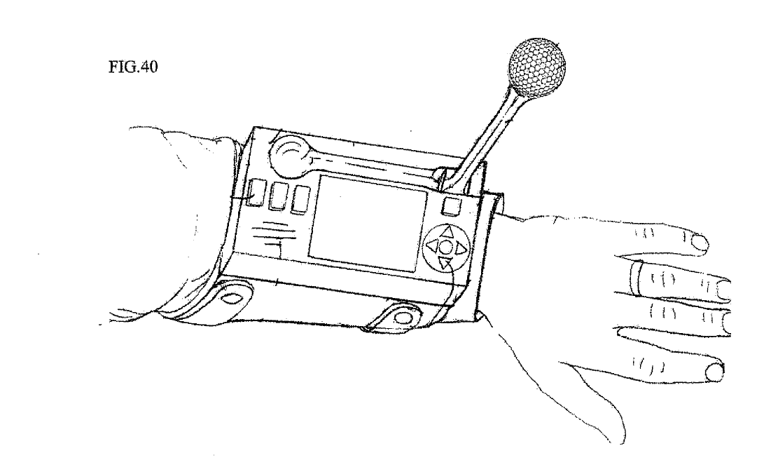

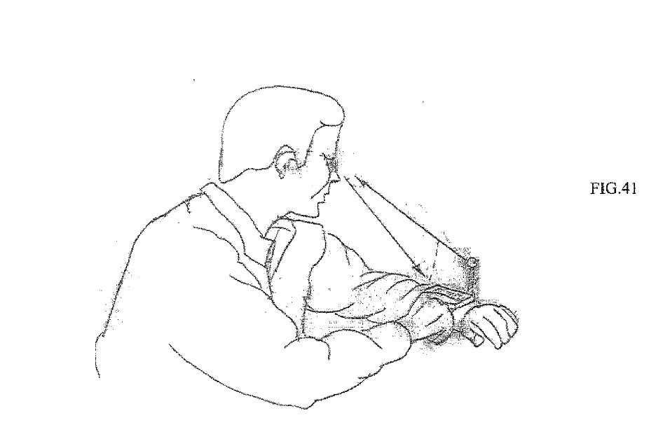

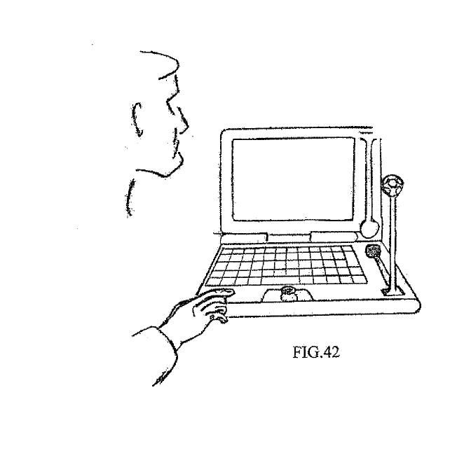

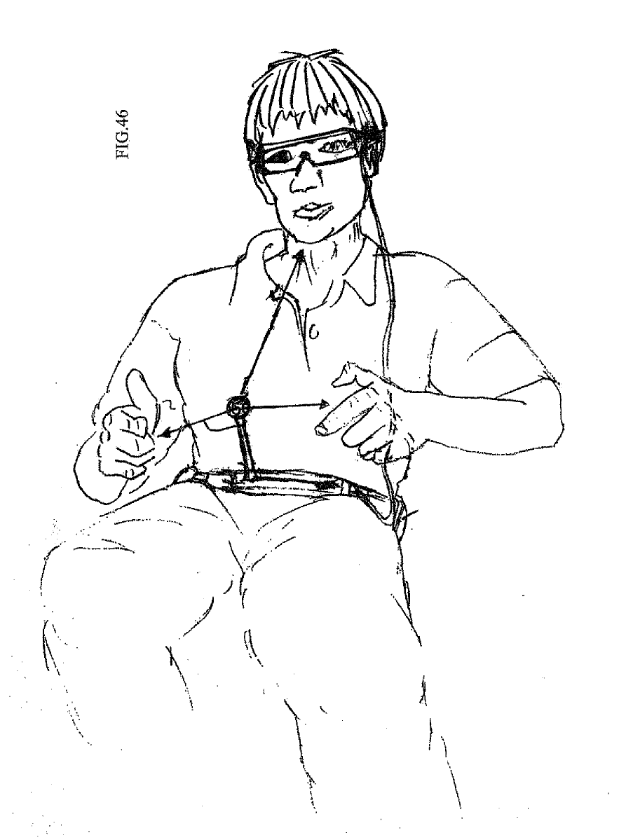

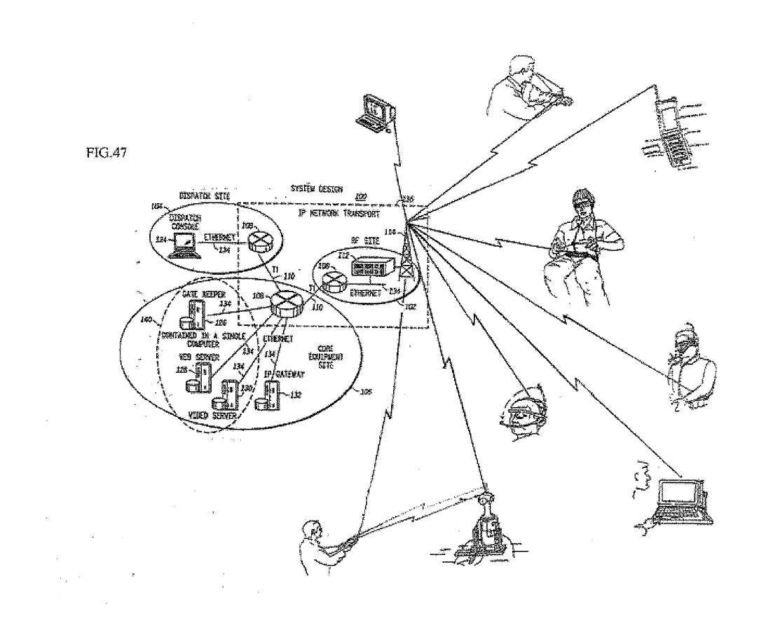

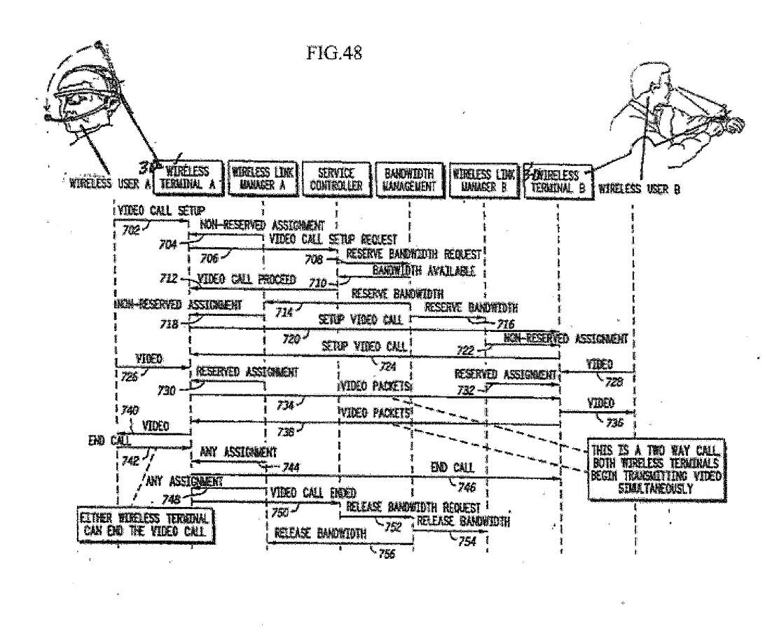

Input mean's embodiments A and B shown in FIGS. 36a and 36b may be incorporated into various housings. Embodiments include those shown in FIG. 37, FIG. 38, FIG. 39, FIG. 40, FIG. 41, FIG. 42, FIG. 43, FIG. 44, FIG. 45, and FIG. 46.

FIG. 19 and FIG. 37 shows an embodiment that comprises standard eye-glasses in outward appearance that have been modified according to the present invention. The

The panoramic sensor assembly 10 like that shown in enlarged details FIG. 20, FIG. 21, FIG. 22, FIG. 23, or FIG. 27 is supported by what may be referred to as an armature or mast. The mast is connected to a swivel like that typically used in boom microphone headsets to the eyeglass frames. The swivel allows the mast to be positioned in front of the users face or above the viewers head as illustrated in FIG. 19. When in the panoramic sensor assembly is positioned in front of the viewers face the image and audio sensors can easily record the users head and/or eye position. When the panoramic sensor assembly is positioned over the viewers head the image and audio sensors can easily record the panoramic scene about the viewer. If input embodiment A is used the relay optics such as fiber optic image conduits, an optical relay lens pipe, mirrors, or prisms reflect the image to an image sensor or sensors. If input embodiment B is used then wires transmit the image to an electronics unit or image processing means. The image processing of the image will be discussed in a later section of this disclosure. Wires and relay optics may be snaked through cables or a flexible conduit to the wearable battery powered, processing and transceiver unit worn by the user. Wires and relay optics from the camera sensor arrays are concealed inside the eyeglass frames and run inside a hollow eyeglass safety strap, such as the safety strap that is sold under the traders “Croakies”.

Eyeglass safety strap typically extends to a long cloth-wrapped cable harness and, when worn inside a shirt, has the appearance of an ordinary eyeglass safety strap, which ordinarily would hang down into the back of the wearer's shirt.

Still referring to FIG. 19 and FIG. 37, wires and relay optics are run down to a belt pack or to a body-worn pack described in FIG. 37b, often comprising a computer as part of processor, powered by battery pack which also powers the portions of the camera and display system located in the headgear. Battery packs of a type suitable for portability are well known in the video production, portable computer, and cellular phone industry and are incorporated in the present invention. The processor if it includes a computer, preferably contains also a nonvolatile storage device or network connection. Alternatively, or in addition to the connection to processor, there is often another kind of recording device, or connection to a transmitting device. The transmitter, if present, is typically powered by the same battery pack that powers the processor. In some embodiments, a minimal amount of circuitry may be concealed in the eyeglass frames so that the wires may be driven with a buffered signal in order to reduce signal loss. In or behind one or both of the eyeglass lenses, there is typically an optical system. This optical system provides a magnified view of an electronic display in the nature of a miniature television screen in which the viewing area is typically less than one inch (or less than 25 millimeters) on the diagonal. The electronic display acts as a viewfinder screen. The viewfinder screen may comprise a ¼ inch (approx. 6 mm) television screen comprising an LCD spatial light modulator with a field-sequenced LED backlight. Preferably custom built circuitry is used.

However, a satisfactory embodiment of the invention may be constructed by having the television screen be driven by a coaxial cable carrying a video signal similar to an NTSC RS-170 signal. In this case the coaxial cable and additional wires to power it are concealed inside the eyeglass safety-strap and run down to a belt pack or other body-worn equipment by connection.

In some embodiments, the television contains a television tuner so that a single coaxial cable may provide both signal and power. In other embodiments the majority of the electronic components needed to construct the video signal are worn on the body, and the eyeglasses and panoramic sensor assembly contain only a minimal amount of circuitry, perhaps only a spatial light modulator, LCD flat panel, or the like, with termination resistors and backlight. In this case, there are a greater number of wires (CCD readout wires for input embodiment B) or fiber optic image conduits (input embodiment A). In some embodiments of the invention the television screen is a

VGA computer display, or another form of computer monitor display, connected to a computer system worn on the body of the wearer of the eyeglasses.

Wearable display devices have been described, such as in U.S. Pat. No. 5,546,099, Head mounted display system with light blocking structure, by Jessica L. Quint and Joel W. Robinson, Aug. 13, 1996, as well as in U.S. Pat. No. 5,708,449, Binocular Head Mounted Display System by Gregory Lee Hcacock and Gordon B. Kuenster, Jan. 13, 1998. (Both of these two patents are assigned to Virtual Vision, a wellknown manufacturer of head-mounted displays). A “personal liquid crystal image display” has been described U.S. Pat. No. 4,636,866, by Noboru Hattori, Jan. 13, 1987. Any of these head-mounted displays of the prior art may be modified into a form such that they will function in place of active television display according to the present invention. A transceiver of a type that may be used to wirelessly transmit video imagery from the camera system to the processing unit and then wirelessly back to the head mounted display in an embodiment of the present invention is the same as incorporated in U.S. Pat. No. 6,614,408 B1 by Mann.

While display devices will typically be held by conventional frames that fit over the ears or head other more contemporary methods are envisioned in the present invention. Because display devices including associated electronics are increasingly becoming lighter in weight the display device or devices may be supported and held in place by body piercings in the eyebrow, nose, or hung on hair from the persons head. Still even weirder, but feasible, is that display devices may be supported by magnets. The magnets can either be stuck on the viewers skin, say the users temple, using a stickie backing or can be embedded under the users skin in the same location. Magnets at the edge of the display that coincide with the magnets mounted under on the skin, along with a noise support hold the displays in front of the users eyes. Because of the electrical power required to drive the display, a conduit to supply power to the display is required. The conduit may contain wires to provide a video signal and for eye tracking cameras also.

In the typical operation of the System shown in FIG. 19 and FIG. 37, light enters the panoramic image sensor and is absorbed and quantified by one or more cameras behind the objective lenses or at the end of the fiber optic image conduits. By virtue of the connection, information about the light entering the eyeglasses is available to the body-worn computer system previously described. The computer system may calculate the actual quantity of light, up to a single unknown scalar constant, arriving at the glasses from each of a plurality of directions corresponding to the location of each pixel of the camera with respect to the camera's center of projection. This calculation may be done using the PENCIGRAPHY method described in Mann's patent. In some embodiments of the invention the narrow-camera, is used to provide a more dense array of such photoquanta estimates. This increase in density toward the center of the visual field of view matches the characteristics of the human visual system in which there is a central foveal region of increased visual acuity. Video from one or both cameras is possibly processed by the body-worn computer and recorded or transmitted to one or more remote locations by a body-worn video transmitter or body-worn Internet connection, such as a standard WA4DSY 56 kbps RF link with a KISS 56 eprom running TCP/IP over an AX25 connection to the serial port of the body-worn computer. The possibly processed video signal is sent back up into the eyeglasses through connection and appears on active display screen, viewed through optical elements.

Typically, rather than displaying raw video on the active display, the video is processed for display as illustrated in FIGS. 37c and 36a, 36b, and 36c(a close-up detail view of the computer processor system 200), as follows: Camera electronics processing 210 outputs video signals from one or more cameras that pass through the wiring harness to a video multiplexer control unit (input embodiment B) 216 controlled by a vision analysis processor 220, also referred to as the image selection processor 220. The image selection processor 220 sends control signals to the spatial light modulator liquid crystal cell shutter control unit and shutter (in input embodiment A) 215 or the video multiplexer (in input embodiment B) 216 to control the shutter or cameras, respectively. The processor may use a look up table to define which pixel or camera to select to define the image transmitted, respectively. The vision analysis processor 220 typically uses the output of the objective lens or lenses and there associated camera or cameras facing the viewer for head and eye tracking. This head and eye tracking determines the relative orientation (yaw, pitch, and roll) of the head based on the visual location of objects in the field of view of camera. The vision analysis processor 220 may also perform 3-D object recognition or parameter estimation, and/or construct a 3-D scene representation. The information processor 230, takes this visual information, and decides which virtual objects, if any, to insert into the viewfinder. The graphics synthesis processor 240, also here referred to as the panoramic image processor, creates a computer-graphics rendering of a portion of the 3-D scene specified by the information processor 230, and presents this computer-graphics rendering by way of wires in wiring harness to display processor 250 of the active television screens of the head mounted display. A processing system 200 of a type that may be used in the present system is that by Mann et al., U.S. Pat. No. 6,307,526, or by using the Thermite processor by Quantum3D.

Typically the objects displayed are panoramic imagery from a like camera located in a remote location or a panoramic scene from a video game or recording. Synthetic (virtual) objects overlaid in the same position as some of the real objects from the scene may also be displayed. Typically the virtual objects displayed on television correspond to real objects within the field of view of panoramic sensor assembly. Preferrably, more detail is recorded by the panoramic sensor assembly in the direction the user is gazing. This imagery provides the vision analysis processor input with extra details about the scene so to make the analysis is more accurate in this foveal region, while the audio and video from other microphones and image sensors provide an anticipatory role and a head-tracking role. In the anticipatory role, the vision analysis processor is already making crude estimates of identity or parameters of objects outside the field of view of the viewfinder screen, with the possible expectation that the wearer may at any time turn his or her head to include some of these objects, or that some of these objects may move into the field of view of active display area reflected to the viewers eyes. With this operation, synthetic objects overlaid on real objects in the viewfinder provide the wearer with enhanced information of the real objects as compared with the view the wearer has of these objects outside of the central field of the user.

Thus even though television active display screen may only have 240 lines of resolution, a virtual television screens of extremely high resolution, wrapping around the wearer, may be implemented by virtue of the head-tracker, so that the wearer may view very high resolution pictures through what appears to be a small window that pans back and forth across the picture by the head-movements of the wearer. Optionally, in addition to overlaying synthetic objects on real objects to enhance real objects, graphics synthesis processor (FIG. 37c) may cause the display of other synthetic objects on the virtual television screen. For example, FIG. 36d, FIG. 36e, and 36f illustrates a virtual television screen with some virtual (synthetic) objects such as an Emacs Buffer upon an xterm (text window in the commonly-used X-windows graphical user-interface). The graphics synthesis processor causes the viewfinder screen (FIG. 19 and FIG. 37) to display a reticle seen in the active display viewfinder window. Typically viewfinder screen has 640 pixels across and 480 down, which is only enough resolution to display one xterm window since an xterm window is typically also 640 pixels across and 480 down (sufficient size for 24 rows of 80 characters of text).

User control of the Panoramic Image Based Virtual Reality/Telepresence Personal Communication System may be a variety of input techniques. For example, as shown in FIGS. 21-23, microphones may be integrated into the sensor assembly 10 of the head mounted device. Alternatively, they may be worn by the viewer and located in any other suitable location. Personal computer windows driven voice recognition system suitable in type for use in the present invention comprises the Kurzweil Voice Recognition and Dragon Voice Recognition Software/Firmware compatible that can be put onto the present unit 120 or 122 to receive voice commands for selecting menu options for driving the unit and communication with other cellular users.

Besides voice recognition input, another preferable interactive user input means in the present invention is user body gesture input via camera input. While separate non-panoramic cameras can be mounted on the user to record body movement, an advantage of using the panoramic sensor assembly to provide input is that it simultaneously provides a panoramic view of the surrounding environment and the user thus obviating the need for a single or dispersed cameras being worn by the viewer. A computer gesture input software or firmware program of a type suitable for use in the present invention is Facelab by the company Seeingmachines, Canberra, Australia. Facelab3 and variants of the software uses at least one, but preferably two points of view, to track the head position and eye location and blink rate. Simultaneous real-time and smoothed tracking data available provides instantaneous output to the host processing unit. In this manner the user can use the panoramic sensor assembly, to track the users head and eye position and define the view the user when viewing panoramic imagery or 3-D graphics on the unit 120 or 122.

Making a window active in the X-windows system is normally done by a user using his hand to operate a mouse and placing the mouse cursor on the window and possibly clicking on it. However, having a mouse on a wearable panoramic camera/computer system is difficult owing to the fact that it requires a great deal of dexterity to position a cursor while walking around. Mann in U.S. Pat. No. 6,307,526 describes an active display viewfinder where the mouse/cursor: the wearer's head is the mouse, and the center of the viewfinder is the cursor. The Mann system may be incorporated in the present invention. However, the present invention expands upon Mann by using the panoramic input device to record more than just head and eye position by using the panoramic sensor assembly to record other body gestures such as hand and finger gestures. A software package for recording head, body, hand, finger, and other body gestures is facelab mentioned above, or the system used by Mann. The gestures are recorded by the image sensors of the panoramic sensor assembly. The input from the sensors is translated by an image processing system into machine language commands that control the Panoramic Image Based Virtual Reality/Telepresence Personal Communication System. The menus in the active display viewfinder are visible and may be overlayed over the real world scene or seen threw the glasses or overlaid on panoramic video transmitted for display. Portions of the menue within the viewfinder are shown with solid lines so that they stand out to the wearer. And xterm operating system suitable and of a type for use in the present invention is that put forth in the Mann patent previously mentioned. A windows type operating system suitable for and of the type suitable for incorporation in the present invention is Microsoft Inc., Windows XP or Read Hat Linux. Application software or firmware may be written/coded in any suitable computer language like C, C++, Java, or other suitable O.S. Preferrably, software is compiled in the same language to avoid translator software slowing application processing down during operation.

Once the wearer selects window by a voice command or body gesture, then the wearer presses uses a follow-on voice command or gesture to choose another command. In this manner the viewer may control the system applications using menus that may or may not be designed to pop up the viewers field-of-view conventional button or switch to turn the system on and off may be mounted in any suitable place on the invention that is worn by the viewer. Still referring to

FIG. 19 and FIG. 37, FIG. 36c shows a data or communications port with standard input jacks, with pins, and cable or wires may be used to attach the body worn Panoramic Image Based Virtual Reality/Telepresence Personal Communication System to another computer. In this way software in the body worn computer system may be interacted with by the interface computer to do things such as changing configuration of the body worn computer, add new software, run diagnostics, and so forth and so on. The interface computer will typically comprise a standard conventional Personal Computer with processor, random access memory, fixed storage, removable storage, network interface, printer/fax/scanner interface, sound and video card, mouse, keyboard, display adapter and display. Alternatively, the body worn computer may be controlled and interfaced with by another computer via it's transceiver.

Note that here the drawings depict objects moved translationally (e.g. the group of translations specified by two scalar parameters) while in actual practice, virtual objects undergo a projective coordinate transformation in two dimensions, governed by eight scalar parameters, or objects undergo three dimensional coordinate transformations. When the virtual objects are flat, such as text windows, such a user-interface is called a “Reality Window Manager” (RWM).

In using the invention, typically various windows appear to hover above various real objects, and regardless of the orientation of the wearer's head (position of the viewfinder), the system sustains the illusion that the virtual objects (in this example, xterms) are attached to real objects. The act of panning the head back-and forth in order to navigate around the space of virtual objects also may cause an extremely high-resolution picture to be acquired through appropriate processing of a plurality of pictures captured by a plurality of objective lenses and stitching the images together. This action mimicks the function of the human eye, where saccades are replaced with head movements to sweep out the scene using the camera's light-measurement ability as is typical of PEAOCIGRAPHIC imaging. Thus the panoramic sensor assembly is used to direct the camera to scan out a scene in the same way that eyeball movements normally orient the eye to scan out a scene.

The processor is typically responsible for ensuring that the view rendered in graphics processor matches the view chosen by the user and corresponding to a coherent spherical scene of stitched together image sub-segments and not the vision processor. Thus if the point of view of the user is attempted to be replicated there is a change of viewing angle, in the rendering, so as to compensate for the difference in position (parallax) between the panoramic sensor assembly and the view afforded by the display.

Some homographic and quantigraphic image analysis embodiments do not require a 3-D scene analysis, and instead use 2-D projective coordinate transformations of a flat object or flat surface of an object, in order to effect the parallax correction between virtual objects and the view of the scene as it would appear with the glasses removed from the wearer.

A drawback of the apparatus depicted is that some optical elements may interfere with the eye contact of the wearer. This however, can be minimized by the careful choice of the optical elements chosen. One technique that can be used to minimize interference is for the wearer is for the wearer to look at video captured by the camera such that an illusion of transparency is created, in the same way that a hand-held camcorder creates an illusion of transparency. The only problem with that is that the panoramic sensor is not able to observe where the viewers eyes are located, unless sensors are placed behind the display as Mann does. Therefore this invention proposes to put cameras or objective lenses and relays behind the eye-glasses to observe the viewer and also incorporate a panoramic sensor assembly as indicated to capture images outside the eyeglasses and about the wearer as depicted in FIG. 19. However, this is just one application of the invention. And other applications such as gaming and quasi-telepresence may be more suitable for the present invention anyway. If the illusion of creating the exact view by the user is desired then the system by Mann may be more useful.

The embodiments of the wearable camera system depicted in FIG. 19, FIG. 37, and FIGS. 36a-1 give rise to a some displacement between the actual location of the panoramic camera assembly, and the location of the virtual image of the viewfinder. Therefore, either the parallax must be corrected by a vision system, followed by 3-D coordinate transformation (e.g. in processor), followed by re-rendering (e.g. in processor), or if the video is fed through directly, the wearer must learn to make this compensation mentally. When this mental task is imposed upon the wearer, when performing tasks at close range, such as looking into a microscope while wearing the glasses, there is a discrepancy that is difficult to learn, and may also give rise to unpleasant psychophysical effects such as nausea or “flashbacks”. Initially when wearing the glasses, the tendency is to put the microscope eyepiece up to one eye, rather than the camera which is right between the eyes. As a result, the apparatus; fails to record exactly the wearer's experience, until the wearer can learn that the effective eve position is right in the middle. Locating the cameras elsewhere does not help appreciably, as there will always be some error. It is preferred that the apparatus will record exactly the wearer's experience. Thus if the wearer looks into a microscope, the glasses should record that experience for others to observe vicariously through the wearer's eye. Although the wearer can learn the difference between the camera position and the eye position, it is preferable that this not be required, for otherwise, as previously described, long-term usage may lead to undesirable flashback effects.

In the present invention image processing can be done to help compensate for the difference between where the viewers eyes are and the panoramic sensor assembly is located. To attempt to create such an illusion of transparency requires parsing all objects through the analysis processor, followed by the synthesis processor, and this may present processor with a formidable task. Moreover, the fact that the eye of the wearer is blocked means that others cannot make eye-contact with the wearer. In social situations this creates an unnatural form of interaction. For this reason head mounted displays with transparency are desirable in social situations and in situations when it is important for the panoramic sensor assembly or mini-optics to track the eyes of the user. Design is a set of tradeoffs, and embodiments disclosed in the present inventions can be incorporated in various manners to optimize the application the user must perform.

Although the lenses of the glasses may be made sufficiently dark that the viewfinder optics are concealed, it is preferable that the active display viewfinder optics be concealed in eyeglasses so to allow others to see both of the wearer's eyes as they would if the user was wearing regular eyeglasses. A beamsplitter may be used for this purpose, but it is preferable that there be a strong lens directly in front of the eye of the wearer to provide for a wide field of view. While a special contact lens might be worn for this purpose. there are limitations on how short the focal length of a contact lens can be, and such a solution is inconvenient for other reasons.

Accordingly, a viewfinder system is depicted in FIG. 37 in which an optical path brings light from a viewfinder screen, through a first relay mirror, along a cavity inside the left temple-side piece of the glasses formed by an opaque side shield, or simply by hollowing out a temple side-shield. Light travels to a second relay mirror and is combined with light from the outside environment as seen through diverging lens. The light from the outside and from the viewfinder is combined by way of beamsplitter. The rest of the eyeglass lenses are typically tinted slightly to match the beamsplitter so that other people looking at the wearer's eyes do not see a dark patch where the beamsplitter is. Converging lens magnifies the image from the active display viewfinder screen, while canceling the effect of the diverging lens. The result is that others can look into the wearer's eyes and see both eyes at normal magnification, while at the same time, the wearer can see the camera viewfinder at increased magnification. It is noted that that the video transmitter can be replaced with a data communications transceiver depending on the application. In fact both can be included for demanding applications. Transceiver along with appropriate instructions loaded into computer provides a camera system allowing collaboration between the user of the apparatus and one or more other persons at remote locations. This collaboration may be facilitated through the manipulation of shared virtual objects such as cursors, or computer graphics renderings displayed upon the camera viewfinder(s) of one or more users. Data and video transceivers like those depicted in the Mann U.S. Pat. No. 6,307,526 are of a type that may be incorporated into the present invention. Examples of other wireless head and eve tracking systems that are of a type that may be incorporated into the present invention include the system on the HMD system marketed by Seimens, and the ones in U.S. Pat. No. 5,815,126 by Fan et al, U.S. Pat. No. 6,307,589 B1 by Maquire, Jr, or in U.S. Pat. App. Pub. 2003/0108236 by Yoon.

As discussed later in the specification in FIGS. 47 through 51, similarly, transceivers, with appropriate instructions executed in computer of the System 120 or 122 allows multiple users of the invention, whether at remote locations or side-by-side, or in the same room within each other's field of view, to interact with one another through the collaborative capabilities of the apparatus. This also allows multiple users, at remote locations, to collaborate in such a way that a virtual environment is shared in which camera-based head-tracking of each user results in acquisition of video and subsequent generation of virtual information being made available to the other(s). Besides Bluetooth, Belverde, and Centrino technologies, and other cellular technologies previously mentioned above, transceivers that allow for wireless communication of video and other data between components of the unit 120 and 122, and allow for wireless communication of video and other data between the unit 120 and 122 includes that in U.S. Pat. No. 6,307,526 by Mann, U.S. Pat. No. 5,815,126 by Fan et al, U.S. Pat. No. 6,307,589 B1 by Maquire, Jr, or in U.S. Pat. App. Pub. 2003/0108236 by Yoon.

Multiple users, at the same location, may also collaborate in such a way that multiple panoramic sensor assembly viewpoints may be shared among the users so that they can advise each other on matters such as composition, or so that one or more viewers at remote locations can advise one or more of the users on matters such as composition. Multiple users, at different locations, may also collaborate on an effort that may not pertain to photography or videography directly, but an effort nevertheless that is enhanced by the ability for each person to experience the viewpoint of another.

It is also possible for one or more remote participants using a like system or other conventional remote device like that shown at the top of FIG. 36i or the like to interact with one or more users of the wearer of a panoramic camera system, at one or more other locations, to collaborate on an effort that may not pertain to photography or videography directly, but an effort nevertheless that is enhanced by the ability for one or more users of the camera system to either provide or obtain advice from one to another individual at a remote location.

FIG. 38 and FIG. 39 depict other embodiments of the present invention. FIG. 38 is a perspective drawing of a head mounted device in which panoramic capture, processing, display, and communication means are integrated into a single unit 120 or 122. A panoramic sensor assembly 10 is mounted on a mast or first armature that swivels such that the assembly can be positioned for what the user considers optimal video recording. The mast is connected to a second armature that folds down and has a viewfinder or small display monitor that is positionable in front of the wearers eye. While one monitor is shown, two monitors, one for each eye, may be incorporated. A support piece goes over the top of the users head. The mast and viewfinder/monitor/active display armatures are connected to the support piece that goes over the wearers head such that the entire unit may be folded up for easy storage.

FIG. 39 is a diagram of the components and interaction between the components that comprise the integrated head mounted device 120 or 122 shown in FIG. 38. The support piece that goes over the users head preferably has pads along its lower side to provide cushion from the weight of the head mounted device. Modules are provided that snap and plug together along the support piece. A power bus and processing bus connects to the modules that include the head phones, camera(s) processing, image selection processing, panoramic image processing, display processing, battery, and transceiver module(s). The processing bus and the electrical power bus have suitable wires and/or optical relays for transmitting imagery and audio to and from the panoramic sensor assembly and active display(s) as previously described.

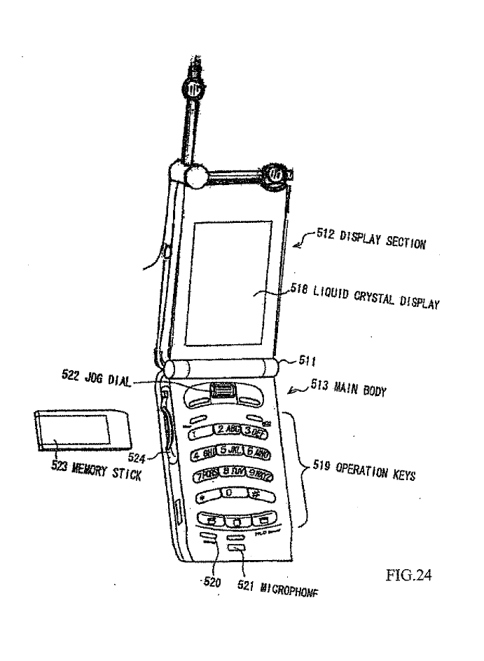

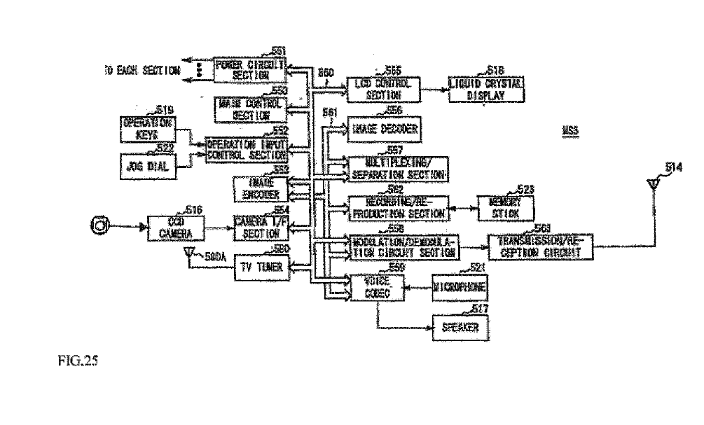

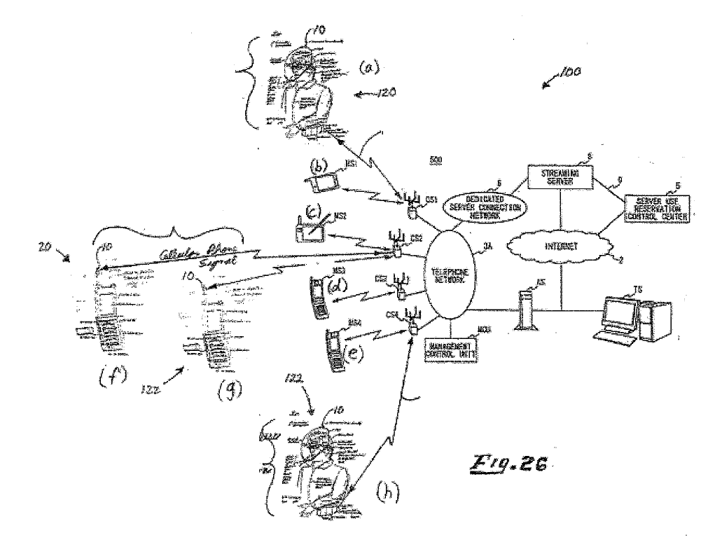

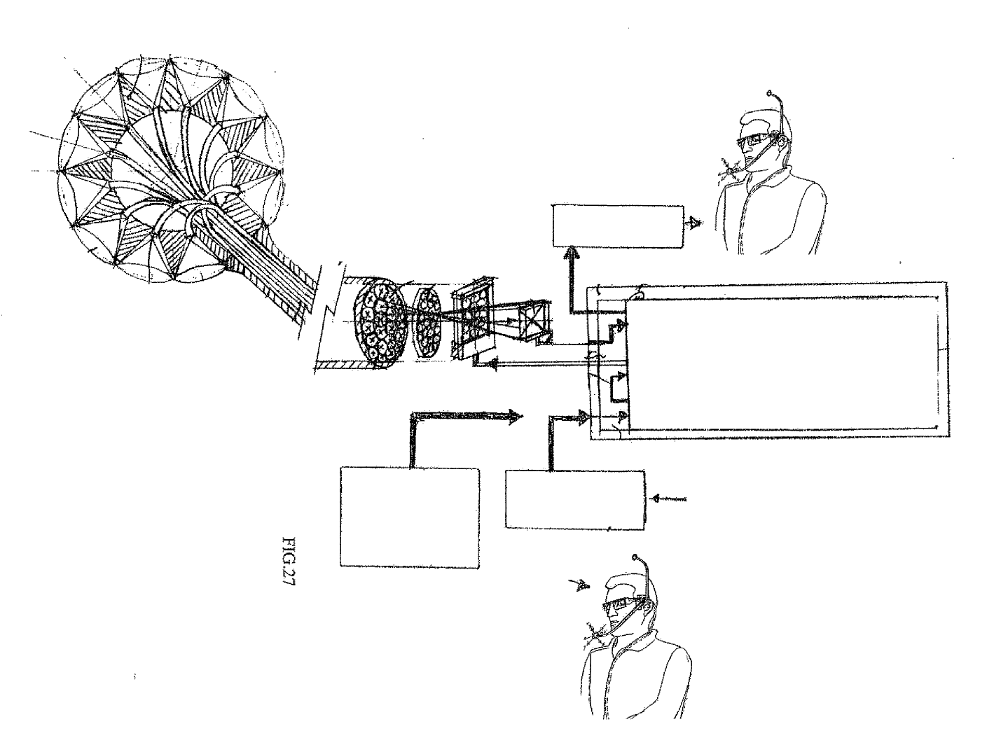

FIG. 24 and FIG. 40 is a perspective of a handheld and wrist mounted Personal wireless communication device 120 or 122 (i.e. video cell phone or personal communicator with video display and camera) with a panoramic sensor assembly for use according to the present invention. The device incorporates all typical hardware and software features of a standard cellular phone described in FIG. 25 plus a panoramic sensor assembly and associated electronics. Because size does matter, in this instance, compact electronics and electro-optics are incorporated to achieve embodiment A or B functionality described in FIG. 36a and FIG. 36b to select the images for transmission taken by the panoramic sensor assembly. For instance in FIG. 36a, embodiment A input means, a small SLM LCD shutter system can be operated to dynamically select the displayed image. Manufactures, systems, and the operation of the spatial light modulator have already been described in early sections of this disclosure so need not be repeated. Alternatively in FIG. 36b, embodiment B input means, a small plural camera switching system that can be incorporated. High-Speed, Low Power, Single-Supply Multichannel, Video Multiplexer-Amplifiers of a type ideal for use in the present invention are the MAX4310/MAX4311/MAX4312 2-/4-/8-channel multiplexers, respectively. A MAX multiplexer can be integrated into a typical operating circuit in unit 120 or 122 to selectively and dynamically select which camera feed is selected based on user head and eye position data processed by the unit 120 or 122. Head and eye position data is sent to the processor which references look-up tables to define what positions correspond what camera(s) to select to provide a certain view. The MAX multiplexers are manufactured by Maxium Integrated Products, Inc. of Sunnyvale, Calif. Other video multiplexer/demultiplexer systems of a type that may be integrated into unit 120 or 122 of the present invention include those described in U.S. Pat. No. 5,499,146 by Donahue et al.; U.S. Pat. App. Pub. 2002/0018124 A1 by Mottur et al.: U.S. Pat. No. 5,351,129 by Lai; U.S. Pat. App. Pub. 2003/0122954 A1. The operation of the switching system has already been described in early sections of this disclosure so need not be repeated.

It is noted that it is possible to distribute the image capture, processing, and display means of the present invention into standalone units worn by the viewer. In such an instance the means may be linked in communicating relationship to one another by transceivers. Wireless transceivers of a type that may be integrated into the present invention have been discussed in the text above and are included here by reference. These wireless transceivers adopt the standards discussed above and have been integrated into numerous products so that electronic devices may communicate wirelessly with one another. The advantage of doing this is to alleviate wires, cables, or optical relays running between these means when they are distributed over the users body. Additionally, the distribution of these means allows for the distribution of weight of these components. For instance, a significant amount of weight can be removed from the integrated system in FIG. 38 by distributing the processing means and significant portion of the battery storage unit of the invention to a belt worn system. If components of unit 120 are distributed a portable power storage and distribution system is included as part of the design in a conventional manner.

As illustrated in FIG. 24, FIG. 40, FIG. 42, and FIG. 44a-e, a wide variety of folding and telescopic arrangements are described for allowing the panoramic optical assembly 10 and mast to be stowed and erected in order to facilitate portability of the system. For instance, in FIG. 40 a spring mechanism is incorporated to hold the mast and sensor assembly in the upright erect position for optimal recording. A springed latch button is pushed by the user to erect the mast and sensor assembly. The user pushes the mast down with his or her hand when finished and the springed latch re-catches a portion of the mast to hold it in the stowed position. In another instance, in FIG. 44a-e indentations allow antenna-like hollow rods with relay lenses are erected into position to facilitate optical transmission of an image to the image sensor. FIG. 44a-e are drawings of a telescoping panoramic sensor assembly according to the present invention. FIG. 44a is a side sectional view showing the unit in the stowage position. FIG. 44b is a side sectional view of the unit in the operational position. FIG. 44c is a perspective drawing of the unit is the operational position. FIG. 44d is a greatly enlarged side sectional drawing of a telescoping arrangement wherein male and female indentations match up to hold the telescoping unit in an erect operational position. Yet the user may retract the unit in an antenna-like manner by pushing the indentations into a collapsed stowage position. FIG. 44e is a greatly enlarged side sectional drawing of a telescoping arrangement wherein springs with balls push outward into sockets to hold the telescoping relay unit in an operational position. And then the springs retract with the ball and push inward when the user applies pressure downward on the antenna-like mast to put the mast in the stowage position. Relay optics (embodiment A) or wires (embodiment B) may be run from the sensor assembly through the mast and an opening at the bottom of the mast depending on the specific design of the device. Indentations may be put into the body of a desktop, portable laptop, cellular phone, or personal communicator in order to also facilitate stowage and portability of the panoramic sensor assembly and mast.

A manufacturer of a device of a type that may be used to hold the unit 120 or 122 on the wrist of the user is the Wrist Cell Sleeve cellular phone holder of Vista, Calif., referred to as the “CSleeve” that is secures the unit and is made of a material that goes around the wrist and is secured around the wrist by velcrove. The mast and panoramic sensor may be placed in the operational position by pushing a button to release a coil or wire spring that pushes the mast and assembly upright. Similar systems are used in switch-blade knives and Mercedes keyholders. The mast and assembly lock in place when pushed down into the closed position.

FIG. 41 is a perspective illustrating the interaction between the user and the wrist mounted personal wireless communication device 120 o 122 (i.e. retrofitted cell phone) with a panoramic sensor assembly shown in FIG. 40. In operation the user interacts with the communication device by using standard interface techniques such a using his or her finger to push buttons, use voice commands, or a stylus to enter commands to the unit.

Additionally, and novel to standard techniques, the user may also use the panoramic sensor assembly as an input. As previously described, panoramic sensor assembly records the viewer and surrounding audio-visual environment. The audio-signals representing all or some portion of the surrounding scene are then transmitted over the cellular communication network.

FIG. 42 is a perspective drawing of a laptop with an integrated panoramic camera system according to the unit 120 or 122 of the present invention. Processing of the panoramic image, display on the screen, and a wireless transceiver are housed integrated into the standard body of the laptop. A similar arrangement could be incorporated into a desktop computer or set-top box.

FIG. 45a-f are drawings of the present invention integrated into various common hats.

FIG. 45a-c are exterior perspectives illustrating the integration of the present invention into cowboy hat that forms unit 120 or 122. Micro-lense objectives are integrated into the hat in an outward facing manner such that they record adjacent or overlapping portions of the surround panoramic environment. Microphones may also be integrated in a similar fashion. Fiber optic image conduits relay the images from the micro-lenses to image an image sensor if input means embodiment A is used as depicted in FIG. 36a. For instance, in FIG. 45a-f objective lenses are faced inward to observe the viewers face and eyes. Wires transmit the images from the CCD's located behind the objective micro-lenses to image processing means if input means embodiment B is used as depicted in FIG. 36b. The wires are illustrated as dashed lines. In either arrangement A or B, similar input means can be used to look inward at the viewer's head/face and eyes. Transmission of information coming to and being transmitted out of the personal panoramic communication system is accomplished by the transceiver. Processing means may be located in the hat, say on a printed circuit board (PCBs) in a unit in the top part of the hat, on a flat like circular PCB integrated into the brim of the hat, or on a circular tube-like PCB integrated into the crown of the hat. Images arriving from the transceiver or derived onboard the hat is displayed on a display screen with viewing optics that pulls down from the crown of the hat in front of the users eyes. The display is in an open cavity of the hat in front of the viewer's forehead and is pulled down pushed up along channels at each end of the display. Optics are integrated into the display so that the wearer can see the display in focus. The display may be opaque, however, preferably the display allows either opaque, see through, or a combination of both to take place to facilitate augmented reality applications. A flexible color display of a type that can be incorporated into displays of the present invention, specifically those like used in the hats of FIG. 45a-f, is manufactured by Philips Research Labratories, Eindhoven, The Netherlands, disclosed at the Society for Information Display Symposium, Session 16: Flexible Displays, May 25-27, 2004, Seattle, Wash., USA by P. Slikkerveer, and black and white displays currently in production by Polymer Vision for Royal Philips Electronics. The displays printed on what is called “e-paper” may be rolled or folded slightly, are three times the thickness of paper, measure about 5 inches diagonally, weigh approximately 3.5 grams, and can be manufactured so that the image can cause the display to be opaque or allow a see through capability.

FIG. 45d-f are exterior perspectives illustrating the integration of the present invention into unit 120 or 122 in the form of a baseball cap. The components and operation of the baseball hat can be similar to the cowboy hat. However, in order to show various embodiments of the invention, the illustration shows that the processing means is communicated with through a cable worn elsewhere on the viewer's body. And the baseball cap illustration the display is stowed on the bottom surface of the bill of the cap and flipped down into position in front of the wearer's eyes.

FIG. 46 is a perspective view of an embodiment of the present invention wherein the panoramic sensor assembly 10 is optionally being used to track the head and hands of the user. In the present example, the panoramic sensor assembly is used to track specified users body movements as he plays an interactive computer game. The head mounted unit is connected to a belt worn stowage and housing system that includes the flip-up panoramic sensor assembly, computer processing system (including wireless communication devices), and a head-mounted display system that forms unit 120 or 122. Alternatively, the sensor assembly may also be used to record, process, and display images for video telepresence and augmented reality applications as illustrated in other figures disclosed within this invention. Similarly, the panoramic sensor assembly can be used by a remote wearer wanting to track the movement of a wearer or subject in the environment. In this manner the person at location A can have telepresence with the wearer at location B. The sensor assembly may also be used to record, process, and display images for video telepresence and augmented reality applications as illustrated in other figures disclosed and described within this invention.

Still alternatively, as depicted in FIG. 36c, embodiment C and D, input means can comprise images and graphics recorded, stored, and played back by a 3-D or panoramic application software or firmware via appropriate processing means. Or input means can comprise images or graphics generated by a 3-D or panoramic application software or firmware via appropriate processing means. The imagery and graphics played back for viewing by a user may panoramic or not panoramic. As depicted in embodiment C the information can be stored on board the portion of the System worn by the user or transmitted from computers. And as depicted in Embodiment D a host computer can be interfaced by wire or wireless means to configure and load programs onto the body worn portion of the System that forms the present invention. While storage systems are not depicted on the hardware portion of the System in FIG. 36a, 36b, and 36c, these are normal parts of any computer and assumed existing in the form of fixed storage, removable storage, or RAM. These options will discussed further in this invention under “Processing” and “Display” and “Telecommunications” means portion of this specification.

The processing means consists of computers, networks, and associated software and firmware that operates on the signals from the input means. In the preferred embodiment the input means consists of a panoramic camera system which provides panoramic imagery. Processing means is a subset of unit 120 or 122, and to varying degrees network 100. Some of the processing operations have been described above in order to facilitate the cohesion of the disclosure of the primary embodiments A and B of the system so will not be repeated. But it will be clear to those skilled in the art that those processing portions are transferable and applicable to the more detailed and additional discussion below concerning processing means.

Referring to FIG. 21, FIG. 27, and FIGS. 36a-i, the processing hardware preferably consists of a small powerful computer system that is worn or held by a user. However, it is foreseen that the unit may be turned on and left in a stand-alone or remote control mode. The processing hardware consists of several major components to include a spatial light modulator/liquid crystal display (SLIM LCD) shutter (embodiment A) or a video video multiplexer/switcher (embodiment B) or on-board generation systems like games, or prerecorded/stored input systems, a wireless transceiver for sending data and video, a processing unit that comprises a vision analysis processor, information processor, graphics synthesis processor with a system bus, and a battery with power bus. Input/output jacks and cables standard these components allow them to be connected to the input hardware and display systems that are also integral to the system and worn or held by the user. These components used are as compact as possible to allow the processing hardware to be portable so it can be worn by the user. For instance, FIG. 19 and FIG. 27 illustrate a user using a belt worn embodiment of the system. Alternatively, processing hardware can be distributed and connected to other hardware processing systems that form the system by transceivers. Small portable computer systems of a type that may be used to facilitate the present invention are disclosed by Mann in U.S. Pat. No. 6,307,526 and that are manufactured by Quantum3D, Incorporated as Thermite. Quantum3D and ViA announced Thermite, the first man-wearable, battery-operated, multi-role, COTS system for deployed tactical visual computing applications. Thermite, which is powered by Transmeta's Crusoe™5800 processor, is designed for soldiers, public safety and other operations personnel.

Referring generally to the processing hardware shown in FIG. 36a, FIG. 36b, and 36c, the user input control system may include devices such as a mouse, keyboard, joystick, trackball, head mounted position tracking system, eye tracking system, or other typical tracking and processing system known to those skilled in the art. The position and tracking systems may incorporate magnetic, radio-frequency, or optical tracking. The user may use the above control devices to continuously control the selected scene displayed to define rules that, once established, operate a program that operates continuously in an autonomous fashion to define what scene is selected for viewing. The tracking system may be mounted on the user viewing the selected scene or on a remote user viewing the selected scene. Or the tracking system may be autonomous and not mounted on the user viewing the selected scene or on a remote user viewing the selected scene. Associated with the tracking system is a computer system to run the tracking system. The software programs that provide graphic user interface and the associated software to select the imagery and audio for viewing may be in installed in the computer in the form of software or firmware. The computer that the software runs on may be positioned in any suitable location in the processing chain between when the raw imagery is captured and the imagery is selected for manipulation for viewing. The control unit may be a subset of a larger computer with various application software on it or housed on a separate computer that is connected with others operating to provide a selected panoramic image to a viewer.

In FIG. 36e, FIG. 36f, and 36g, the spatial light modulator/liquid crystal cell (SLM LCD) shutter control unit receives input from a user SLM LCD processing unit that defines the imagery to be selected for display. The SLM LCD may comprise a printed circuit board for mounting in a personal computer or a box unit. In either case the SLM LCD control unit is in communicating relationship between the SLM LCD shutter and the personal computer system. The input from the processing unit provides information to the SLM LCD shutter control unit that defines the location and the timing of the pixels to be open and closed on the SLM LCD shutter. Software of a type suitable for use with the SLM LCD control unit for interfacing with standard personal computer system-like architecture incorporated in the present invention is available from Meadowlark Optics which has already been described. Head and eye tracking software provides position, orientation, and heading data to the input control system to define the imagery to be selected processing and display. This imagery is updated on a continual basis. Position, orientation, and heading data define the selection of the pixels of the spatial light modulator that are open and closed. The position, orientation, and heading data is translated into control unit data that defines the opening and closing of pixels of the spatial light modulator. In this way the image is selected and transmitted to the image sensor of unit 120 or 122.

Preferrably, at least head and eye tracking hardware and software of a type for incorporation in the present invention is described in U.S. Pat. No. 6,307,526 by Mann or of a type manufactured by Seeingmachines, Australia which has already been described. Position, orientation, and heading data, and optionally eye tracking data, received from the input control system is transmitted to the computer processing system to achieve dynamic selective image capture system. Position, orientation, and heading data define the position, orientation, and heading of the viewers head and eye position. According to studies, head position information alone can be used to predict the direction of view about 86 percent of the time.

Operating system and application software are an integral part of the Panoramic Image Based Virtual Reality/Telepresence Personal Communication System and Method. Alternatively, the software can be stored as firmware. For instance, a software may be embedded onto the memory of a reconfigurable central processing unit chip of a body worn computer. Operating system and application software is stored in firmware, as RAM, on hard drives, or other suitable media storage worn by the viewer. Different processors worn by the viewer are programmed to complete tasks that enable the invention. The user of the system operates the system to perform those application programs which he or she chooses to accomplish the tasks desired. In operation the software applications are integrated, threaded, and compiled together in a seamless manner to achieve concerted and specific operations. Those tasks and applications are described below:

As graphically illustrated in FIG. 36d1, upon using a conventional button or switch to turn the Panoramic Image Based Virtual Reality/Telepresence Personal Communication System on the user may select applications he wants to perform. The on button can be similar to that used on any conventional computer, cellular phone, palm-top, or the like.

Once turned on, the system may use body gestures tracked by cameras worn by the wearer or a remote user, voice recognition, or other conventional method to interact with the xterm menu in window on the users display. A typical sequence frames that would displayed for the user of the menus is illustrated in FIG. 36d under the words The System Control/Application Control. The menus may be displayed on an opaque background or the words projected over a real world surrounding environment or camera recorded background depending on which application options the user chooses. The window can be positioned in any location on the users display, again depending on what preferences the user chooses. As stated earlier, processes and applications may be located on one or more storage and processing units. However, preferably the applications are compiled into the same machine language with a common operating system to make them compatible. This compatibility facilitates the writing of a typical tree menu with branches of applications and specific functions which control the applications software or firmware graphically shown in FIG. 36a, FIG. 36b, and FIG. 36c.

Still referring to FIG. 36d2, Video Capture and Control system is second application of the Panoramic Image Based Virtual Reality/Telepresence Personal Communication System. Video Capture and Control allows the user to define typical digital video camera functions similar to that found on any conventional digital camcorder system. Specifically the user can control the imagery and audio functions of the System. A frame sequence with a users face that has been sampled from video recorded by the panoramic sensor assembly is shown in FIG. 36d to graphically illustrate a standard operation of this application. These controls can be implemented by use of menus as described in the above paragraph. If input embodiment A is used in the invention then control of the LCD SLM is also included as part of the Video Capture and Control system. Alternatively, if input embodiment B is used in the invention then control of the video switcher/multiplexer system is included as part of the Video Capture and Control system. The image is then output for display (FIG. 36g, FIG. 36h, or FIG. 36i), recording, or further processing. Software or firmware of a general nature for manipulating and viewing video within the context of the present invention includes software by Mann in U.S. Pat. No. 6,307,526; Gilbert in U.S. Pat. No. 6,323,858 B1, IPIX's Immersive Movies; and U.S. Pat. No. 4,334,245 referenced by Ritchey in U.S. Pat. No. 5,130,794 by Mitchael to create and manipulate spherical camera(s) imagery using a digital video effects generator.

Audio processing software or firmware of a type that is incorporated into the present invention is that described by U.S. Pat. No. 6,654,019 hardware and software by Gilbert et al.; or Sound Forge Incorporated's multi-channel software. Speech recognitions systems by Dragon Systems and Kurzweil may also be incorporated as discussed in more detail elsewhere. Additionally, speech recognition control of unit 120 or 122 may be controlled by software described in U.S. Pat. No. 6,535,854 B2 by Buchner et al; and features tracked using software described in U.S. Pat. Pub. App. 2003/0227476.

Again referring to FIG. 36d3, Image Stabilization is a third software or firmware application of the Panoramic Image Based Virtual Reality/Telepresence Personal Communication System. Image stabilization may be accomplished optically or digitally, that is respectively by using electro-optical/mechanical means or by using software. These techniques are well know in the camcorder industry and may be included in the present invention. Image stabilization software and firmware that may be incorporated into the present invention is manufactured by JVC, Sony, Canon and other video camera manufacturers, and is well known to those skilled in the art of video camera design. The Canon XL-1 Camcorder and the JVC HD-1 HDTV camcorder are examples of systems that incorporate image stabilization mechanisms and software/firmware that may be incorporated into the present invention. Software for correcting image jitter and blurring may be corrected by incorporating corrective software or firmware of a type like that described in U.S. Pat. App. Pub. 2004/0027454 A1 by Vella et al. or by incorporating SynaPel's SteadyHand software. FIG. 36d, Image Stabilization, Section a, illustrates a frame sequence of a bystander that has been sampled from video recorded by the panoramic sensor assembly without image stabilization applied. The independent lines around the body of the bystander illustrate the blur and jittery image recorded by vibration caused by the wearers body motion. FIG. 36d, Image Stabilization, Section b, illustrates a frame sequence of a bystander that has been sampled from video recorded by the panoramic sensor assembly with image stabilization applied. The independent lines representing the vibration have been removed by the software or firmware image stabilization software application. The image is then output for display (FIG. 36g, FIG. 36h, or FIG. 36i), recording, or further processing.

Again referring to FIG. 36d4, Target and Feature Selection, Acquisition, Tracking, and Reporting is a forth software or firmware application of the Panoramic Image Based Virtual Reality/Telepresence Personal Communication System. The targets and features available to be tracked may be defined by the manufacturer of the software or by the user using the System menus or the Interface computer in FIG. 36c. Per FIG. 36, Section a and b, Target and Feature Selection is accomplished by the user selecting what features to track using a menu or stylus to touch the images recorded by the panoramic sensor assembly. As depicted in FIG. 7, color, shape, audio signature, are examples of features typically tracked by standard target tracking software. Once the computer records these features and they are tracked using various image processing techniques such as comparison. A software or firmware program that is of a type that can be used in the present Invention to accomplish Target and Feature Selection, Acquisition, Tracking, and Reporting is manufactured by Australian company or other manufacturer already discussed. For example, as graphically illustrated in FIG. 36d, under Target and Feature Selection, Acquisition, Tracking, and Reporting, Section a and b, the user has used the System menu and selected to track the position, orientation, and heading of his head, eyes, hands, and fingers. This selection is recorded and operated on by the System computer using said application software.

As depicted in FIG. 36, Section c, the System 120 computer then operates in concert with the panoramic sensor assembly to acquire/identifies and those features of the subject, here the user of the System. As depicted in FIG. 36, Section d once identified and acquired the System tracks those features on a continuous basis as new video signals come in and are operated upon to calculate the position, orientation and heading of the users head, eyes, hands, and fingers as the subject move throughout the environment. As depicted in FIG. 36, Section e, the position, orientation, and heading information is sent to the System computer and distributed appropriately to drive other software applications. The information/data representing the position, orientation, and heading of the users head, eyes, hands, and fingers is input into the Processing portion of the System to drive the interaction and view provided to the viewer. The information may be used to drive onboard or remote system software and firmware applications. Gaming applications (FIGS. 36c and 36f, Interactive Game Control embodiment) and telepresence applications (FIG. 36c, embodiment c, FIG. S 47-51 Telecommunications embodiments) will be described in additional detail below. Other Target and Feature Selection, Acquisition, Tracking, and Reporting software or firmware of a type that can be incorporated into the processing system of the present invention includes that described in U.S. Pat. Pub. App. 2003/0052962 A1 by Wilk; manufactured by IMAGO Video Tracking Software; that marketed as Webcam Tracker software on freeware.com; by Micro Systems as the MaxVideo250 boards and ImageFlow Software; Falcon Video Tracker Software; as described in U.S. Pat. No. 5,469,536; U.S. Pat. No. 5,850,352 by Moezzi et al.; U.S. Pat. No. 6,289,165 B1 by Abecassis; and U.S. Pat. No. 6,654,019 B2 by Gilbert et al.

Referring to FIG. 36e5, Image Stitching is a fifth software or firmware application of the Panoramic Image Based Virtual Reality/Telepresence Personal Communication System. As illustrated in FIG. 36a and FIG. 36b and described above input means and processing means dynamically selectively track and report on targets and features defined by a user in the local or a remote environment. FIG. 36e, section a, graphically illustrates the sequence of video frames captured by the panoramic sensor assembly. Frames T, U, and V each represent image segments of a skier in the environment surrounding the wearer of the panoramic System. FIG. 36e, section b, graphically illustrates the stitching together of the image segments T, U, and V by computer application software or firmware of the System. FIG. 36e, section c, graphically illustrates the output of the image segments as a composite image for viewing. The image is then output for display (FIG. 36g, FIG. 36h, or FIG. 36i), recording, or further processing. An Image Stitching software or firmware application program that is of a type that can be used in the present Invention to accomplish the above task is described by Ford Oxaal of MindsEye using PictoSphere software, Inc. and related U.S. Pat. No. 5,684,937; Internet Pictures Corporation's Interactive Studio and Immersive 360 Movie's Production Software; and in U.S. Pat. No. 5,694,531 by Golin et al; and by Gilbert et al. in U.S. Pat. No. 6,323,858 B1; and by Helmet Dersch, in a freeware product called Panoramic Tools; in U.S. Pat. 2002/0063802 A1 by Gullichsen et al; and as described by the use of existing video digital video software referenced in U.S. Pat. Nos. 5,130,794 and 5,495,576 by Ritchey.

Again referring to FIG. 36e6, Image Mosaicing is a sixth software or firmware application of the Panoramic Image Based Virtual Reality/Telepresence Personal Communication System. When a group of images from the same objective lens of the Panoramic Sensor Assembly are recorded and the viewer wishes to pan portions of that scene Image Mosaicing may be used. FIG. 36e, Section a, graphically illustrates a sequence of frames of mountains and a snow skier recorded in the environment surrounding the System. FIG. 36e, section b, graphically illustrates the operation of the software or firmware to clip out and stitch portions of the image together to form a continuous scene as the user pans the environment using interactive control devices like a keyboard, mouse, stylus, head tracking system or so forth and so on. FIG. 36e, Section c, illustrates the output image as the user uses an interactive control device to pan from the skier to looking at the mountains. The image is then output for display (FIG. 36g, FIG. 36h, or FIG. 36i), recording, or further processing. An Image Mosaicing software or firmware application program that is of a type that can be used in the present Invention to accomplish the above task is Microsoft Corporation, by Szeliski et al. in U.S. Pat. No. 6,018,349; and described in U.S. Pat. Pub. App. 2003/0076406 A1 by Peleg et al.

Again referring to FIG. 36e7, Three-Dimensional (3-D) Modeling and Texture Mapping is a seventh software or firmware application of the Panoramic Image Based Virtual Reality/Telepresence Personal Communication System. FIG. 36e, Section a, graphically illustrates a sequence of frames that comprise image segments side R, S, T, U, V, W representing the composite scene surrounding the panoramic sensor assembly of the System. In this example, each segment is recorded by an associated objective lens with equal to or greater FOV coverage. FIG. 36e, Section c, graphically illustrates the operation of the application of the software or firmware to reassemble the segments adjacent to one another to form a 3-D model representing the panoramic scene. FIG. 36e, Section c depicts a viewer selected portion of the model being output after this application is applied. The image is output for display (FIG. 36g, FIG. 36h, or FIG. 36i), recording, or further processing. Three-Dimensional Modeling and Texture Mapping software or firmware application programs that are of a type that can be used in the present Invention to accomplish the above task is IPIX and Ford Oxaal and Ritchey's U.S. Pats. '794 and '576 referenced above (when using input means FIG. 36a, embodiment a) and iMove Inc. streaming panoramic video software and Ritchey's U.S. Pats. '794 and '576 referenced above (when using input means FIG. 36b, embodiment b), and in U.S. Pat. 2002/0063802 A1 by Gullichsen et al.

Referring to FIG. 36f8, Augmented Reality is a eighth software or firmware application of the Panoramic Image Based Virtual Reality/Telepresence Personal Communication System. Besides placing System control and application menus over a background of the surrounding environment as described in the first application software and firmware instance in FIG. 36a, other instances are possible. FIG. 36f, Section a, graphically illustrates a sequence of frames that have been recorded by the panoramic sensor assembly 10 of the unit 120 or 122. The subject in the frames is the user. The users location is tracked as described above using another, but related, software or firmware application. Based on the position, orientation, and heading of the user the system selects predetermined objects stored in a computer database. The objects, here a certain cowboy hat, is positioned on the user so he can decide if he wants to purchase the cowboy hat from a vendor. The object database depicted graphically in FIG. 36f, section b, may be stored on media as part of the computer system portion of the System worn by the user, or may be transmitted to him from a remote computer server that is located remotely that is part of the System that is not worn by the user. If a server will typically be part of a telecommunications network that forms a Local Area Network (LAN), Campus Area Network (CAN), or Wide Area Network (WAN) typical to the computer and telecommunication industry. The System 120 or 122 worn by the user receives the augmented video signal via the wireless data and video transceiver worn or carried (cell phone/palm top/laptop) by the user.

Augmented Reality (AR) software of a type incorporated for use in the present invention is Studierstube, from Germany, which is a windows based software package that operates on an personal computer architecture, like that on a conventional laptop. It provides a user interface management system for AR based on but not limited to stereoscopic 3-D graphics. It provides a multi-user, multi-application environment together with 3-D window equivalents, 3-D widgets, an supports different display devices such as HMDs, projection walls and workbenches. It also provices the means of interaction, either with the objects or with user interface elements registered with the pad. The Studierstube software also supports the sharing and migration of applications between different host units/terminals 120 or 122 or servers sharing different users.

The inputs of the different tracking devices are preferably processed by trackers associated with the panoramic sensor assembly 10 of the present invention, but others are also feasible. The devices are linked to the Augmented reality software. The software receives data about the users head orientation from the sensor 10 to provice a coordinate system that is positionally body stabilized and oreintationly world stabilized. Within this coordinate system the pehn and pad are tracked using the panoramic sensor assembly 10 mounted on the HMD, cell phone, and ARToolKit to process the video information.

The information may be used to drive onboard or remote system software and firmware applications. Augmented Reality software may be used for interactive gaming, educational, medical assistance and telepresence, just to name a few applications. Gaming applications (FIGS. 36c and 36f, Interactive Game Control embodiment) and telepresence applications (FIG. 36c, embodiment c, FIG. S 47-51 Telecommunications embodiments) will be described in additional detail below.

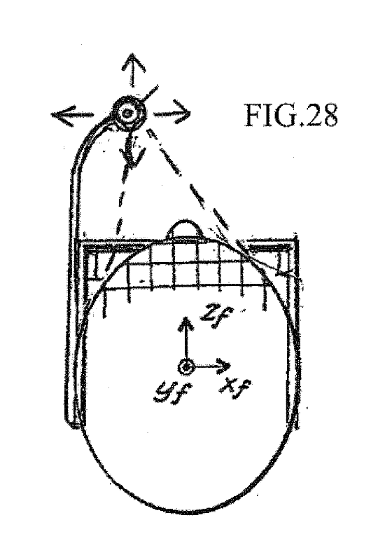

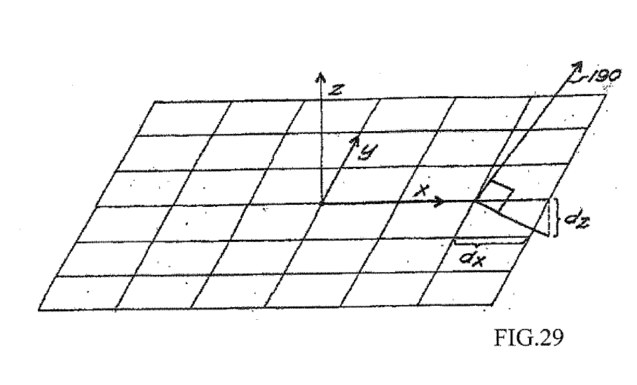

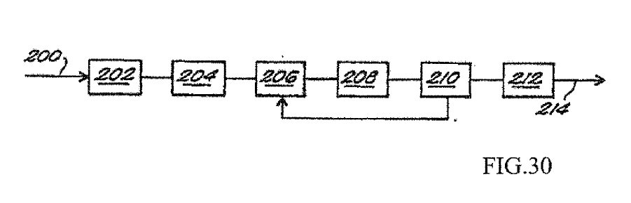

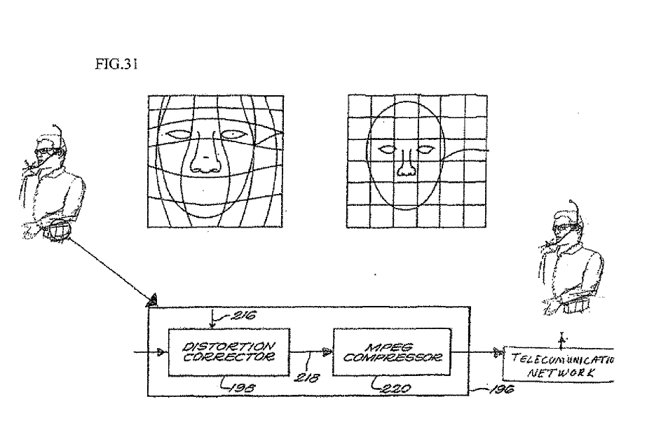

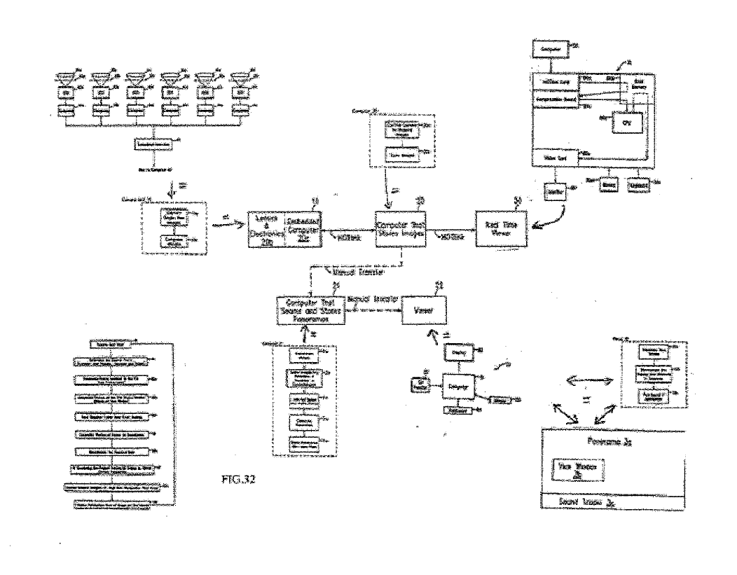

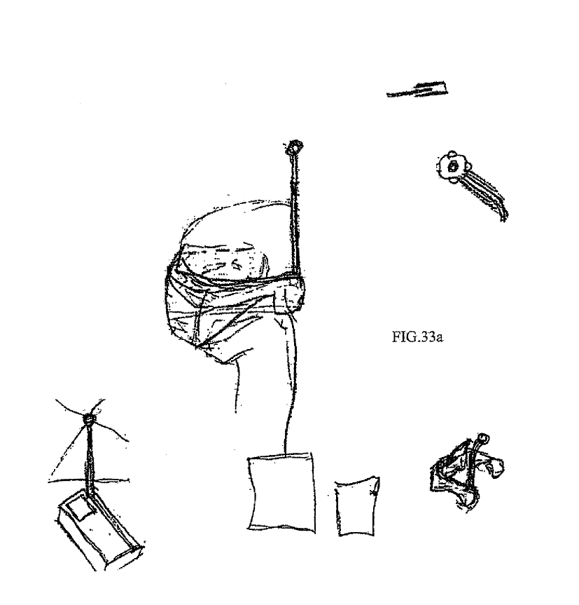

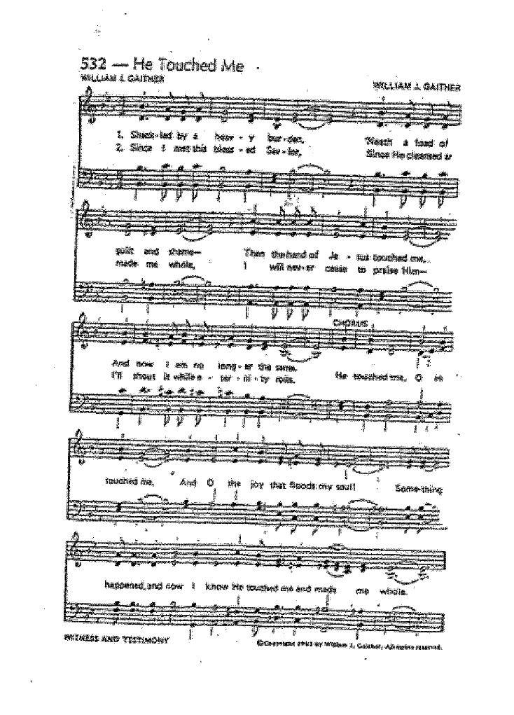

Again referring to FIG. 36f9, Perspective Correction is a ninth software or firmware application of the Panoramic Image Based Virtual Reality/Telepresence Personal Communication System. FIG. 36f, section a, graphically illustrates a sequence of frames of a users face that have been recorded by the panoramic sensor assembly of the System. The users face in the frame has perspective distortion because of the location of the sensor. FIG. 36f, section b, illustrates the same sequence of frames in which the application of the software or firmware to remove or reduce the distortion using mathematical equations and algorithms applied to each image of the image sequence. Each image is then output for display (FIG. 36g, FIG. 36h, or FIG. 36i), recording, or further processing. A perspective correction software or firmware application program that is of a type that is integrated in the present Invention is described in U.S. Pat. No. 6,211,903 by Bullister described in FIGS. 28-31; in U.S. Pat. 2002/0063802 A1 by Gullichsen et al; or the software used in U.S. Pat. No. 6,654,019 by Gilbert et al. to perspectively correct views.

Again referring to FIG. 36f10, Distortion Correction is a tenth software or firmware application of the Panoramic Image Based Virtual Reality/Telepresence Personal Communication System. FIG. 36f, section a, graphically illustrates a sequence of frames of a users face that have been recorded by the panoramic sensor assembly of the System.

The users face in the frame has barrel distortion because of the optical sensor is fisheye lens. FIG. 36f, section b, illustrates the same sequence of frames in which the application of the software or firmware to remove or reduce the barrel/fisheye distortion by using mathematical equations and algorithms applied to each image of the image sequence. Each image is then output for display (FIG. 36g, FIG. 36h, or FIG. 36i), recording, or further processing. Distortion correction software or firmware application program that are of a type that is integrated in the present Invention is described in image manipulation and viewing software/firmware by Ford Oxaal of MindsEye using PictoSphere software, Inc. and related U.S. Pat. No. 5,684,937; Internet Pictures Corporation's Interactive Studio and Immersive 360 Movie's Production Software; and in U.S. Pat. No. 5,694,531 by Golin et al; and by Helmet Dersch, of Germany, in a freeware product called Panoramic Tools; Richardson et al. in U.S. Pat. No. 5,489,940; Travers et al. in U.S. Pat. 2002/0190987 A1; as described by the use of existing video digital video software referenced in U.S. Pat. Nos. 5,130,794 and 5,495,576 by Ritchey; or in U.S. Pat. 2002/0063802 A1 by Gullichsen et al;

Again referring to FIG. 36f11, Interactive Game Control is a eleventh software or firmware application of the Panoramic Image Based Virtual Reality/Telepresence Personal Communication System. As illustrated in FIG. 36d, FIG. 46, and described above the input means and processing means may be used to dynamically and selectively track and report on targets and features defined by a user in an onboard game or a remote game interacted with on the telecommunications network. The game program may be set up for using certain predetermined input devices. Preferrably the input device is the panoramic sensor assembly depicted in FIG. 46. FIG. 36d, section a, describes Target and Feature Selection, Acquisition, Tracking, and Reporting a software or firmware application of the Panoramic Image Based Virtual Reality/Telepresence Personal Communication System for use in deriving head, eye, hand, finger, and other body information for defining the interaction and displayed scene for interactive gaming. Once that operation is accomplished the body position information is used to drive the interactive game. For example, in FIG. 36b an avatar representing the user and the users actions provided by the body coordinate system is located at the center of the game environment which surrounds the user. The computer calculates all inputs and interactions and effects the game in an appropriate manner. When the user points and curves a certain finger the position is sensed by the System and a laser beam is fired at an alien space ship. If the top finger is pointed in the general direction of the space ship, the space ship explodes. It's OK, these are bad aliens, and not to be confused with the second coming of Christ. FIG. 36c graphically depicts the scene output to the display means (including audio output) which the viewer is using to help him or her interact with the game environment. Interactive games of a type for use with the present system include numerous 3-D/panoramic games listed at www.mindflux.com and 3-D movies listed at www.i-glasses.com/store/imax2.

Referring to FIG. 36g, FIG. 36h, and FIG. 36i, the display means hardware preferably consists of a small compact portable active display that is worn or held by a user. The display system includes means for powering the display by electrical means, and includes means for receiving a video signal. The display means consists of a computer driven display device that receives digital or analog signals output from the processing means. Display devices may include Cathode Ray Tubes (CRTs), Liquid Crystal Display, LED, and other standard display devices. Some display means are projection display systems. The display signal(s) are sent from remote and associated networks or the video display signal(s) are transmitted from the wearers/users onboard processing means. As depicted in FIG. 36c and FIG. 36e, embodiment c, the Wireless Transceiver in FIG. 36b transmits a video and/or data signal to the display system. The display means can receive prerecorded information or live information from remote computers (including interface computers) or from the onboard computer system being held or worn. Wireless transceiver of a type that is suitable for incorporation into embodiments of the present invention that is capable of transmitting and receiving data and video have been described above and are incorporated in a similar manner in this embodiment.

Some of the display means have been described above in order to facilitate the cohesion of the disclosure of the primary embodiments A and B of the system so that discussion will not be repeated for the sake of efficiency. But it will be clear to those skilled in the art that discussions on display systems are transferable and applicable to the more detailed and additional discussion below concerning display means.

FIG. 36g, section a and b is a schematic diagram illustrating examples of wearable panoramic projection communication display means according the present invention. A first embodiment at the top of the page of FIG. 36g, Section a, of the drawing shows components of an projection phone integrated into a cell phone. In operation the system works just the opposite as the input means shown in FIG. 36a embodiment a. Instead of collecting images on a CCD, the CCD is replaced with a LCD projection display that outputs images through an SLM LCD shutter, micro-lens array, through fiber optic image conduits and projection lenses facing outward in a panoramic manner. In FIG. 36g, section b the viewer incorporates a keyboard, mouse, position sensing system or other means well know means to define the image projected. In this way the viewer can selectively look at a panoramic scene in it's proper orientation if he or she so chooses. The image is projected on the interior spherical surface of the surrounding room. It should be noted that the projection lenses and processing of the projected image can be adjusted to provide the proper perspective no matter what the interior shape of the room is. A video projection system that is integrated with a cellular phone that may be adapted to the present invention is disclosed by Williams in U.S. Pat. App. Pub. 2002/0063855 A1. While Williams system is wireless and portable, the system may be implemented in a non-portable fashion and connected by wires or cables common for connecting a computer to video projector in the present invention.

A second embodiment at the bottom of the page of FIG. 36g, Section a and b, of the drawing shows a video cellular phone with an integrated projector. The video cellular phone includes a transceiver for receiving video. The projector has one projection lens. In FIG. 36g, section b the viewer incorporates a keyboard, mouse, position sensing system or other means well know means to define the image projector. In this way the viewer can selectively look pan the panoramic scene. In the preferred embodiment, the projector is incorporated into the top of a cowboy hat, section c, and the projector faces to the viewer's front. As shown in section d of the drawing the image is projected on the floor, wall, and ceiling surface of the surrounding room as the viewer faces different directions. In this embodiment the projector projects the scene in it's proper orientation as the viewer faces a direction of the projection. In the preferred embodiment the system worn by the viewer include a position sensing system that defines the corresponding image to the direction the user is looking. Wireless position sensors are well known to those skilled in the art. It should also be noted that the projection can provide an augmented reality that is a projected image over an object. A video projection system that is integrated with a cellular phone that may be adapted to the present invention is the described by Williams in U.S. Pat. App. Pub. 2002/0063855 A1. While Williams system is wireless and portable, the system may also be implemented in a non-portable fashion and connected by wires or cables common for connecting a computer to video projector in the present invention.

FIG. 36h is a schematic diagram illustrating wearable portable head-mounted and portable panoramic communication display means according to the present invention.

At the top of the page, in FIG. 36h, sections a-e, show wearable portable wireless head-mounted communication devices already described in the present invention that can receive panoramic imagery for display. These system may incorporate see-through displays referenced earlier.

At the bottom of the page, in FIG. 36h, sections a-c, show wearable portable wireless hand-held communication devices already described in the present invention that can receive panoramic imagery for display.

FIG. 36i is a schematic diagram illustrating prior art display means that are compatible with the present invention. As FIG. 36i, section a-e, at the top of the page illustrate, this includes desktop, laptop, set-top box, PDA, video cellular phones and tethered head mounted displays that do not have an integrated panoramic sensor assembly for recording panoramic video, but that can receive panoramic video and interact with it. These systems may or may not include wireless capabilities. Devices capable of

As FIG. 36i, section a-b, at the bottom of the page, audio-visual signals from the Panoramic Image Based Virtual Reality/Telepresence Personal Communication System can also be projected in the prior art CAVE, VideoRoom™, and RealityRoom™ systems. A room type system compatible with the present invention is manufactured by Fakespace Systems Inc., Marshalltown, Iowa as the “C6” CAVE of. Room-type virtual reality/telepresence rooms in U.S. Pat. Nos. 5,130,794 and 5,495,576 may receive images from terminal/unit 120 or 122 for projection in the systems by the inventor of the present system.

FIGS. 47-51 illustrate how the panoramic image based virtual reality/telepresence system functions as a personal communication system 100 and method.

Communication systems 100, such as land mobile radio and cellular communications systems 100, are well known. Such systems typically include a plurality of radio communication units 120 or 122 (e.g., vehicle-mounted mobiles or portable radios in a land mobile system and radio/telephones in a cellular system); one or more repeaters; and dispatch consoles that allow an operator or computer to control, monitor or communicate on multiple communication resources.

Typically, the repeaters are located at various repeater sites and the consoles at a console site. The repeater and console sites are typically connected to other fixed portions of the system (i.e., the infrastructure) via wire connections, whereas the repeaters communicate with communication units and/or other repeaters within the coverage area of their respective sites via a wireless link. That is, the repeaters transceiver information via radio frequency (RF) communication resources, typically comprising voice and/or data resources such as, for example, narrow band frequency modulated channels, time division modulated slots, carrier frequencies, frequency pairs, etc. that support wireless communications within their respective sites.

Communication systems 100 may be organized as trunked systems, where a plurality of communication resources is allocated amongst multiple users by assigning the repeaters within an RF coverage area on a communication-by-communication basis, or as conventional (non-trunked) radio systems where communication resources are dedicated to one or more users or groups. In trunked systems, there is usually provided a central controller (sometimes called a “zone controller”) for allocating communication resources among multiple sites. The central controller may reside within a fixed equipment site or may be distributed among the repeater or console sites.

Communication systems 100 may also be classified as circuit-switched or packet-switched, referring to the way data is communicated between endpoints.

Historically, radio communication systems have used circuit-switched architectures, where each endpoint (e.g., repeater and console sites) is linked, through dedicated or on-demand circuits, to a central radio system switching point, or “central switch.” The circuits providing connectivity to the central switch require a dedicated wire for each endpoint whether or not the endpoint is participating in a particular call. More recently, communication systems are beginning to use packet-switched networks using the Internet Protocol (IP). In packet-switched networks, the data that is to be transported between endpoints (or “hosts” in IP terminology) is divided into IP packets called datagrams. The datagrams include addressing information (e.g., source and destination addresses) that enables various routers forming an IP network to route the packets to the specified destination. The destination addresses may identify a particular host or may comprise an IP multicast address shared by a group of hosts. In either case, the Internet Protocol provides for reassembly of datagrams once they reach the destination address. Packet-switched networks are considered to be more efficient than circuit-switched networks because they permit communications between multiple endpoints to proceed concurrently over shared paths or connections.

Because packet-based communication systems 100 offer several advantages relative to traditional circuit-switched networks, there is a continuing need to develop and/or refine packet-based communication architectures. Historically, however, particularly for packet-based radio and cellular communications systems, the endpoints or “hosts” of the IP network comprise repeaters or consoles. Thus, the IP network does not extend across the wireless link(s) to the various communication units. Existing protocols used in IP transport networks such as, for example, H.323, SIP, RTP, UDP and TCP neither address the issue nor provide the functionality needed for sending multimedia data (particularly time-critical, high-frame-rate streaming voice and video) over the wireless link(s). Thus, any packets that are to be routed to the communication units must be tunneled across the wireless link(s) using dedicated bandwidth and existing wireless protocols such as the APCO-25 standard (developed by the U.S. Association of Public Safety Communications Officers (APCO)) or the TETRA standard (developed by the European Telecommunications Standards Institute (ETSI)). Until recently, none of these protocols are sufficiently able to accommodate the high speed throughput of packet data that is needed to fully support multimedia communications. However, recent internet wideband cellular services allow for panoramic and three-dimensional content to be transmitted over the internet when it is broken down in to manageable video/image sub-segments using the systems/devices/and methods described in the present invention.

Accordingly, there is a need for a panoramic communication system that extends packet transport service across the wireless link(s), or stated differently, that extends IP “host” functionality to wireless communication units so as not to require dedicated bandwidth between endpoints. Advantageously, the communication system and protocol will support high-speed throughput of packet data, including but not limited to panoramic streaming voice and video over the wireless link. The present invention is directed to addressing these needs. The following describes a panoramic communication system that extends packet transport service over both wireline and wireless link(s). The communication system supports high-speed throughput of packet data, including but not limited to streaming voice and video between IP host devices including but not limited to wireless communication units 120 or 122. A packet-based, multimedia communication system that is of the type required and is integrated to support Panoramic Image Based Virtual Reality/Telepresence Personal Communication is described by Dertz et al. in U.S. Patent Application Publication 2002/0093948 A1 dated Jul. 18, 2002.

FIG. 47 is a block diagram of a packet based multimedia communications system that facilitates transmission of panoramic video, three-dimensional content, and three-dimensional position, orientation, and heading data content over a wireless network according to the present invention. Turning now to the drawings and referring initially to FIG. 1, there is shown a packet-based multimedia communication system (“network”) 100 comprising a repeater site 102, console site 104 and core equipment site 106 having associated routers 108 interconnected by T1 links 110. Alternatively, the T1 links may be replaced or used in combination with T3 links, optical links, or virtually any type of link adapted for digital communications. The repeater site 102 includes a repeater 112 and antenna 114 that is coupled, via wireless communication resources 116 with panoramic communication units 120, 122 within its geographic coverage area. The console site 104 includes a dispatch console 124. As shown, the dispatch console 124 is a wireline console. However, it will be appreciated that the console may be a wireless or wireline console. The core equipment site 106 includes a gatekeeper 126, web server 128, video server 130 and IP Gateway 132. The devices of the core equipment site 106 will be described in greater detail hereinafter. As will be appreciated, the packet-based multimedia communication system 100 may include multiple repeater sites, console sites and/or core equipment sites, having fewer or greater numbers of equipment, having fewer or greater numbers of routers or communication units or having equipment distributed among the sites in a different manner than shown in FIG. 47.

Systems and methods are disclosed herein including the service controller managing a call request for a panoramic video/audio call; the panoramic multimedia content server accommodating a request for panoramic multimedia information (e.g., web browsing or video playback request); the bandwidth manager accommodating a request for a reservation of bandwidth to support a panoramic video/audio call; execution of a panoramic two-way video calls, panoramic video playback calls, and panoramic web browsing requests. The present invention extends communication system that extends the usefulness of packet transport service over both wireline and wireless link(s). Adapting existing and new communication systems to handle panoramic and three-dimensional content according to the present invention supports high-speed throughput of packet data, including but not limited to streaming voice and video between IP host devices including but not limited to wireless communication units. In this manner the wireless panoramic personal communications systems/terminals described in the present invention may be integrated into/overlaid onto any conventional video capable telecommunications system.

In one embodiment of the integrated telecommunication system the panoramic communication units 120, 122 comprise wireless radio terminals that are equipped for one-way or two-way communication of IP datagrams associated with multimedia calls (e.g., voice, data and/or video, including but not limited to high-speed streaming voice and video) singly or simultaneously with other hosts in the communication system 100. In such case, the communication units 120, 122 include the necessary call control, voice and video coding, and user interface needed to make and receive multimedia calls.

In another embodiment of the integrated telecommunication system the repeater 112, panoramic communication units 120, 122, routers 108, dispatch console 124, gatekeeper 126, web server 128, video server 130 and IP Gateway 132 all comprise IP host devices that are able to send and receive IP datagrams between other host devices of the network. For convenience, the communication units 120, 122 will be referred to as “wireless terminals.” As will be appreciated and has been described above in FIG. 36a through FIG. 36i, the panoramic wireless terminals may also include wireless consoles or other types of wireless devices. All other host devices of FIG. 1 will be referred to as “fixed equipment” host devices. Each host device has a unique IP address. The host devices include respective processors (which may comprise, for example, microprocessors, microcontrollers, digital signal processors or combination of such devices) and memory (which may comprise, for example, volatile or nonvolatile digital storage devices or combination of such devices).

In another embodiment of the integrated telecommunication system the fixed equipment host devices at the respective sites are connected to their associated routers 108 via wireline connections (e.g., Ethernet links 134) and the routers themselves are also connected by wireline connections (e.g., T1 links). These wireline connections thus comprise a wireline packet switched infrastructure (“packet network”) 136 for routing IP

datagrams between the fixed equipment host devices. One of the unique aspects of the example telecommunications system is the extension of IP host functionality to the panoramic wireless host devices (e.g., the panoramic communication units 120, 122) over a wireless link (i.e., the wireless communication resource 116). For convenience, the term “wireless packet network” will hereinafter define a packet network that extends over at least one wireless link to a wireless host device as described herein.

The wireless communication resource 116 may comprise multiple RF (radio frequency) channels such as pairs of frequency carriers, code division multiple access (CDMA) channels, or any other RF transmission media. The repeater 112 is used to generate and/or control the wireless communication resource 116. In one embodiment, the wireless communication resource 116 comprises time division multiple access (TDMA) slots that are shared by devices receiving and/or transmitting over the wireless link. IP datagrams transmitted across the wireless link can be split among multiple slots by the transmitting device and reassembled by the receiving device. In the preferred input embodiment A or B transmitted datagrams will transmit panoramic video and three-dimensional content and three-dimensional position, orientation, and heading data.

In another embodiment, the repeater 112 performs a wireless link manager function and a base station function. The wireless link manager sends and receives datagrams over the wireline network 136, segments and formats datagrams for transmission over the wireless link 116, prioritizes data for transmission over the wireless link 116 and controls access of the wireless terminals 120, 122 to the wireless link 116. In one embodiment, the latter function is accomplished by the wireless link manager allocating “assignments” granting permission for the wireless terminals to send messages over the wireless link.

The assignments may comprise either “Non-Reserved Assignment(s)” or “Reserved Assignments,” each of which is described in greater detail in related application referenced as [docket no. CM04761H] to the Detz et al, 2002/0093948 A1 application. The base station sends and receives radio signals over the wireless link 116. Multiple base stations can be attached to a single wireless link manager.

In a related application to the Detz et al, 2002/0093948 referenced [docket no. CM04762H] discloses a slot structure that supports the transmission of multiple types of data over the wireless link 116 and allows the packets of data to be segmented to fit within TDMA slots. It also provides for different acknowledgement requirements to accommodate different types of service having different tolerance for delays and errors. For example, a voice call between two wireless terminals A, 120 and B, 122, can tolerate only small delays but may be able to tolerate a certain number of errors without noticeably effecting voice quality. However, a data transfer between two computers may require error-free transmission but delay may be tolerated.

Advantageously, the slot format and acknowledgement method may be implemented in the present invention to transmit delay-intolerant packets on a priority basis without acknowledgements, while transmitting error-intolerant packets at a lower priority but requiring acknowledgements and retransmission of the packets when necessary to reduce or eliminate errors. The acknowledgement technique may be asymmetric on the uplink (i.e., wireless terminal to repeater) and downlink (i.e., repeater to wireless terminal) of the wireless link 116. The routers 108 of the wireline portion of the network are specialized or general purpose computing devices configured to receive IP packets or datagrams from a particular host in the communication system 100 and relay the packets to another router or another host in the communication system 100. The routers 108 respond to addressing information in the IP packets received to properly route the packets to their intended destination. In accordance with internet protocol, the IP packets may be designated for unicast or multicast communication. Unicast is communication between a single sender and a single receiver over the network.

Multicast is communication between a single sender and multiple receivers on a network. Each type of data communication is controlled and indicated by the addressing information included in the packets of data transmitted in the communication system 100. For a unicast message, the address of the packet indicates a single receiver. For a multicast communication, the address of the packet indicates a multicast group address to which multiple hosts may join to receive the multicast communication. In such case, the routers of the network replicate the packets, as necessary, and route the packets to the designated hosts via the multicast group address. In this way one user of the panoramic communication units 120, 122 described in FIG. 36a through FIG. 36i to interact in a unicast or multi-cast manner.

The wireless packet network is adapted to transport IP packets or datagrams between two or more hosts in the communication system 100, via wireless and/or wireline links. In a preferred embodiment, the wireless packet network will support multimedia communication, including but not limited to high-speed streaming voice and video so as to provide the hosts of the communication system 100 with access to voice, video, web browsing, video-conferencing and internet applications. As will be appreciated, depending on which host devices are participating in a call, IP packets may be transported in the wireless packet network over wireline portions, wireless portions or both wireline and wireless portions of the network. For example, IP packets that are to be communicated between fixed equipment host devices (e.g., between console 124 and gatekeeper 126) will be routed across only wireline links, and IP packets that are communicated between fixed equipment host devices and wireless communication devices are transported across both wireline and wireless links.

Those packets that are to be communicated between wireless terminals (e.g., between panoramic communication units 120, 122) may be transported across only wireless links, or wireless and wireline links, depending on the mode of operation of the communication system 100. For example, in site trunking mode, packets might be sent from communication unit 120 to repeater site 102 via wireless link 116, to router 108 via Ethernet 134, back to the repeater site 102 and then to communication unit 122 via wireless link 118. In a direct mode, sometimes referred to as “talk around” mode, packets may be sent between the panoramic communication units 120, 122 directly via a wireless link. In either case, the wireless packet network of the present invention is adapted to support multimedia communication, including but not limited to high-speed streaming of panoramic voice and video so as to provide the host devices with access to panoramic audio, video, web browsing, video-conferencing and internet applications.

Microphones on the panoramic sensor assembly, just like objective lenses, are associated with certain set regions on the housing to enable reconstruction of imagery for panning a scene or reconstructing a scene. The software/firmware described in FIG. 36d through FIG. 36f are operated upon by computer processors to manipulate the incoming audio and output the scene in it's proper orientation In this way, look up tables in the software/firmware application program define what audio is associated with what microphones and what imagery is associated with what objective lenses in performing adjacent and overlapping reconstruction of the virtual scene. Once determined the portion or portions of the audio and imagery can be presented to the viewer in their proper spatial orientation. Software capable of performing this is manufactured by Sense8 under the title World Modeler. Three dimensional coordinates provided by various input devices, such as the panoramic sensor assembly being operated to run target/feature tracking software/firmware can be used to provide viewer position, orientation, and heading data to drive the output audio and/or imagery in a three-dimensional manner. Panoramic audio systems that can record three-dimensional audio of a type that may be integrated into the present invention have been discussed and are referenced here.

Practitioners skilled in the art will appreciate that the communication system 100 may include various other communication devices not shown in FIG. 47.

For example, the communication system 100 may include comparator(s), telephone interconnect device(s), internet protocol telephony device(s), call logger(s), scanner(s) and gateway(s). Generally, any of such communication devices may comprise wireless or fixed equipment host devices that are capable of sending or receiving IP datagrams routed through the communication system 100. Now referring to the core equipment site 106, the gatekeeper 126, web server 128, video server 130 and IP Gateway 132 will be described in greater detail. Generally, the gatekeeper 126, web server 128, video server 130 and IP

Gateway 132 operate either singly or in combination to control audio and/or video calls, streaming media, web traffic and other IP datagrams that are to be transported over a wireless portion of the communication system 100. In one embodiment, the gatekeeper 126, web server 128 and video server 130 are functional elements contained within a single device, designated in FIG. 47 by the dashed bubble 140. It will be appreciated, however, that the gatekeeper 126, web server 128 and/or video server 130 functions may be distributed among separate devices.

According to one embodiment of the present invention, the gatekeeper 126 authorizes all video and/or audio calls between host devices within the communication system 100. The audio and/or video may be of a spatial, three-dimensional or panoramic nature as described above. For convenience, the term “video/audio calls” in include spatial audio and video data and will be used herein to denote video and/or audio calls, whether or not they are panoramic, as either can be accommodated. The video/audio calls that must be registered with the gatekeeper are one of three types: video only, audio only, or combination audio and video. Calls of either type can be two-way, one-way (push), one-way (pull), or a combination of one-way and two-way. Two-way calls define calls between two host devices wherein host devices sends audio and/or video to each other in full duplex fashion, thus providing simultaneous communication capability. One-way push calls define calls in which audio and/or video is routed from a source device to a destination device, typically in response to a request by the source device (or generally, by any requesting device other than the destination device). The audio and/or video is “pushed” in the sense that communication of the audio and/or video to the destination device is initiated by a device other than the destination device. Conversely, one-way pull calls define calls in which audio and/or video is routed from a source device to a destination device in response to a request initiated by the destination device.

In one embodiment, any communication between host devices other than video/audio calls including, for example, control signaling or data traffic (e.g., web browsing, file transfers) may proceed without registering with the gatekeeper 126. As has been noted, the host devices may comprise wireless devices (e.g., panoramic communication units 120, 122) or fixed equipment devices (e.g., repeater 112, routers 108, console 124, gatekeeper 126, web server 128, video server 130 and IP Gateway 132).

For video/audio calls, the gatekeeper 126 determines, cooperatively with the host device(s), the type of transport service and bandwidth needed to support the panoramic or three-dimensional content call. In one embodiment, for example, this is accomplished by the gatekeeper exchanging control signaling messages with both the source and destination device. If the call is to be routed over a wireless link, the gatekeeper determines the RF resources 116 needed to support the call and reserves those resources with the wireless link manager (a functional element of repeater 112). The gatekeeper 126 further monitors the status of active calls and terminates a call, for example when it determines that the source and/or recipient devices are no longer participating in the call or when error conditions in the system necessitate terminating the call. The wireless link manager receives service reservation commands or requests from the gatekeeper and determines the proper combination of error correction techniques, reserved RF bandwidth and wireless media access controls to support the requested service. The base station is able to service several simultaneous service reservations while sending and receiving other IP traffic between the panoramiccommunication units 120, 122 and host device(s) over the wireless link 116.

The web server 128 provides access to the management functions of the gatekeeper 126. In one embodiment, the web server 128 also hosts the selection of video clips, via selected web pages, by a host device and provides the selected streaming video to the video server 130. The video server 130 interfaces with the web server 128 and gatekeeper 126 to provide stored streaming video information to requesting host devices. For convenience, the combination of web server 128 and video server 130 will be referred to as a multimedia content server 128, 130. The multimedia content server 128, 130 may be embodied within a single device 140 or distributed among separate devices.

The IP gateway 132 provides typical firewall security services for the communication system 100. As previously discussed the web server and video server may be equipped with software for storing, manipulation, and transmitting spatial 3-D or panoramic content. The spatial content may be in the form of video, game, or 3-D web browsing content. The server may be programmed to continuously receive and respond instantaneously to commands from the user of a user of a panoramic communication unit handheld or worn 120, 122 device.

The present invention contemplates that the source and/or panoramic destination devices 120, 122 may be authorized for certain services and not authorized for others.

If the service controller determines that the source and destination devices are authorized for service at steps 204, 206 and that the destination device is in service at step 208, the service controller requests a reservation of bandwidth to support the call at step 210. In one embodiment, this comprises the service controller sending a request for a reservation of bandwidth to the bandwidth manager. In one embodiment, the service controller may also request a modification or update to an already-granted reservation of bandwidth. For example, the service controller might dynamically scale video bitrates of active calls depending on system load.

Examples of various types of communication supportable by the communication system 100 that is adapted and integrated with the panoramic capable communication terminals/units 120, 122 are described in FIGS. 48-51. Examples of various types of communication supportable by the communication system 100 that is adapted and panoramic and three-dimensional video and other spatial content in the present invention is also shown in FIGS. 48-51. More specifically, FIGS. 48-51 are message sequence charts showing examples, respectively, of a two-way panoramic or 3-D video call between panoramic capable communication terminals; panoramic or 3-D video playback from the multimedia content server to a requesting panoramic capable communication terminal; panoramic or 3-D video playback from the multimedia content server to a destination panoramic capable communication terminal (requested by another wireless terminal); and panoramic or 3-D playback of web-browsing content to a requesting panoramic capable communication terminal. As will be appreciated, however, the communication system of the present invention will support additional and/or different types of communication, including communication with different requesting, source or destination devices/panoramic communication units 120, 122 than the examples shown in FIGS. 48-51, which have been described in earlier parts of the specification.

It should be noted that the message sequence charts of FIGS. 48-51 use arrows to denote the communication of messages between various host devices of a wireless packet network communication system. However, the arrows do not imply direct communication of the messages between the indicated host devices. On the contrary, many of the messages are communicated between host devices indirectly, through one or more intermediate devices (e.g., routers). For convenience, these intermediate messages are not shown in FIGS. 48-51.

FIG. 48 is a message sequence chart associated with an embodiment of a two-way panoramic video call supported by a packet-based multimedia communication system according to the present invention. (ref. US 2002/0093948, FIG. 7).

As has been noted, the communication system 100 of the present invention is adapted to support several different types of communication between host devices, including panoramic audio and/or video calls requiring registration with the gatekeeper (i.e., the service controller function of the gatekeeper) and communication other than audio and/or video calls (e.g., control signaling, data traffic (including web browsing, file transfers, and (position, orientation, and heading data) that may proceed without registering with the gatekeeper 126. Moreover, as has been noted, the sources and recipients of the different types of communication may comprise wireless panoramic devices and/or fixed panoramic equipment devices.

Referring initially to FIG. 48, there is shown a message sequence chart associated with a two-way video call between panoramic capable wireless terminals 120, 122 (“Wireless Terminal A” and “Wireless Terminal B”) located at different sites. The message sequence of FIG. 48 begins with the user of Wireless Terminal A (“Wireless User A”) initiating a video call by sending Video Call Setup signal(s) 702 to Wireless Terminal A. In one embodiment, the Video Call Setup signal(s) 702 identify the type of call and the destination, or second party for the call. Thus, in the present example, the Video Call Setup signal(s) 702 identify the call as a two-way video call and Wireless User B as the destination, or second party for the call. As will be appreciated, the mechanism for entering the Video Call Setup signal(s) 702 will depend on the features and functionality of the wireless terminal(s), and may differ from terminal to terminal.

In the current example the wireless terminals comprise wireless head mounted worn by user A and wrist mounted panoramic communication systems worn by user B according to the present invention. The panoramic communications terminals A and B include a panoramic sensor assembly for recording multi-media signals representing the surrounding environment. The resulting signals are processed and selectively transmitted to a remote user for viewing. Data derived from the panoramic sensor assembly may also be used to define the content viewed. For example, head position, orientation, and heading data and eye gaze data of User A might be derived and transmitted to User B. User B would then use the data to send corresponding imagery to A based on that point of view and gaze data. In this way User A would be slaved to wherever User B looked at his or her remote location.

If all permissions are left open by Terminal A and Terminal B user, the users may immerse themselves in what each other see in their respective environments. Alternatively, viewer A may restrict viewer B to what he or she sees, or visa versa. Still alternatively, viewers A and B may agree to push and pull rules of their respective scenes. Viewer A may select to see thru his visor at the real world, if it has see a thru type, and transmit the sensed world recorded to User B. Or alternatively, user A may select to use his active viewfinder display to view the image he is sending to user B. Still alternatively, User A could view the processed image he is transmitting to User B in one eye, and view the real world in the other eye. Within these instances, users may define what is acquired, tracked, and reported on using menus discussed previously in the processing section of this invention. For instance, user A could select from the menu to just send image segments of his face to user B. And User A, who has just gotten out of the shower, being modest, could just allow user B to see everything in the environment except her body by using menu selections. Still alternatively, just to be safe, she might just allow audio to be sent and no imagery using the menu selections. The wireless terminals may include other interaction devices besides the optical sensor assembly, for example, magnetic position sensors, datagloves, gesture recognition systems, voice recognitions systems, keypads, touchscreens, menu options, etc. that permit the user to select the type and rules of call and the second party for the call. Positional data and commands can be sent in packets just like the video information. Full duplex communication allows for the transmission and receival of information is a simultaneous manner between user terminal A and B. The second party may be identified by user identification number, telephone number or any suitable means of identification.

Finally, it should be understood that one-way push or pull calls between a User A and User B are possible if two-way calls are possible, as they are even less demanding.

If authorization is received for the call, the multimedia content server sets up a one-way video call. Permissions and software and hardware to allow a panoramic or three-dimensional content distribution and interaction is set up between the multimedia content server and the destination device/users wireless panoramic/3-D panoramic communication units/unit 120. The one-way video call may comprise a video-only, or combination video and audio call. In one embodiment, setting up the video call comprises the multimedia content server negotiating terms of the video call with the destination device. For example, the multimedia content server and destination device might negotiate the type of audio, vocoder type, video coder type and/or bit rate to

be used for the call. After setting up the call, the multimedia content server retrieves video information (i.e., from memory or from a web site link) associated with the call and sends the video information to the requesting device (or destination device, if different than the requesting device) until the call ends.

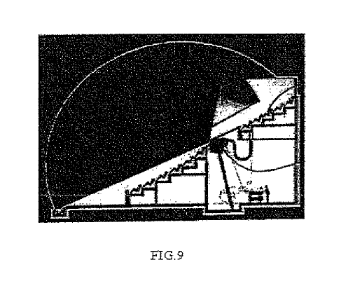

FIG. 49 is a message sequence chart associated with an embodiment of a one-way panoramic video playback call supported by a packet-based multimedia communication system according to the present invention. (ref. US 2002/0093948, FIG. 8) FIG. 49, describes a message sequence associated with a video playback request. In one embodiment, video playback calls define one-way audio and video calls sourced from a multimedia content server and delivered to a destination device specified in the request.

Alternatively or additionally, the multimedia content server may source audio-only, video-only, or lip-synced audio and video streams. The message sequence of FIG. 49 begins with the user of Wireless Terminal A (“Wireless User A”) initiating the request by sending Video Playback signal(s) 802 to Wireless Terminal A. In one embodiment, the Video Playback signal(s) 702 identify the video information (e.g., video clips) that is desired for playback in a manner that is recognizable by the multimedia content server, such that the multimedia content server may ultimately retrieve and source the requested panoramic video information. For example, the Video Playback Signal(s) may identify a URL for a particular web site video link. The Video Playback Signal(s) 702 also identify the destination for the call, which in the present example is the requesting device (Wireless User A). However, the destination device may be different than the requesting device, as will be shown in FIG. 50. The mechanism for Wireless User A terminal entering the Video Playback signal(s) 802 may comprise other interaction devices besides the optical sensor assembly, for example, magnetic position sensors, datagloves, gesture recognition systems, voice recognitions systems, keypads, touchscreens, menu options, etc. that permit the user to select the type and rules of call and the second party for the call. Positional data and commands can be sent in packets just like the video information. Full duplex communication allows for the transmission and receival of information is a simultaneous manner between user terminal A and B. The second party may be identified by user identification number, telephone number or any suitable means of identification.

Next, Wireless Terminal A obtains a Non-Reserved Assignment 804 from Wireless Link Manager A, thereby allowing it to send a Video Playback Request 806 across an associated wireless link to the 3-D Multimedia Content Server. The Multimedia Content Server, which is the source of video information for the call, sends a Video Call Setup Request 808 to the Service Controller. The Service Controller determines an availability of bandwidth to support the call by sending a Reserve Bandwidth Request 810 to the Bandwidth Manager. The Bandwidth Manager responds to the request by determining an amount of bandwidth required for the call and granting or denying the Reserve Bandwidth Request based on an availability of bandwidth for the call. In one embodiment the Bandwidth Manager responds to the request by determining an amount of bandwidth required on the wireless link(s) required for the call and granting or denying the Reserve Bandwidth Request based on an availability of bandwidth on the wireless link(s). In the example of FIG. 49, the Bandwidth Manager returns a Bandwidth Available message 812 to the Service Controller, indicating that bandwidth is available on Wireless Link A to support the video playback call. The Service Controller, in turn, sends a Video Call

Proceed message 814 to the Multimedia Content Server, thereby authorizing the video playback call to proceed.

Thereafter, the Panoramic Multimedia Content Server and Wireless Terminal A exchange Setup Video Call message(s) 816, 820 to negotiate terms of the video call such as, for example, the type of audio, vocoder type, video coder type and/or bit rate to be used for the 3-D video playback call. In one embodiment, the Setup Video Call message(s) 820 from Panoramic Wireless Terminal A can not be sent until Non-Reserved Assignment(s) 818 are received from Wireless Link Manager A. After terms of the panoramic video playback call have been negotiated, the Multimedia Content Server retrieves video/audio packets 822 from memory or from an associated web server and sends them to Panoramic capable Wireless Terminal A. Upon receiving the video/audio packets, Panoramic capable Wireless Terminal A converts the IP packets into video/audio information 824 that is displayed/communicated to Wireless User A.

When the Panoramic capable Multimedia Content Server has finished sending the video/audio packets 822, it ends the video playback call by sending End Call message(s) 826 to Panoramic capable Wireless Terminal A and Video Call Ended message(s) 828 to the Service Controller. Upon receiving the Video Call Ended message 828, the Service Controller initiates a release of the bandwidth supporting the call by sending a Release Bandwidth Request 830 to the Bandwidth Manager.

FIG. 50 is a message sequence chart associated with a video playback request wherein the destination device is different than the requesting device.

The message sequence of FIG. 50 otherwise is generally the same as FIG. 49.

Wireless User A initiates the request by sending Video Playback signal(s) 902 to Panoramic capable Wireless Terminal A. The Panoramic Video Playback signal(s) 902 identify the video information (e.g., video clips) that is desired for playback in a manner that is recognizable by the panoramic capable multimedia content server, such that the panoramic capable multimedia content server may ultimately retrieve and source the requested video information. For example, the Video Playback Signal(s) may identify a URL for a particular web site video link with panoramic/3-D content. The Video Playback Signal(s) 902 also identify the destination for the call, which in the present example is Panoramic capable Wireless Terminal B of Wireless User B, located at a different RF site than Wireless User A. The mechanism for Wireless User A entering the Panoramic Video Playback signal(s) 902 may comprise other interaction devices besides the optical sensor assembly, for example, magnetic position sensors, datagloves, gesture recognition systems, voice recognitions systems, keypads, touchscreens, menu options, and the like depending on the features and functionality of Wireless Terminal A. Positional data and commands can be sent in packets just like the video information. Full duplex communication allows for the transmission and receival of information is a simultaneous manner between user terminal A the server and terminal B. The second party may that the playback request if for may be identified by user identification number, telephone number or any suitable means of identification.

Wireless Terminal A obtains a Non-Reserved Assignment 904 from Wireless Link Manager A and sends a Video Playback Request 906 across an associated wireless link to the Multimedia Content Server. The Multimedia Content Server, which is the source of video information for the call, sends a Video Call Setup Request 908 to the Service Controller. The Service Controller determines an availability of bandwidth to support the call by sending a Reserve Bandwidth Request 910 to the Bandwidth Manager. The Bandwidth Manager responds to the request by determining an amount of bandwidth required for the call and granting or denying the Reserve Bandwidth Request based on an availability of bandwidth for the call. In the example of FIG. 50, the Bandwidth Manager returns a Bandwidth Available message 912 to the Service Controller, indicating that bandwidth is available to support the video playback call. The Service Controller, in turn, sends a Video Call Proceed message 914 to the Panoramic capable Multimedia Content Server, thereby authorizing the video playback call to proceed. Thereafter, the Multimedia Content Server and Wireless Terminal B exchange Setup Video Call message(s) 916, 920 to negotiate terms of the video call such as, for example, the type of audio, vocoder type, video coder type and/or bit rate to be used for the video playback call. In one embodiment, the Setup Video Call message(s) 920 from Wireless Terminal B can not be sent until Non-Reserved Assignment(s) 918 are received from Wireless Link Manager B. After terms of the video playback call have been negotiated, the Multimedia Content Server retrieves video/audio packets 922 from memory or from an associated web server and sends them to Wireless Terminal B. Upon receiving the video/audio packets, Wireless Terminal B converts the IP packets into video/audio information 924 that is displayed/communicated to Wireless User B.

When the Multimedia Content Server has finished sending the panoramic content video/audio packets 922, it ends the video playback call by sending End Call message(s) 926 to Wireless Terminal B and Video Call Ended message(s) 928 to the Service Controller. Upon receiving the Video Call Ended message 928, the Service

Controller initiates a release of the bandwidth supporting the call by sending a

Release Bandwidth Request 930 to the Bandwidth Manager.

FIG. 51 is a message sequence chart associated with an embodiment of a wireless panoramic web browsing request supported by a packet-based multimedia communication system according to the present invention. (ref. US 2002/0093948)

FIG. 51 is a message sequence chart associated with a panoramic or 3-D web browsing request from a panoramic capable wireless terminal 120 (Wireless User A). Wireless User A initiates the request by sending Browsing Request signal(s) 1002 to Wireless Terminal A. The Browsing Request signal(s) 1002 identify the web browsing information (e.g., web sites, URLs) that are desired to be accessed by Wireless User A. The Browsing Request Signal(s) 1002 also identify the destination for the call, which in the present example is Wireless User A. However, the destination device may be different than the requesting device. The mechanism for Wireless User A entering the Browsing Request signal(s) 1002 may comprise other interaction devices besides the optical sensor assembly, for example, magnetic position sensors, datagloves, gesture recognition systems, voice recognitions systems, keypads, touchscreens, menu options, and the like depending on the features and functionality of Wireless Terminal A. Positional data and commands can be sent in packets just like the video information. Full duplex communication allows for the transmission and receival of information is a simultaneous manner between user terminal A the server and terminal B. The second party may that the playback request if for may be identified by user identification number, telephone number or any suitable means of identification.

Panoramic Wireless Terminal A 120 obtains a Non-Reserved Assignment 1004 from Wireless Link Manager A and sends a Browsing Request 1006 across an associated wireless link to the Panoramic capable Multimedia Content Server. The Multimedia Content Server sends a Browsing Response signal 1008 to Wireless Terminal A that includes browsing information associated with the browsing request. Upon receiving the browsing information, Wireless Terminal A displays the panoramic or 3-D browsing Content 1010 on the panoramic/3-D capable Wireless Terminal A to Wireless User A.

The present disclosure therefore has identified a panoramic/3-D capable communication system 100 that extends packet transport service over both wireline and wireless link(s).

The wireless panoramic communication system supports high-speed throughput of packet data, including but not limited to streaming voice and video to wireless terminals 120 or 122 participating in two-way video calls, video playback calls, and web browsing requests.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

I claim:

1. A panoramic system, comprising:
means for obtaining a panoramic image; and
means for displaying the panoramic image.
